(19) United States
(12) Patent Application Publication
(10) Pub. No.: US 2025/0284944 A1
(43) Pub. Date: Sep. 11, 2025

(54) BIOLOGICAL NEURAL NETWORK SYSTEM AND METHODS

(71) Applicant: Biological Black Box, Inc., Baltimore, MD (US)

(72) Inventors: Alexander Ksendzovsky, Baltimore, MD (US); Isaac Jonathan Pomeraniec, Wynnewood, PA (US); John Wittig, Solana Beach, CA (US); William Barnes, Washington, DC (US); Adam Messinger, Chevy Chase, MD (US); Steven Jerjian, Baltimore, MD (US); Maria Cristina Florio, Lutherville-Timonium, MD (US); Marisol Cortes, Baltimore, MD (US)

(73) Assignee: Biological Black Box, Inc., Baltimore, MD (US)

(21) Appl. No.: 19/054,670

(22) Filed: Feb. 14, 2025

Related U.S. Application Data
(60) Provisional application No. 63/562,357, filed on Mar. 7, 2024.

(51) Int. Cl. G06N 3/06

(52) U.S. Cl. CPC G06N 3/061

(57) ABSTRACT

Techniques for using a biological and artificial neural network (BANN) system to generate a neural-based embedding of an input signal. The BANN system comprises a multi-electrode array (MEA); a biological neural network (BNN) comprising neurons arranged on the MEA, an artificial neural network; and at least one processor. The method comprises using the BANN system to stimulate the BNN by using the MEA to generate electrical signals in accordance with a stimulation pattern generated based on the input signal; measure, using the MEA, a response of the BNN responsive to the stimulating by deriving from the response of the BNN, multiple features of the at least one response; and process the multiple features derived from the response of the BNN with the ANN to generate the neural-based embedding, wherein the ANN is trained to process the multiple features derived from the response of the BNN.

### CROSS-REFERENCE TO RELATED APPLICATIONS

This application claims the benefit of priority under 35 U.S.C. § 119 (e) to U.S. Provisional Application Ser. No. 63/562,357 titled “BIOLOGICAL NEURAL NETWORK SYSTEM” and filed on Mar. 7, 2024, the entire contents of which is incorporated by reference herein in its entirety.

### FIELD

Aspects of the disclosure relate to biological neural network (BNN) systems and methods. More specifically, aspects of the disclosure relate to a BNN system that uses cells (e.g., neurons) on a multielectrode array (MEA) for computational applications.

### BACKGROUND

The use of artificial neural networks (ANNs) and other machine learning tools has grown significantly in recent years. Such techniques can be used in a wide variety of applications. With the increasing demand for ANNs and other machine learning tools, and the increasing complexity of the problems which they are tasked to solve, the amount of time, energy, and data required to train such tools is likewise increasing.

### SUMMARY

According to some aspects, there is provided a method for using a biological and artificial neural network (BANN) system to perform a task, the BANN system comprising: (i) a multi-electrode array (MEA); (ii) a biological neural network (BNN) comprising neurons arranged on the MEA, (iii) a trained statistical model trained using inputs generated using responses of the BNN to training data inputs; and (iv) at least one processor, the method comprising: using the BANN system to perform: receiving an input signal to be processed by the BANN in furtherance of performing the task; encoding the input signal to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; generating, based on the measured at least one response, an input for the ANN; processing the input with the trained statistical model to obtain corresponding output from the trained statistical model; and using the output from the trained statistical model in furtherance of performing the task.

According to some aspects, there is provided a biological and artificial neural network (BANN) system comprising: a multi-electrode array (MEA); a biological neural network (BNN) comprising neurons arranged on the MEA; a trained statistical model trained using inputs generated using responses of the BNN to training data inputs; and at least one processor configured to perform a task at least in part by: receiving an input signal to be processed by the BANN in furtherance of performing the task; encoding the input signal to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; generating, based on the measured at least one response, an input for the trained statistical model; processing the input with the ANN to obtain corresponding output from the trained statistical model; and using the output from the trained statistical model in furtherance of performing the task.

According to some aspects, there is provided a method for using a biological and artificial neural network (BANN) system to perform a task, the BANN system comprising: (i) a multi-electrode array (MEA); (ii) a biological neural network (BNN) comprising neurons arranged on the MEA, (iii) a trained statistical model; and (iv) at least one processor, the method comprising: using the BANN system to perform: receiving an input signal to be processed by the BANN in furtherance of performing the task; encoding the input signal using the trained statistical model to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; and using the measured at least one response from the BNN in furtherance of performing the task.

According to some aspects, there is provided a system comprising: a multi-electrode array (MEA); a biological neural network (BNN) comprising neurons arranged on the MEA; a trained statistical model; and at least one processor configured to perform a method for performing a task, the method comprising: receiving an input signal to be processed by the system in furtherance of performing the task; encoding the input signal using the trained statistical model to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; and using the measured at least one response from the BNN in furtherance of performing the task.

According to some aspects, there is provided a method for using a biological and artificial neural network (BANN) system to generate a neural-based embedding of an input signal, the BANN system comprising: (i) a multi-electrode array (MEA); (ii) a biological neural network (BNN) comprising neurons arranged on the MEA, (iii) an artificial neural network (ANN); and (iv) at least one processor, the method comprising: using the BANN system to perform: stimulating the BNN by using the MEA to generate electrical signals in accordance with at least one stimulation pattern generated based on the input signal; measuring, using the MEA, at least one response of the BNN responsive to the stimulating, wherein measuring the at least one response comprises deriving from the at least one response of the BNN, multiple features of the at least one response; and processing the multiple features derived from the at least one response of the BNN with the ANN to generate the neural-based embedding, wherein the ANN is trained to process the multiple features derived from the at least one response of the BNN.

According to some aspects, there is provided a system comprising: a multi-electrode array (MEA); a biological neural network (BNN) comprising neurons arranged on the MEA; an artificial neural network; and at least one processor configured to generate a neural-based embedding of an input signal at least in part by: stimulating the BNN by using the MEA to generate electrical signals in accordance with at least one stimulation pattern generated based on the input signal to be processed by the BANN in furtherance of generating the neural-based embedding; measuring, using the MEA, at least one response of the BNN that is responsive to the stimulating, wherein measuring the at least one response comprises deriving from the at least one response of the BNN, multiple features of the at least one response; and processing the multiple features derived from the at least one response of the BNN with the ANN to generate the neural-based embedding, wherein the ANN is trained to process the multiple features derived from the at least one response of the BNN.

According to some aspects, there is provided a method for calibrating a system comprising (i) a multi-electrode array (MEA); (ii) a biological neural network (BNN) comprising neurons arranged on the MEA, and (iii) at least one processor, the method comprising: using the system to perform a calibration method to select a subset of a plurality of electrodes of the MEA to use when stimulating the BNN, at least in part by: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by respective ones of the plurality of electrodes; receiving an input signal to be processed by the BNN; encoding the input signal to generate at least one stimulation pattern for stimulating the BNN; and stimulating the BNN using only the selected subset of the plurality of electrodes of the MEA to generate electrical signals in accordance with the at least one stimulation pattern.

According to some aspects, there is provided a system comprising: a multi-electrode array (MEA); a biological neural network (BNN), wherein the BNN comprises neurons arranged on the MEA; and at least one processor configured to perform a method for calibrating the system comprising: using the system to perform a calibration method to select a subset of a plurality of electrodes of the MEA to use when stimulating the BNN, at least in part by: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by respective ones of the plurality of electrodes; receiving an input signal to be processed by the BNN; encoding the input signal to generate at least one stimulation pattern for stimulating the BNN; and stimulating the BNN using only the selected subset of the plurality of electrodes of the MEA to generate electrical signals in accordance with the at least one stimulation pattern.

According to some aspects, there is provided a method for generating a dictionary of neural-based embeddings for a dictionary of tokens, the method performed by a biological and artificial neural network (BANN) system comprising (i) a multi-electrode array (MEA); (ii) a biological neural network (BNN) comprising neurons arranged on the MEA; (iii) an artificial neural network (ANN) trained to process multiple features derived from at least one response of the BNN to a stimulation pattern; and (iv) at least one processor, to create a dictionary of neural-based embeddings, the method comprising: using the BANN system to perform: (a) receiving a token of a dictionary of tokens; (b) mapping the token to a corresponding stimulation pattern; (c) stimulating the BNN by using the MEA to generate electrical signals in accordance with the corresponding stimulation pattern for the token; (d) measuring, using the MEA, at least one response of the BNN that is responsive to the stimulating with the corresponding stimulation pattern for the token; (e) generating, based on the measured at least one response, an input; (f) processing the input with the ANN to obtain a neural-based embedding for the token; and (g) storing the neural-based embedding for the token in a memory.

According to some aspects, there is provided a system comprising: a multi-electrode array (MEA); a biological neural network (BNN), wherein the BNN comprises neurons arranged on the MEA; an artificial neural network (ANN) trained to process multiple features derived from at least one response of the BNN to a stimulation pattern; and at least one processor configured to generate a dictionary of neural-based embeddings for a dictionary of tokens, at least in part by: (a) receiving a token of a dictionary of tokens; (b) mapping the token to a corresponding stimulation pattern; (c) stimulating the BNN by using the MEA to generate electrical signals in accordance with the corresponding stimulation pattern for the token; (d) measuring, using the MEA, at least one response of the BNN that is responsive to the stimulating with the corresponding stimulation pattern for the token; (e) generating, based on the measured at least one response, an input; (f) processing the input with the ANN to obtain a neural-based embedding for the token; and (g) storing the neural-based embedding for the token in a memory.

According to some aspects, there is provided a method for using a dictionary of neural-based embeddings to perform a task using a system comprising: (i) a large language model (LLM); and (ii) at least one processor, the method comprising: using the system to perform: receiving text comprising one or more tokens to be processed by the LLM in furtherance of performing a task; determining, for each token of the one or more tokens, a corresponding neural-based embedding using the dictionary of neural-based embeddings, the dictionary of neural based embeddings being generated using a biological neural network (BNN) comprising neurons arranged on a multi-electrode array; processing the one or more tokens using the LLM by inputting to the LLM the determined corresponding neural-based embeddings for each of the one or more tokens to obtain an output; using the output in furtherance of performing the task.

According to some aspects, there is provided a system comprising: a large language model (LLM); and at least one processor configured to use a dictionary of neural-based embeddings to perform a task at least in part by: receiving text comprising one or more tokens to be processed by the LLM in furtherance of performing a task; determining, for each token of the one or more tokens, a corresponding neural-based embedding using the dictionary of neural-based embeddings, the dictionary of neural based embeddings being generated using a biological neural network (BNN) comprising neurons arranged on a multi-electrode array; processing the one or more tokens using the LLM by inputting to the LLM the determined corresponding neural-based embeddings for each of the one or more tokens to obtain an output; using the output in furtherance of performing the task.

According to some aspects, there is provided a method for training a large language model (LLM) using a dictionary of neural-based embeddings, the method comprising: using at least one computer hardware processor to perform: obtaining a dictionary of neural-based embeddings, the dictionary of neural based embeddings being generated using a biological neural network (BNN) comprising neurons arranged on a multi-electrode array, the dictionary of neural based embeddings including a neural embedding for each of one or more words in a lexicon; initializing parameters of an input embedding layer of the LLM using neural embeddings in the dictionary of neural-based embeddings; and after the initializing, training an LLM using training data comprising text having words in the lexicon to obtain a trained LLM, the training comprising updating the parameters of the input embedding layer of the LLM.

According to some aspects, there is provided a method for using a dictionary of neural-based embeddings to process text using a large language model (LLM), the LLM having an embedding layer and a plurality of transformers, each of the transformers having one or more attention heads, the method comprising: using at least one computer hardware processor to perform: receiving text comprising one or more tokens to be processed by the LLM; determining a corresponding token embedding for each of the one or more tokens by using parameters of the embedding layer to obtain token embeddings, the parameters of the embedding layer determined using the dictionary of neural-based embeddings, the dictionary of neural-based embeddings having been generated using a biological neural network (BNN) comprising neurons arranged on a multi-electrode array; and processing the obtained token embeddings using the plurality of transformers part of the LLM to obtain LLM output.

According to some aspects, there is provided a system, comprising: at least one computer hardware processor; at least one non-transitory computer-readable storage medium storing processor-executable instructions that, when executed by the at least one computer hardware processor, causes the at least one computer hardware processor to perform any of the methods described herein.

According to some embodiments, there is provided at least one non-transitory computer-readable storage medium having instructions encoded thereon that, when executed by at least one processor, cause the at least one processor to perform any of the methods described herein.

### BRIEF DESCRIPTION OF THE DRAWINGS

Various aspects and embodiments will be described with reference to the following figures. It should be appreciated that the figures are not necessarily drawn to scale. For purposes of clarity, not every component may be labeled in every drawing. In the drawings:

FIG. 1 illustrates a schematic diagram of an example biological and artificial neural network (BANN) system, according to some embodiments of the technology described herein.

FIG. 2 illustrates communication with a biological neural network via stimulation, according to some embodiments of the technology described herein.

FIG. 3 illustrates a schematic diagram illustrating aspects of preparing a biological neural network, according to some embodiments of the technology described herein.

FIG. 4 is a schematic diagram illustrating aspects of a microelectrode array of a biological neural network system, according to some embodiments of the technology described herein.

FIG. 5A illustrates aspects of another example multi-electrode array of a biological neural network system, according to some embodiments of the technology described herein.

FIG. 5B illustrates aspects of another example multi-electrode array of a biological neural network system, according to some embodiments of the technology described herein.

FIGS. 6A-B illustrate schematic diagrams comparing a conventional artificial neural network with a biological and artificial neural network, according to some embodiments of the technology described herein.

FIG. 7A is a schematic diagram illustrating an example workflow of an example biological neural network system, according to some embodiments of the technology described herein.

FIG. 7B illustrates a schematic diagram illustrating a feedback loop in the example workflow of FIG. 7A, according to some embodiments of the technology described herein.

FIG. 8 illustrates aspects of stimulating a biological neural network, according to some embodiments of the technology described herein.

FIG. 9 illustrates an example graphical user interface for use with a biological neural network system, according to some embodiments of the technology described herein.

FIG. 10 illustrates aspects of features that can be derived from one or more measurements that may be obtained in response to stimulation of a biological neural network, according to some embodiments of the technology described herein.

FIG. 11 illustrates spatial features that can be derived from one or more measurements that may be obtained in response to stimulation of a biological neural network, according to some embodiments of the technology described herein.

FIG. 12 illustrates example features that can be derived from one or more measurements obtained in response to stimulation of a biological neural network, according to some embodiments of the technology described herein.

FIG. 13 illustrates an example feature that can be derived from one or more measurements that may be obtained in response to stimulation of a biological neural network, according to some embodiments of the technology described herein.

FIG. 14 illustrates another example feature that can be derived from one or more measurements that may be obtained in response to stimulation of a biological neural network, according to some embodiments of the technology described herein.

FIGS. 15A-1, 15A-2, and 15B-C illustrate example features that can be derived from one or more measurements that may be obtained in response to stimulation of a biological neural network, according to some embodiments of the technology described herein.

FIG. 16 illustrates example features that can be derived from one or more measurements that may be obtained in response to stimulation of a biological neural network, according to some embodiments of the technology described herein.

FIG. 17 illustrates example features that can be derived from one or more measurements that may be obtained in response to stimulation of a biological neural network, according to some embodiments of the technology described herein.

FIG. 18A illustrates a schematic diagram illustrating an example workflow of an example biological and artificial neural network system, according to some embodiments of the technology described herein.

FIG. 18B illustrates a schematic diagram illustrating a feedback loop in the example workflow of FIG. 18A, according to some embodiments of the technology described herein.

FIG. 19 illustrates an example method for performing a task using a biological and artificial neural network system, according to some embodiments of the technology described herein.

FIG. 20 illustrates a schematic diagram illustrating an example stimulation pattern for a biological neural network, according to some embodiments of the technology described herein.

FIGS. 21A-B illustrate example results of a response of a biological neural network to stimulation, according to some embodiments of the technology described herein.

FIG. 22 illustrates example results of a biological neural network at classifying a letter in response to stimulation, according to some embodiments of the technology described herein.

FIG. 23 illustrates a difference in classification performance of the biological neural network before and after training is performed, according to some embodiments of the technology described herein.

FIG. 24 illustrates aspects of performing a classification task using a biological neural network, according to some embodiments of the technology described herein.

FIG. 25 illustrates aspects of performing a classification task using a biological neural network, according to some embodiments of the technology described herein.

FIG. 26 illustrates a response of a biological neural network to a stimulation pattern applied to perform a classification task using the biological neural network, according to some embodiments of the technology described herein.

FIG. 27 illustrates aspects of performing a classification task using a biological neural network, according to some embodiments of the technology described herein.

FIG. 28 illustrates a comparison of results of a biological neural network and an artificial neural network at performing a classification task, according to some embodiments of the technology described herein.

FIGS. 29A-B illustrate comparisons of results of a biological neural network and an artificial neural network at performing a classification task, according to some embodiments of the technology described herein.

FIG. 30 illustrates a schematic diagram illustrating encoding of visual patterns into stimulation patterns for processing with a biological neural network, according to some embodiments of the technology described herein.

FIG. 31 illustrates a graph showing accuracy of a biological neural network at performing a classification task according to the workflow of FIG. 30, according to some embodiments of the technology described herein.

FIG. 32A illustrates a schematic diagram illustrating an example workflow of an example biological and artificial neural network system, according to some embodiments of the technology described herein.

FIG. 32B illustrates a schematic diagram illustrating a feedback loop in the example workflow of FIG. 32A, according to some embodiments of the technology described herein.

FIG. 33 illustrates an example method for performing a task using a biological and artificial neural network system, according to some embodiments of the technology described herein.

FIG. 34 illustrates an architecture of a biological and artificial neural network system, where an artificial neural network is used to determine a stimulation pattern for the biological neural network, according to some embodiments of the technology described herein.

FIG. 35 illustrates an example workflow for tokenizing images into stimulation patterns using an artificial neural network, according to some embodiments of the technology described herein.

FIG. 36 illustrates an example of applying a set of images in the form of a stimulation pattern to a biological neural network, according to some embodiments of the technology described herein.

FIG. 37 illustrate a graph illustrating classification accuracy of a biological neural network which receives stimulation patterns generated by an ANN, according to some embodiments of the technology described herein.

FIG. 38 illustrates another schematic diagram of a workflow for generating a stimulation pattern for a biological neural network by using convolutional kernels, according to some embodiments of the technology described herein.

FIG. 39A illustrates a schematic diagram illustrating an example workflow of an example biological and artificial neural network system, according to some embodiments of the technology described herein.

FIG. 39B illustrates a schematic diagram illustrating a feedback loop in the example workflow of FIG. 39A, according to some embodiments of the technology described herein.

FIG. 40 illustrates an example method for performing a task using a biological and artificial neural network system, according to some embodiments of the technology described herein.

FIG. 41 illustrates a schematic diagram illustrating a workflow for processing a response of a biological neural network to a stimulation pattern with an artificial neural network, according to some embodiments of the technology described herein.

FIG. 42 illustrates additional aspects of the schematic diagram of FIG. 59, according to some embodiments of the technology described herein.

FIG. 43 illustrates an example method for processing a response of a biological neural network to stimulation according to a stimulation pattern, according to some embodiments of the technology described herein.

FIG. 44 illustrates an architecture of an example artificial neural network for processing a response of a biological neural network to stimulation according to a stimulation pattern, according to some embodiments of the technology described herein.

FIG. 45 illustrates an architecture of the example artificial neural network of FIG. 44 that can be applied to different tasks, according to some embodiments of the technology described herein.

FIG. 46 illustrates an architecture for training the example artificial neural network of FIG. 44, according to some embodiments of the technology described herein.

FIG. 47 illustrates another representation of the example artificial neural network of FIG. 44, according to some embodiments of the technology described herein.

FIG. 48 illustrates graphs depicting performance of the example artificial neural network of FIG. 44 at a classification task, according to some embodiments of the technology described herein.

FIG. 49 illustrates an example method for calibrating a biological neural network, according to some embodiments of the technology described herein.

FIG. 50 illustrates stimulation of a biological neural network with a multi-electrode array that shows aspects of the example method of FIG. 67, according to some embodiments of the technology described herein.

FIG. 51 illustrates an example method for calibrating a biological neural network, according to some embodiments of the technology described herein.

FIG. 52 illustrates graphs depicting identification of bursts in a biological neural network, according to some embodiments of the technology described herein.

FIG. 53 illustrates graphs depicting results of burst suppression through electrical stimulation, according to some embodiments of the technology described herein.

FIG. 54 illustrates graphs depicting thresholds set for burst removal, according to some embodiments of the technology described herein.

FIG. 55 illustrates a schematic diagram illustrating an example workflow for creating one or more (e.g., a dictionary of) neural-based embeddings using a biological and artificial neural network system, according to some embodiments of the technology described herein.

FIG. 56 illustrates an example method for creating a dictionary of neural-based embeddings using a biological and artificial neural network system, according to some embodiments of the technology described herein.

FIG. 57 illustrates a graph depicting a mapping of tokens to stimulation patterns, according to some embodiments of the technology described herein.

FIG. 58 illustrates images showing average electrode response to tokenized vector inputs, according to some embodiments of the technology described herein.

FIG. 59 illustrates an example matrix of word-to-word distances, according to some embodiments of the technology described herein.

FIG. 60 illustrates an example matrix of word-to-word distances, according to some embodiments of the technology described herein.

FIG. 61 illustrates an example method for assigning stimulation patterns to tokens, according to some embodiments of the technology described herein.

FIGS. 62A-B illustrate aspects of generating stimulation patterns for a biological neural network, according to some embodiments of the technology described herein.

FIG. 63 illustrates an example look-up table of embeddings for text inputs, according to some embodiments of the technology described herein.

FIG. 64 illustrates example images of a response of a biological neural network to stimulation according to stimulation patterns, according to some embodiments of the technology described herein.

FIG. 65 illustrates aspects of a process for generating unique stimulation patterns for a biological neural network, according to some embodiments of the technology described herein.

FIG. 66 illustrates an example matrix of distance between neuronal responses to stimulation according to different stimulation patterns, according to some embodiments of the technology described herein.

FIG. 67 illustrates a schematic diagram illustrating an example workflow for performing a task using a dictionary of neural-based embeddings, according to some embodiments of the technology described herein.

FIG. 68 illustrates an example method for performing a task using a dictionary of neural-based embeddings, according to some embodiments of the technology described herein.

FIG. 69A illustrates accuracy and efficiency of a biological and artificial neural network system at performing a word classification task, according to some embodiments of the technology described herein.

FIGS. 69B-D illustrate relative performance of large language models (LLMs) whose embeddings were initialized using neural embeddings and one or more other techniques, according to some embodiments of the technology described herein.

FIG. 70 illustrates example graphs depicting performance of a trained biological neural network in performing a word classification task, according to some embodiments of the technology described herein.

FIG. 71 illustrates an example diagram illustrating performance of a biological neural network at performing a word classification task, according to some embodiments of the technology described herein.

FIG. 72 illustrates an example workflow for using a biological neural network to perform sentence classification, according to some embodiments of the technology described herein.

FIG. 73 illustrates an example graph depicting results of a biological neural network's performance at a sentence classification task, according to some embodiments of the technology described herein.

FIG. 74 illustrates an example architecture of a biological neural network embedding layer into a transformer-based large language model, according to some embodiments.

FIG. 75 illustrates example results of a large language model at a sentence classification task, according to some embodiments of the technology described herein.

FIGS. 76A-B illustrate schematic diagrams illustrating example workflows for training a biological neural network, according to some embodiments of the technology described herein.

FIG. 77 illustrates example aspects of training a biological neural network, according to some embodiments of the technology described herein.

FIGS. 78A-C illustrate example graphs depicting results of a biological neural network at a classification task before, during, and after training the biological neural network, according to some embodiments of the technology described herein.

FIG. 79 is a block diagram of an exemplary computer system in which aspects of the present disclosure may be implemented, according to some embodiments of the technology described herein.

### DETAILED DESCRIPTION

### I. Introduction

Aspects of the technology described herein provide for techniques that involve use of a biological neural network (BNN) comprising a plurality of cells (e.g., neurons, microglia, and astrocytes) arranged on a multielectrode array (MEA). According to some aspects, the biological neural network forms part of a biological and artificial neural network (BANN) system, which may further include the MEA, a trained statistical model which may be a trained artificial neural network (ANN), and at least one processor to execute operations of the BANN system. The BANN may encode data (e.g., input signals which may be in the form of numerical data, images, videos, etc.) into the BNN in the form of a stimulation pattern that is applied to the BNN via stimulation. For example, stimulation of the BNN may be electrical stimulation, chemical stimulation, optical stimulation, and/or any other suitable manner of performing stimulation of the BNN. The input data is processed by the BNN and results of the data processing by the BNN may be decoded by measuring its response(s) to the stimulation. The measured response(s) may be processed into a format usable for subsequent computational tasks. In this way, the BANN may be used to perform computational tasks such as classification, prediction, dimensionality reduction, reinforcement learning, regression, and the like.

Biological neural networks are composed of living cells that are capable of forming interconnected cell networks. For example, the cells may include neurons, astrocytes, microglia, and/or other cells. Neurons may include extracted neurons and/or stem cell derived neurons, for example, human induced pluripotent stem cell (iPSC) derived neurons. BNNs process data through electrical signals, enabled by voltage changes across neural membranes. In contrast to artificial neural networks (ANNs), BNNs inherently process data non-linearly (analog) and preserve information over time via fading memory. Additionally, BNNs leverage synaptic modification mechanisms both within and across neurons. BNNs can adapt to new environments and perform computation, including visual processing and image recognition, for a fraction of the time and energy cost compared to ANNs and silicon computers. By using commercially available microelectrode arrays (MEAs), neurons can be incubated on a high density array of electrodes which can be used to encode data, allowing for neuronal processing, the result of which can be decoded to perform computation with applications in general computing. Novel computational tools are described herein that utilize BNN(s), either solely or in conjunction with artificial neural network(s). A BNN used with an artificial neural network is termed “BANN” in this context. These tools involve encoding data into a BNN for neuronal processing and subsequently decoding the results of such processing for subsequent data analysis and computational tasks. The BNN and BANN systems described herein provide techniques for processing data from a BNN and techniques for performing tasks utilizing tools derived from use of a BNN (e.g., a dictionary of neural-based embeddings).

The present disclosure describes new ways of performing computation that use cellular (e.g., neuronal) processing of data improves on ANNs and classical silicon computing. Some embodiments involve use of BNNs either alone or in combination with ANNs (a network architecture that combines biological neural networks and in silico artificial neural networks, which architecture is referred to as “BANN”) to solve computational problems. To accomplish this, methods of cell culture, data encoding, and decoding of processed data through stimulation and recording of cellular (e.g., neuronal) cultures on an MEA is presented herein. The inventors have recognized that use of BNNs alone or in combination with an ANNs is advantageous compared to using ANNs alone, as BNNs require less power to perform certain tasks. That is, the power required to train a BNN or BANN system to perform a task is less than the power required to perform the same task using an ANN alone (e.g., to the same level of accuracy). This is in part due to the power required by the BNN to perform a task being less than the power required by an ANN to perform the same task. This is partly due to the efficiency and asynchronous information processing performed by the BNNs. Specifically, as described herein, ANNs trained on neural responses following stimulus presentation to the BNN-which represent information processed by the BNNs-require fewer training iterations to achieve the same or higher accuracy in performing a task compared to ANNs trained solely on the stimulus. Thus, one benefit of the technology described herein is reducing the amount of power required to train an artificial intelligence (AI) system, such as a neural network, which is an improvement to neural network technology and AI technology as well as an improvement to computer technology, which results in savings of computational resources (e.g., by utilizing fewer processor cycles to train a neural network model than conventional approaches).

Accordingly, some aspects of the technology described herein provide for a biological and artificial neural network system that may be used to perform one or more tasks. In some embodiments, the BANN comprises an ANN that processes an input to the BNN to generate a stimulation pattern for the BNN. In some embodiments, the BANN comprises an ANN that processes an output of the BNN in furtherance of performing a task. In some embodiments, the BANN comprises first and second ANNs, the first ANN processes an input to the BNN to generate a stimulation pattern for the BNN, and the second ANN processes an output of the BNN in furtherance of performing a task.

Some aspects of the technology described herein provide for systems and techniques for processing a response of the BNN. For example, in some embodiments, there is provided a BANN comprising an ANN for processing multiple features derived from a measured response of the BNN to stimulation.

Some aspects of the technology described herein provide for calibration techniques for use with a BNN. The calibration techniques may be used to select a subset of electrodes of an MEA with which to perform stimulation of the BNN. In some embodiments, the calibration techniques provide for minimizing burstiness (network-wide neural activity) of the BNN that may interfere with encoding of stimuli or decoding of responses. Indeed, some of the calibration techniques described herein improve neural encoding and decoding technology, by improving the efficiency and accuracy of encoding stimuli and decoding responses.

Some aspects of the technology described herein provide for use of a BNN for LLM applications. For example, some aspects of the technology described herein relate to use of a dictionary of neural-based embeddings and creation thereof. In some embodiments, there is provided a BANN system which is used to generate a dictionary of neural-based embeddings. In some embodiments, there is provided an LLM which uses a dictionary of neural-based embeddings generated by a BANN (e.g., to perform a task). The inventors have recognized that creation of a dictionary of neural-based embeddings using a BANN provide for improved embeddings which, when used to perform a task, provides for better performance of the task (e.g., performance of the ask using an LLM using the dictionary of neural-based embeddings generated by the BANN).

The aspects and embodiments described above, as well as additional aspects and embodiments, are described further below. These aspects and/or embodiments may be used individually, all together, or in any combination, as the application is not limited in this respect.

### II. Example BANN System

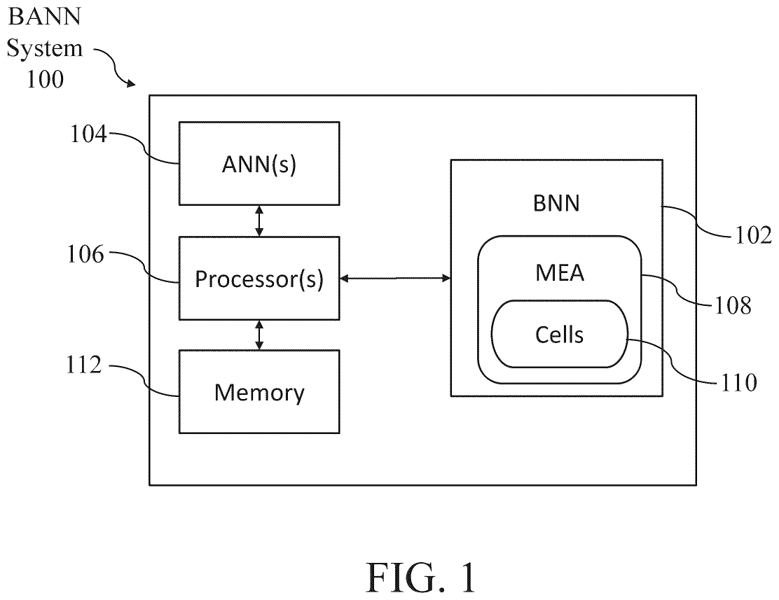

As described herein, aspects of the technology relate to systems and methods using biological neural networks. According to some aspects, there is provided a biological and artificial neural network (BANN) system which utilizes one or more BNNs in combination with one or more ANNs. FIG. 1 illustrates a schematic diagram of an example biological and artificial neural network system 100, according to some embodiments of the technology described herein. In the illustrated embodiment of FIG. 1, the BANN system 100 comprises one or more BNNs 102, one or more processors 106, one or more ANNs 104, and one or more memories 112. Each BNN 102 comprises a multielectrode array (MEA) 108 and a plurality of interconnected cells 110 arranged on the MEA 108. Each of the components of the BANN system 100 are operatively coupled together, for example, via processor 106.

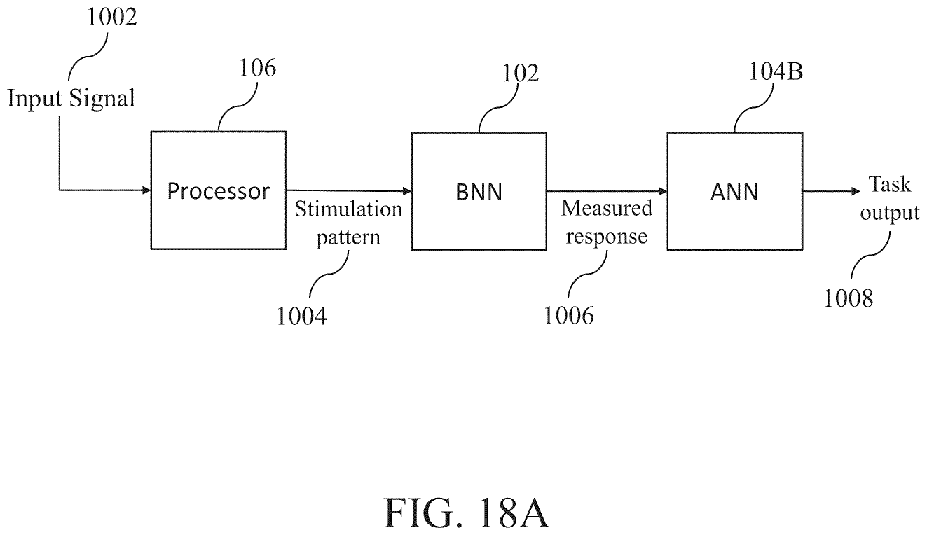

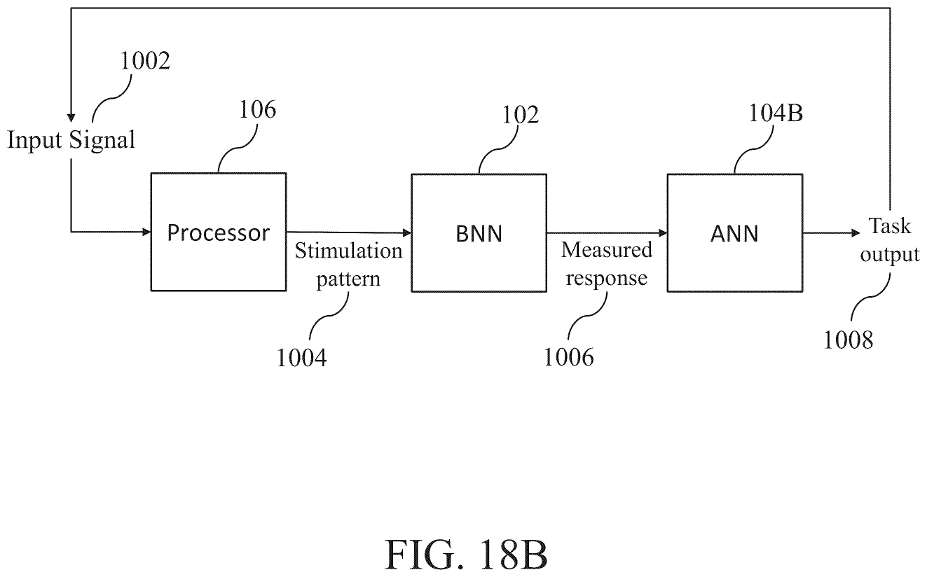

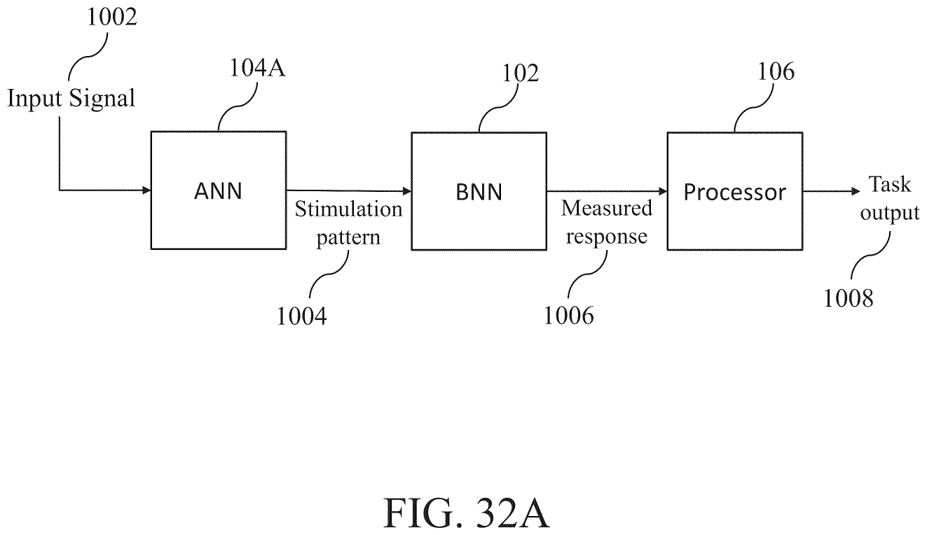

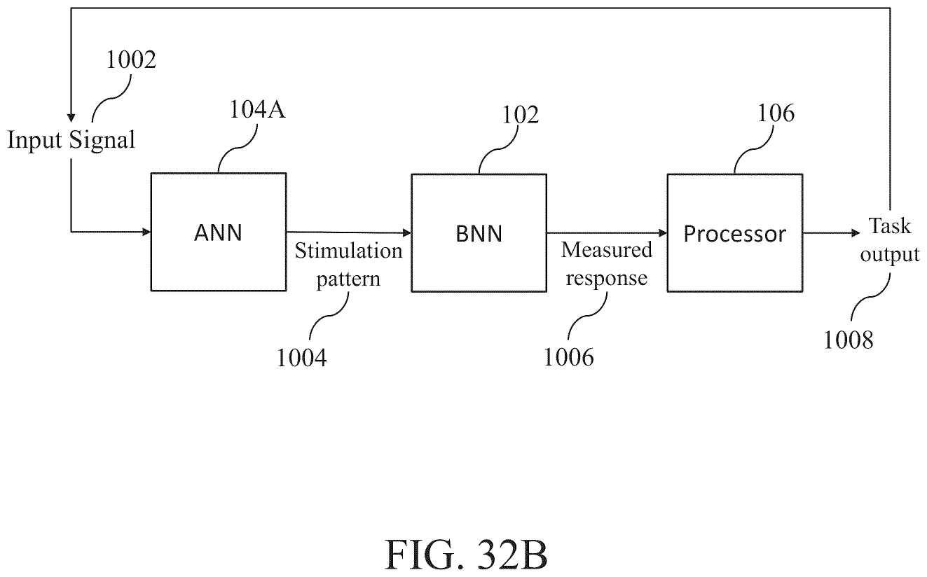

As described herein, the BANN system 100 may be used to perform a task at least in part by encoding an input signal (e.g., data in any suitable form, such as one-dimensional, two-dimensional, three-dimensional, four-dimensional, spatial, temporal, spatio-temporal, etc.) into the BNN 102. The encoding of the input signal into the BNN 102 can be performed by generating a stimulation pattern for stimulating the BNN 102 (e.g., via electrical, chemical, and/or optical stimulation), the stimulation pattern being generated based on the input signal or a derived stimulus from the input signal. Such encoding of the input signal by generating a stimulation pattern based on the input signal can be performed, in some embodiments, using a trained statistical model, such as an ANN 104. Indeed, as described herein, an ANN may be used to facilitate generating an input stimulation pattern used to stimulate a BNN. Another ANN may be used to process response(s) of the BNN. These ANNs may be different from one another and, in such embodiments, ANN(s) 104 may include at least one ANN for facilitating generating an input stimulation pattern (e.g., ANN 104A described herein, including with reference to FIG. 32A) and at least one ANN for processing measured BNN responses (e.g., ANN 104B described herein, including with reference to FIG. 18A). Examples of such ANNs are provided herein.

The stimulation pattern may be applied to the BNN 102 via electrical, chemical (e.g., using dopamine), and/or optical (e.g., using one or more lasers) stimulation. In some embodiments, the stimulation pattern may be applied to the BNN 102 by using the MEA 108 to transmit electrical signal(s) to the cells 110. The cells 110 process the input signal by responding to the stimulation, and the response of the BNN 102 (e.g., change(s) in voltage) can be measured using the MEA 108. The measured response, which may comprise one or more measurements, can be processed in furtherance of performing the task. In some embodiments, the processing of the measured response may be performed, at least in part, using a trained statistical model, such as the ANN 104 to process the measured response and/or one or more features derived from the measured response.

The inventors have recognized that biological computing is especially powerful for a variety of computational tasks involving time series data, such as video, speech, and/or text processing. Moreover, the unique set of biological equations in each BNN, unlike the standardized algebraic structures in silicon systems, positions biological computing as a strong candidate for other types of tasks such as data encryption. Examples of tasks that can be performed using the BNN techniques described herein are provided herein.

One example task is time series data analysis. Biological computing excels in integrating temporal information due to its recurrent architecture, making it ideal for tasks where time plays a crucial role, including, for example, speech recognition, financial forecasting (e.g. predicting stock prices or economic trends from time series data), and sensor data processing (e.g., applications like weather modeling, seismology, and/or industrial IoT sensors).

Another example task is video processing. Biological computing's ability to process temporal information in real-time without flattening it into single time steps could improve tasks, including, for example, video analysis (e.g., object tracking, scene understanding, activity recognition), and autonomous vehicle tasks (e.g., integration of visual and sensor data to react to changing environments and improve decision-making in real time).

Another example task includes natural language processing (NLP). Biological computing's efficient handling of recurrent tasks would be advantageous for NLP tasks where context over time is crucial, including, for example, conversational artificial intelligence (e.g., chatbots and/or virtual assistants which integrate past conversations and contextual nuances), and machine translation (e.g., by better capturing long-range dependencies between words and phrases in different languages over time). Indeed, some of the novel large language model (LLM) methods described herein (e.g., for generating improved word embeddings) can be used, among other purposes, to improve performance on various NLP tasks.

Another example task includes real-time decision making. Applications that require fast, continuous decision-making with minimal energy consumption would benefit greatly from biological computing, including, for example, robotics and autonomous systems (e.g., by enhancing control of robots and autonomous vehicles, especially in environments that demand real-time adaptation to changing stimuli) and real-time strategy games (e.g., tasks that require continuous strategic thinking and adaptation, such as complex video games or military simulations).

Another example task includes data encryption and cybersecurity. Since biological computing relies on unique, individual network structures, it could offer enhanced capabilities for tasks such as data encryption (e.g., by generating more secure encryption keys and algorithms, as a BNN's internal computational processes are inherently non-standardized and difficult to replicate) and anomaly detection (e.g., detecting anomalies in network traffic or financial transactions by recognizing subtle temporal and spatial patterns that silicon-based models might overlook).

Another example task includes pattern recognition and generalization. Biological networks, which do not need retraining to recognize new classes of data, could outperform silicon systems in tasks requiring high adaptability, including, for example, few-shot learning (e.g., a BNN's ability to generalize new information without retraining makes it superior for few-shot learning tasks, such as recognizing new objects in images after seeing only a few examples) and medical diagnostics (e.g., in medical imaging or diagnostics, biological systems could detect new diseases or conditions based on their flexible pattern recognition, adapting quickly without retraining).

Another example task includes energy-efficient AI applications. For example, in such tasks power consumption may be critical. Such tasks include edge computing (e.g., biological computing's energy efficiency would make it ideal for low-power devices at the edge of networks, such as smartphones, wearables, or IoT devices) and sustainable AI (e.g., applications requiring large-scale data processing, such as climate modeling or AI in resource-constrained environments, would benefit from biological computing's ability to perform tasks with minimal energy consumption).

Another example task includes creative problem solving. For example, due to its non-linear, recurrent nature, biological computing might excel in tasks that involve creative problem-solving and thinking, including, for example, generative art and music (e.g., biological systems could generate more complex, evolving patterns in art and music, adapting to human feedback in real-time) and scientific research and discovery (e.g., in fields like drug discovery or physics, biological systems could explore solutions and hypotheses that silicon-based systems, constrained by predefined architectures, might not consider).

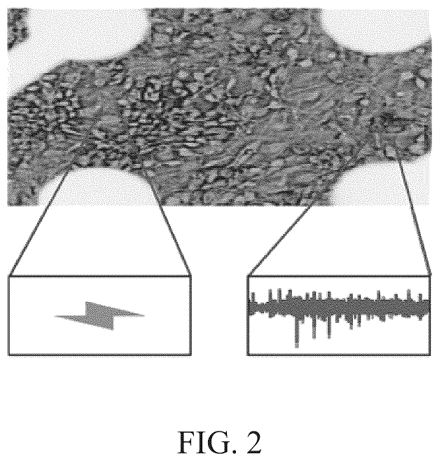

Components of the example BANN system 100 shown in FIG. 1 will now be further described herein. As shown in FIG. 1 and described herein, the BANN system 100 comprises a biological neural network 102. As described herein, the BNN 102 comprises a plurality of interconnected cells 110 arranged on an MEA 108. FIG. 2 illustrates a schematic diagram illustrating aspects of an example biological neural network, which may be an example of BNN 102, according to some embodiments of the technology described herein. The schematic diagram of FIG. 2 shows a plurality of interconnected cells 110 arranged on an MEA 108. In particular, FIG. 2 shows a schematic diagram of cultured brain cells arranged on an MEA. The white circles shown in FIG. 2 illustrate electrodes that stimulate the plurality of cells with electrical signals (e.g., electrical current) and which measure a response of the plurality of cells to the stimulation (e.g., by recording electrical activity of the plurality of cells, for example, in the form of voltage change(s)).

The plurality of cells may be brain cells, such as cortical cells, in some embodiments. For example, the plurality of cells may comprise neurons, microglia, and/or astrocytes. In some embodiments, the plurality of cells may comprise a mixture of different types of cells. In some embodiments, the plurality of cells comprise a plurality of neurons alone or in combination with a plurality of cells of one or more different types. For example, a cell culture comprising 50-60% neurons, 35-45% astrocytes, and 3-7% microglia may be used.

Neurons are brain cells which send and receive neurotransmitters and maintain an intracellular electrochemical gradient that can modulated based on interconnected cells and other extracellular environmental factors. Neurons transduce external inputs and can output responses to such inputs. As described herein, the BNN, and more specifically, the plurality of cells, are stimulated using electrical signals applied to the BNN by the MEA according to a stimulation pattern. Where the plurality of cells are neurons, the neurons respond to the stimulation, process the data, and respond in a manner which can be observed by recording the electrical activity of the neurons with the MEA.

FIG. 2 schematically represents communication with a biological network via stimulation, according to some embodiments of the technology described herein. As described herein, input data can be communicated to cells, including neurons, through stimulation in accordance with a particular stimulation pattern using the MEA. Neurons have naturally evolved to form networks and process information in high-dimensional spaces. This information can be utilized by encoding and decoding task-specific data using stimulation, which may be in the form of, for example, spatial, temporal and/or patterns.

Any suitable number of cells may be used in the MEA. In some embodiments, the plurality of cells (e.g., neurons) comprise approximately 50,000 cells, 75,000 cells, 100,000 cells, 125,000 cells, 150,000 cells, 200,000 cells, 500,000 cells, between 50 and 200 thousand cells, more than 200K cells or any other suitable number of cells. As an example, 100K cells may be equivalent to a 2.7 trillion parameter artificial neural network.

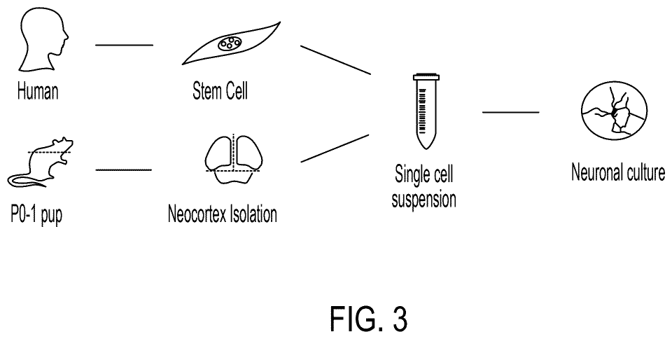

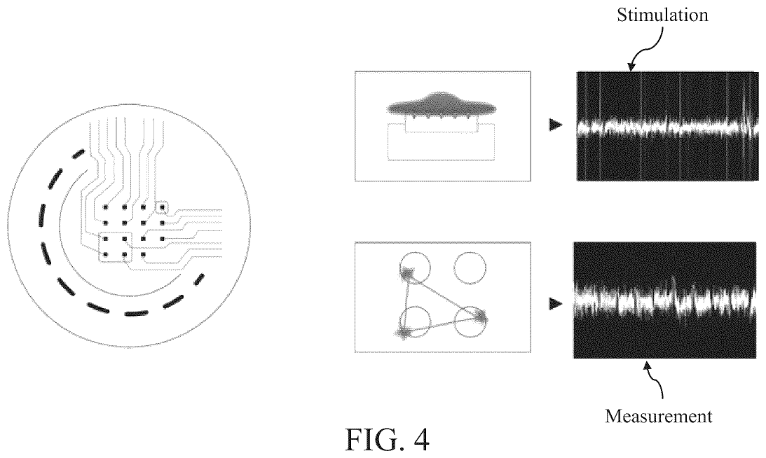

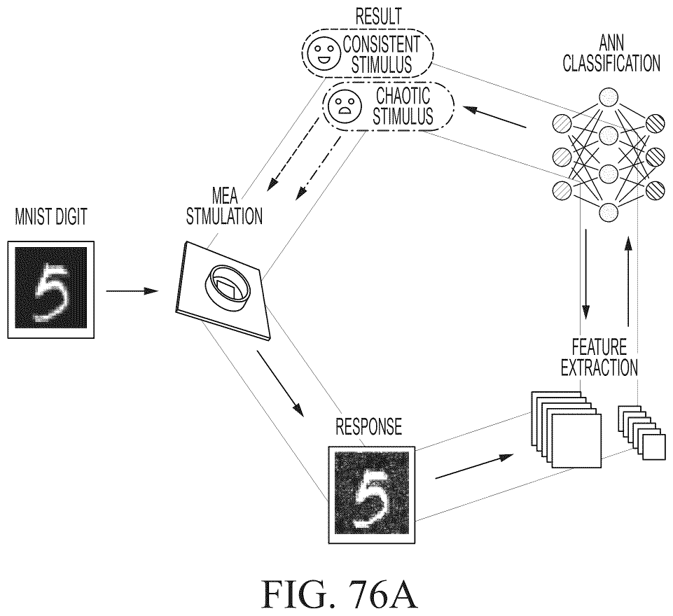

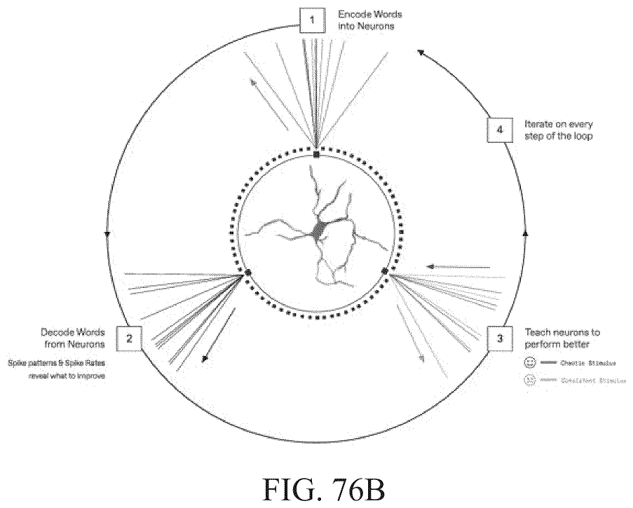

The preparation and/or culturing of cells for use as the BNN may be performed in any suitable way. For example, FIG. 3 illustrates a schematic diagram illustrating aspects of preparing a biological neural network, according to some embodiments of the technology described herein. In the schematic diagram of FIG. 3, a cerebral cortex is collected from 1-day-old neonatal rats and then enzymatically digested to isolate single cells. Alternatively or additionally, stem cells from humans are obtained. The cells are then plated on a high-density MEA. The neuronal culture forms synapses and is ready for stimulation and recording experiments after a suitable time has elapsed (e.g., approximately 14-21 days in vitro, in some embodiments). In the example of FIG. 4, living neurons incubated on electrodes are dissociated from their innate circuitry to form naïve networks that can be trained to perform one or more tasks (see, for example, FIG. 76A which illustrates closed-loop training of a BNN).

In some embodiments, the techniques include optimizing the biological neural network to perform a task prior to performing stimulation of the BNN. That is, the cells cultured on the MEA may be optimized for performance of a particular task. Optimizing the cell culture may include optimizing cell culture conditions (e.g., a type of cell culture media, temperature, humidity, gas concentration such a carbon dioxide) to meet particular thresholds. As an example, it may be desirable to obtain a cell culture having particular percentage of neuronal sub types. One example percentage that the inventors have found to be desirable for BANN applications is a cell culture comprising 55% neurons, 40% astrocytes, and 5% microglia. As another example, cell cultures comprising 50-60% neurons, 35-45% astrocytes, and 3-7% microglia may be used. Still other cell culture mixtures may be used. Accordingly, the conditions of the cell culture may be optimized such that the cell culture meets the particular thresholds.

The thresholds may be determined experimentally, in some embodiments. For example, the BANN system may be repeatedly used to perform a particular task, with percentages of cell types varying with each performance of the task. Performance of the task may be monitored to identify the cell type thresholds which produce the best performance of the task (e.g., highest accuracy performance of the task, for example). The cell type thresholds which produce the best performance of the task may therefore be designated as the target thresholds and optimizing the cell culture for performance of the task may include adjusting the conditions of the cell culture in order to achieve the cell type thresholds for the cell culture.

A further example of preparation of the BNN is described herein. For example, MEA plates may be coated based on standard published protocols. For most commercial MEA vendors, either poly-Dlysine (PDL) or poly-DL-omithine (PDLO), diluted in borate buffer (pH 8.4) (1 00 μg/mL) may be used to coat the MEA prior to culturing neurons.

In some embodiments, rat cortical neurons are cultured from newborn P1 Wistar rat pups of any sex. The cortices are dissected in a modified Puck's dissociation medium [100 mL 20× D 1 (8% NaCl, 0.045% KCl, 0.03% Na2HPO4.7H20, 0.0012% KH2PO4 in deionized water), 100 mL glucose/sucrose solution (6% anhydrous glucose+ 14.8% sucrose in deionized water), 50 mM HEPES buffer, pH to 7.4, osm to 320-330]. The cortex is then divided from the subcortical structures. Once dissection is complete, the cells are dissociated in a Puck's/papain solution (1.5 mM CaCh, 0.5 mM EDTA, 0.75% papain (Worthington Biochemical Corporation)), and decoded to perform computation with applications in general computing.

The viability percentage of cells in an example biological neural network, can be optimized, in some embodiments. For example, an experiment was performed based on cortical cultures having the following characteristics: an average of 164 days in culture, first recording taken 21 days after isolation, the longest culture of the data set being 200 days, and the longest successful recording being 19 hours. The cortical cultures were optimized for infection control and for cell viability according to known protocols. The neuronal cultures may also be optimized for specific computational applications (e.g., neuronal cultures optimized for computer vision applications may be different from neuronal cultures optimized for large language model (LLM) applications).

Returning to FIG. 1, as described herein, the BNN 102 comprises a plurality of cells 110 arranged on an MEA 108. In some embodiments, the BANN system 100 further comprises the MEA 108. The MEA 108 comprises a plurality of electrodes arranged in an array.

FIG. 4 is a schematic diagram illustrating aspects of a microelectrode array of a biological neural network system, according to some embodiments of the technology described herein. As described herein, one or more electrodes of the MEA 108 may be used to perform stimulation of the BNN by transmitting electrical signals to the plurality of cells. The MEA may include the plurality of electrodes as well as circuitry for performing the stimulation and/or recording of the cellular response. One or more electrodes of the MEA 108 may be used to record a response of the BNN to the stimulation. That is, one or more electrodes of the MEA 108 may record extracellular voltage of one or more cells cultured on the electrode, thereby capturing its electrical activity. The electrode(s) which perform the stimulation may be the same as or different from the electrode(s) that measure the response of the BNN to the stimulation. In some embodiments, some but not all of, the electrodes that perform the stimulation also perform the measuring.

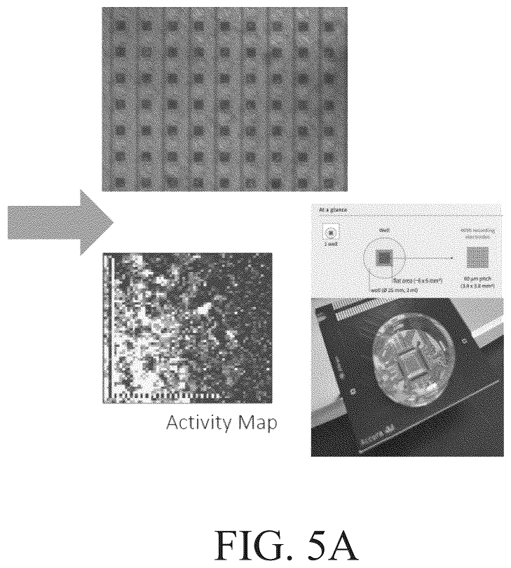

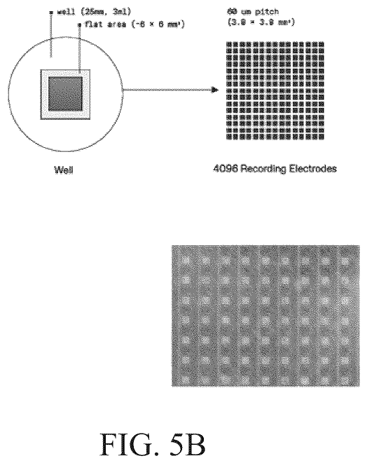

The MEA 108 may be any suitable size and including any suitable number of electrodes, examples of which are provided herein. FIGS. 5A-B illustrate aspects of example multielectrode arrays of a biological neural network system, according to some embodiments of the technology described herein. In one example, shown in FIG. 5A, the MEA comprises 4096 electrodes. The size of each electrode is 21×21 μm. The spacing between electrodes is 60 μm. The size of the recording area is 3.8 mm×3.8 mm. Stimulation is performed at 60 Hz. In another example, shown in FIG. 5B, the MEA comprises 4096 electrodes. The size of each electrode is 21×21 μm. The spacing between electrodes is 60 μm. The size of the recording area is 3.8 mm×3.8 mm. There are 277 stimulation endpoints per stimulation. Stimulation is performed at 500 Hz. In some embodiments, an example MEA comprises 26,400 electrodes per well, 3,625 electrodes/mm², and a recording area of 150×95×25 mm³. Other types of MEAs may be used including any suitable number of electrodes (e.g., between 1K and 10K electrodes, between 5K and 25K electrodes, more than 25K electrodes, etc.).

In some embodiments, the BANN system may include one or more components for maintaining the cells of the BNN (e.g., components for temperature control). The inventors recognized that long term recording in an incubator may be helpful for some applications of the BANN (e.g., for creating a dictionary of neural-based embeddings for a large corpus of tokens). In such embodiments, it is important to ensure that the BNN does not overheat with increased exposure and recording in the incubator. To do so, an optimal incubator temperature for long term recordings may be identified. As a non-limiting example, experiments may be performed at physiological temperature for cells of the BNN (e.g., equal to 37° C.), though other temperatures may be used.

Returning again to FIG. 1, the BANN system 100 further comprises a processor 106. The processor 106 controls aspects of the BANN system's functions. For example, the processor 106 may execute instructions encoded on a non-transitory computer-readable storage medium to control one or more components of the BANN system 100. In some embodiments, the instructions executed by the processor 106 cause the BANN system 100 to perform a task based on an input signal. As shown in FIG. 1, the processor is operatively coupled to other components of the BANN System 100, including the BNN 102, ANN 104, and memory 112.

As shown in FIG. 1, the BANN system 100 further comprises a memory 112. The memory may store, for example, instructions executed by the processor 106 for performing one or more methods with components of the BANN system 100. Components of the BANN system 100 may be stored in memory 112. For example, the ANN 104 may be stored in memory 112.

As shown in FIG. 1, the BANN system 100 further comprises one or more artificial neural networks 104. In other embodiments, the BANN system 100 may comprise one or more trained machine learning models other than an ANN (e.g., support vector machine, Gaussian mixture model, regression model, graphical model, etc.) in addition or instead of the ANN 104, or a combination of one or more ANNs and one or more other types of trained machine learning models.

The ANN 104 may be used in combination with the BNN 102, for example, to perform a task. As described herein, the ANN may, in some embodiments, process input for the BNN. For example, processing the input for the BNN may comprise generating at least one stimulation pattern for stimulating the BNN based on one or more input signals. In some embodiments, the ANN may process an output of the BNN. For example, processing the output of the BNN may comprise processing a response of the BNN to the stimulation and obtaining a response to the task as output. In some embodiments, the BANN system 100 comprises ANNs for processing an input for the BNN and for processing the output of the BNN. Any combination of one or more BNNs and one or more ANNs may be implemented in the BANN system 100.

Although the illustrated embodiment of FIG. 1 illustrates one of each components of the BANN system 100, in other embodiments, the BANN system 100 may comprise multiple of one or more of the components therein. For example, in some embodiments, the BANN system 100 may comprise multiple BNNs, multiple ANNs, multiple processors, and/or multiple memories, which components may be used in series or in parallel. For example, in some embodiments, the BANN system 100 may include multiple MEAs with respective cell mixtures disposed thereon and using such a system may involve stimulating cells on the multiple MEAs and measuring responses from the multiple MEAs.

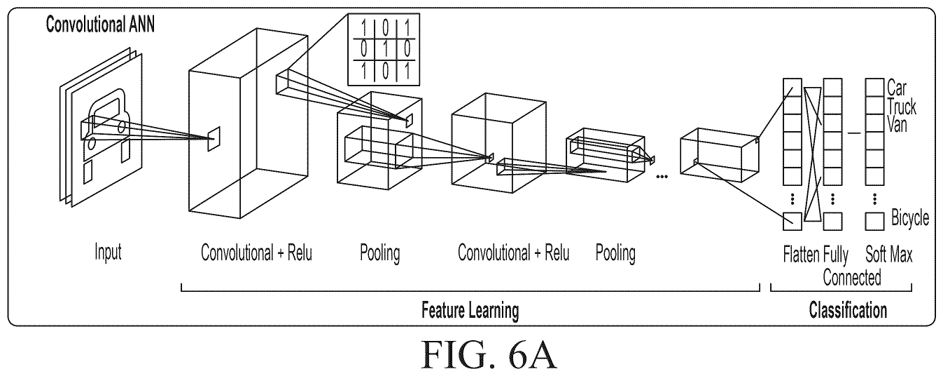

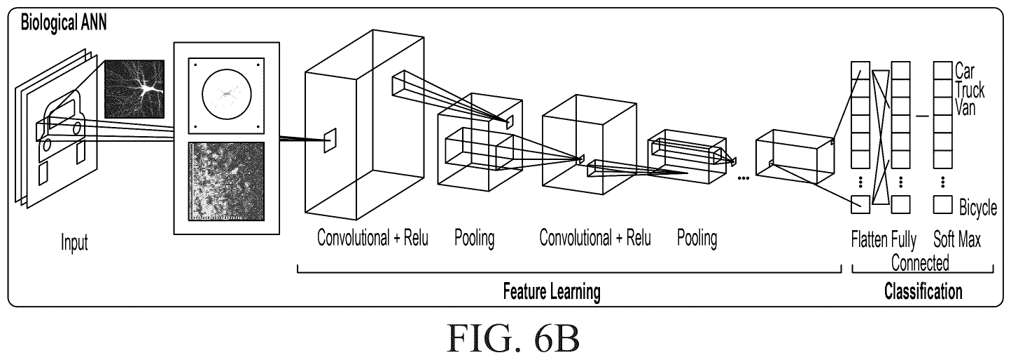

FIGS. 6A-B illustrate schematic diagrams comparing a conventional artificial neural network with a biological and artificial neural network, according to some embodiments of the technology described herein. FIG. 6A illustrates processing of data through a conventional ANN, which in the illustrated embodiment is a convolutional neural network. By contrast, the Biological ANN shown in FIG. 6B shows how a BNN can be integrated with the conventional ANN to form a BANN. As shown in FIG. 6B, the BNN receives input, processes the input utilizing the plurality of cells of the BNN to perform the processing. One or more cellular (e.g., neuronal) responses of the BNN, which may be in the form of spikes and patterns, can be input to the ANN for analysis. As described herein, the combination of a BNN and ANN into a BANN system results in more efficient and in some instances more accurate performance of a task (in this case, classification of an image) than a conventional ANN. For example the BANN system requires less power to perform certain tasks relative to performing the same task with the conventional ANN. In some instances, the BANN system requires less training iterations, and therefore less power, to learn how to perform a task relative to the number of training iterations required by the conventional ANN to learn how to perform the same task. All this constitutes an improvement to AI technology and to computer technology. Although in the illustrated example of FIGS. 6A-B, as described herein, the ANN processes an output of the BNN, in other embodiments, an ANN may additionally or alternatively be provided to generate an input for the BNN. For example, one ANN (e.g., an artificial neural network such as the one described with respect to FIG. 32A) may be used to generate input signals to stimulate the BNN, whereas another ANN (e.g., such as the ANN shown in FIG. 6A and/or FIG. 18A) may be used to process measured responses of the BNN. Accordingly, the combinations of one or more ANNs and one or more BNNs in a BANN system are not limited to the illustrated embodiment of FIG. 6 herein.

### III. Operation of Example BNN System

As described herein, the BANN system 100 may be used to process input data to perform one or more tasks (e.g., classification, prediction, dimensionality reduction, reinforcement learning, regression, etc.). Example operation of an illustrative BANN system is now described.

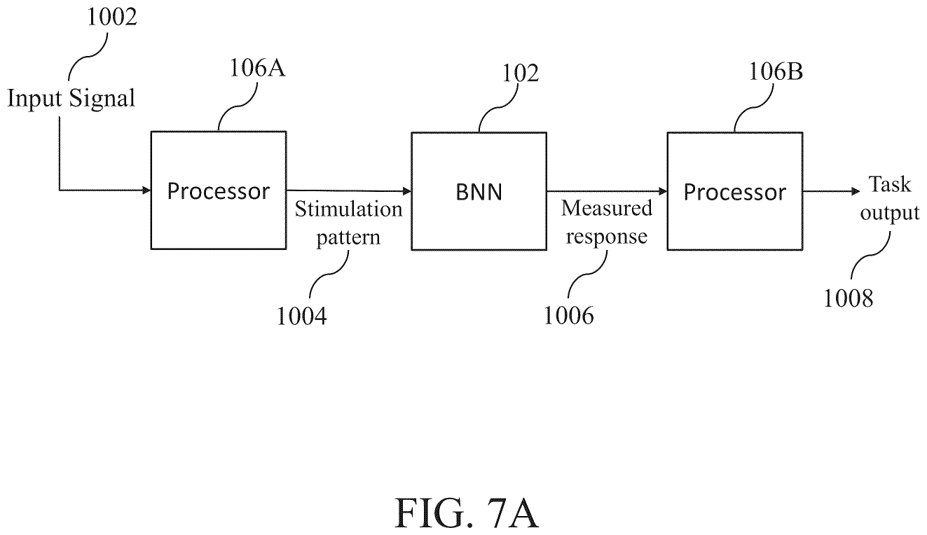

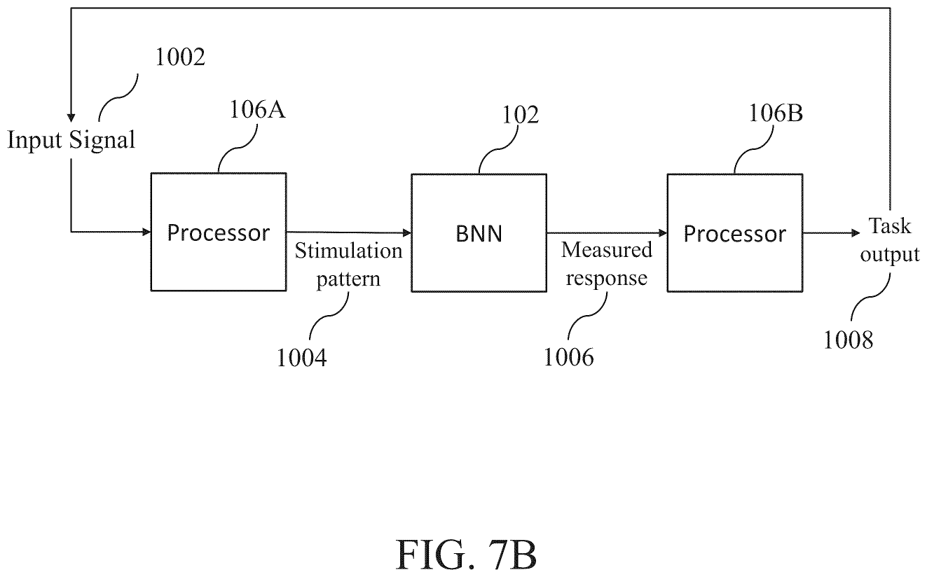

FIG. 7A is a schematic diagram illustrating an example workflow of an example biological neural network system, according to some embodiments of the technology described herein.

As shown in FIG. 7A, an input signal 1002 is provided to the system. The input signal is a signal that is to be processed by the BNN in furtherance of performing a task. The input signal may be any suitable type of input signal. For example, the input signal may comprise one-dimensional, two-dimensional, three-dimensional, or four-dimensional data, including temporal data and/or spatial data. For example, the input signal may comprise time series data. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images, and/or other types of images). In some embodiments, the input signal comprises one or more videos (e.g., multiple frames of images in a sequence). In some embodiments, the input signal comprises natural language text, numerals, and/or alphanumeric data. The input signal 1002 may be provided in digital form to the processor 106. Although a single input signal is shown in FIG. 7A, in some embodiments, the input signal may comprise multiple input signals.

The processor 106A receives the input signal 1002. The processor 106A uses the input signal 1002 to generate a stimulation pattern 1004 for the BNN 102. The stimulation pattern 1004 may be digital, which may be generated based on the digital input signal. That is, the digital input signal may be encoded by the processor to generate at least one stimulation pattern for stimulating the BNN. In some embodiments, as described herein, generation of the at least one stimulation pattern may be performed by processing the input signal 1002 with a trained statistical model, such as an ANN (e.g., a convolutional ANN). In other embodiments, generation of the at least one stimulation pattern may be performed by the processor 106A without an ANN.

The stimulation pattern 1004 may comprise a pattern according to which the BNN 102 is stimulated using one or more electrodes of the MEA. That is, the stimulation pattern 1004 provides instructions regarding how stimulation of the BNN 102 with the MEA is to be performed, which may include which electrodes to use to transmit electrical signals to the BNN, a timing of transmitting the electrical signals, and/or a frequency, voltage, and/or current, among other stimulation parameters of the electrical signals transmitted to the BNN. Thus, in some embodiments, the stimulation pattern may be a digital signal or other type of signal that, once provided to the MEA, may be used by the MEA to generate electrical signals to stimulate the BNN. In some embodiments, the input signal 1002 may be encoded by the processor 106 into the stimulation pattern 1004 spatially (e.g., by controlling which electrodes to use to transmit electrical signals to the BNN) and/or temporally (e.g., by controlling when particular electrodes transmit electrical signals to the BNN).

In some embodiments, such as where the input signal comprises an image, the stimulation pattern comprises a mapping between the input signal and the MEA. For example, the stimulation pattern may be a 1:1, or other suitable ratio other than 1:1 (e.g., greater than, less than), mapping between pixels of the input image to electrodes of the MEA, and the electrical signals transmitted by each electrode may depend on a characteristic of the image at the pixel corresponding to a respective electrode. For example, an intensity or other characteristic of the image at a particular pixel may correspond to a frequency, current, and/or voltage value of an electrical signal applied by the electrode corresponding to that pixel.

More specifically, in some embodiments, “Probe stimuli” may be encoded into the biological network through electrical stimulation, although other forms of stimulation (e.g., chemical, optical) may be used in addition or alternative to electrical stimulation, in some embodiments. Depending on the application, stimuli may be encoded spatially (3-dimensions), temporally, or both (4-dimensions). As an example, spatial encoding of numbers within the MNIST (numbers) or CIFAR 10 (real-world images) dataset may be encoded through monopolar electrical stimulation with multiple “endpoints,” spatially arranged along electrodes representing pixels within the electrode array. Stimulation endpoints vary based on the MNIST or CIFAR 10 character being encoded. Stimulation parameters (mono-vs. biphasic, variable pulse width and time, amplitude, and frequency of stimulation pulse, etc.) also vary based on optimized parameters for experimental conditions. As described herein, stimulus encoding may be interleaved with calibration to minimize burstiness and maximize stimulus encoding. Electrode parameters may also be optimized for experimental conditions and applications. In the case of MNIST encoding, a total of 10 electrode stimulation patterns are used. As described herein, in some embodiments, the electrodes used for stimulation may comprise the top responders (e.g., top 9) to broad stimulus in randomized order in a calibration process, with 30 ms between context stimulus, 120 ms to probe stimulus and a final 150 ms toward the next context stimulus, which repeats the loop. These parameters and total number of probe stimulus loops may be optimized for the given application.

According to some aspects, a goal of stimulating the BNN is to get neurons to fire spikes without damaging the neurons. In some embodiments, stimulation may be performed with a positive current followed by a negative current, which may evoke the most neural activity. The amplitude of the stimulation current may depend on the electrode technology, which may vary, as well as the biological process by which the cell cultures are plated onto the electrodes. In one example, the BNN may be stimulated in a range of 5-50 μA for each of the positive and negative phases of stimulation. The length of each stimulation phase may be 120 us with a 20 us pause between phases, which may vary if electrode technology or biological plating technique change. The frequency of this biphasic stimulation may vary between Ims and 1000 ms.

In some embodiments, a default current for stimulation may be 20 μA. The two-dimensional activity map of the MEA array may be analyzed to see if stimulation evokes clear spiking activity. In some embodiments, stimulation current may be lowered if the activity map shows a ‘burst’ of activity where most neurons fire (e.g., spike) rapidly yielding a spike count with a magnitude an order or more larger than non-burst trials. In some embodiments, stimulation current may be raised if the cell culture of the BNN has no or minimal response. Since each cell culture covers the MEA differently (e.g., some only partially cover the MEA) and since some cell cultures fire much more or less than others, the current level may be titrated based on what is reasonable for a cell culture based on previous recordings and based on non-stimulation ‘baseline’ activity. The level of current may change slightly for the same cell culture on different days because baseline, non-stimulation activity, has daily variations.

An example of a stimulation pattern is as follows: 20 μA positive current for 120 μs, then 20 μs no stimulation, finally 20 μA negative current for 120 μs. This pattern may be repeated on various electrode constellations every 200 ms.

As an example of time-based encoding, a BNN may be utilized to forecast stock market values based on historical data. An illustrative experiment employed an MEA with parameters consistent with those previously described. In the experiment, 100 days of S&P500 stock price fluctuations were encoded into the BNN by first identifying the two electrodes with the highest response to cellular (e.g., neuronal) stimulation. This was achieved by administering a stimulus pulse across all electrodes and selecting the two with the greatest response for stimulus presentation in a calibration process that is further described herein. The stimulus parameters included bipolar stimulation across these endpoints, biphasic stimulation at a frequency of 50 Hz for 10 seconds every minute, with a baseline current of 250 uA and 500uV. To encode the S&P500 values, daily percentage changes in stock prices were converted into corresponding changes in voltage, applying this formula to adjust the stimulus voltage. For instance, a 10% increase in the S&P500 index resulted in a stimulus of 550uV. This stimulation, which varied in voltage to reflect daily stock market changes, was repeated every minute for 100 minutes to simulate 100 days of data. In this experiment, the market data was analyzed by the BNN upon presentation through electrical stimulation.

In some embodiments, generating the stimulation pattern 1004 using the processor 106A may include transforming lower dimensional data to higher dimensional data. For example, in some embodiments, generating the stimulation pattern 1004 comprises transforming one-dimensional data into two-dimensional instructions for the MEA (which is a two-dimensional array of electrodes). This transformation may be performed, for example, by using a time-frequency transform (e.g., a short-time Fourier transform, a wavelet transform).

In some embodiments, generating the stimulation pattern 1004 using the processor 106 may include transforming higher dimensional data to lower dimensional data. For example, in some embodiments, generating the stimulation pattern 1004 comprises transforming three or four-dimensional data into two-dimensional instructions for the MEA (which is a two-dimensional array of electrodes). For example, where the input signal comprises video data, which is two-dimensional data over time (e.g., a time-series of images), generating the stimulation pattern may comprise taking each frame of the video and converting each frame into a respective stimulation. In further embodiments, each frame of the video may be converted into multiple stimulation patterns (e.g., from one frame to four stimulation patterns). For example, for a video that is 5 seconds long and 60 frames per second, there are 300 frames in the video. If each frame in the video is converted into four stimulation patterns, generating the stimulation pattern for the input video comprises generating 1200 stimulation patterns based on the 300 frames of the video. In some embodiments, an ANN may be used to generate multiple stimulation patterns from a single frame. For example, in some embodiments a three-dimensional kernel may be used to process three-dimensional spatial data (e.g., a single 3D frame) into multiple stimulation patterns (e.g., multiple 2D stimulation patterns) or 2D spatial data (e.g., a single 2D frame) into multiple stimulation patterns (e.g., multiple 2D stimulation patterns).

Once the stimulation pattern 1004 is generated, it can be applied to the BNN 102. Applying the stimulation pattern 1004 to the BNN 102 comprises operating one or more electrodes of the MEA to apply electrical signals to the plurality of cells of the BNN 102 in accordance with the stimulation pattern 1004 (e.g., according to the timing, location, and characteristics of the electrical signals defined by the stimulation pattern 1004). The stimulation pattern 1004 output by the processor may be a digital signal that is converted to an analog signal (e.g., by the MEA) when the stimulation is applied to the BNN 102. The processor of receiving the input signal 1002, generating the stimulation pattern 1004 based on the input signal, and stimulating the BNN 102 in accordance with the stimulation pattern 1004 may be referred to as encoding the input signal 1002 into the BNN 102.

As described herein, the plurality of cells of the BNN 102 process the input signals and respond to the stimulation. The response of the BNN 102, and in particular the response of the plurality of cells, is measured. Specifically, the cells output electrical signals, deflections in extracellular voltage, which may be recorded by one or more electrodes of the MEA as voltage values. The MEA electrode(s) which record the response of the BNN 102 to the stimulation may be different, the same, or partially the same as the electrode(s) that perform the stimulation.

In an illustrative example, an MEA system by 3Brain (Zurich, SW) is used for electrical recording. More specifically, in the one or more embodiments, a 4096 titanium-nitride electrode microelectrode array is used, with 21 μm diameter circular electrodes with 60 μm spacing between adjacent electrodes. Raw voltage from the electrode is digitized at 20 Khz and bandpass filtered (50 Hz-3 kHz) using a CMOS chip. Both the sampling rate and bandpass filtering are under software control and can be flexibly changed. The signal leaves the CMOS chip via a gold wire and is further processed using BioCAM Duplex hardware and sent to a high performance personal computer (PC). A thermostat maintains the temperature at 37 degrees Celsius underneath the MEA. Two control signal electrodes exist (Ch (1,1) and Ch (1,2)) in order to save a digital event every time the MEA resets charge and a digital stimulation event used to sync internal and external pulses, respectively. Sample data were transferred in real-time to a computer hard disk for later processing. Each electrode could be used for recording or for stimulation. Voltage stimulation consisted of monopolar or bipolar pulses varying in duration, amplitude and frequency of stimulation. An artifact lasting 0-3 ms caused by the electrical stimulation was induced on the recording electrodes, but was removed from the electrical recordings during data analysis.

In some embodiments, BNN activity may be measured by visualizing Calcium (Ca2+) transients. As an illustrative example of accomplishing this, rat mixed cortical cultures are virally transduced on day in vitro (DIV) 0 to express a neuron-targeted Ca2+ indicator (i.e.: R-GECO, pAAV.Syn.NES-jRGECOla). Neurons expressing R-GECO are imaged before and after electrical/chemical/optical stimulation for Ca2+ transients using a confocal microscope with a 40× objective. Cells are imaged for 5 min to obtain a baseline Ca2+ fluorescence (Fbaseline), then stimulated, allowed to process input data and imaged for 10 minutes.

As described and shown in FIG. 7A, the processor 106B measures the response of the BNN 102 to the stimulation to obtain a measured response 1006. The measured response 1006 may comprise one or more measurements, such as one or more voltage measurements and/or calcium transients, of the electrical signals generated by the BNN in response to the stimulation.

The measured response 1006 is provided to the processor 106B for processing. In some embodiments, the processor which receives the measured response 1006 may be the same processor or a different processor from the processor that generates the stimulation pattern 1004 based on the input signal. In some embodiments, the processor 106B comprises a trained statistical model, such as an ANN (e.g., a convolutional neural network). In some embodiments, the processor 106B comprises a trained statistical model (e.g., trained machine learning model) that is not an ANN. In other embodiments, the processor 106 processes the measured response 1006 without use of a trained statistical model. Processing the measured response 1006 with the processor 106B may include deriving one or more features, examples of which are described herein, from the measured response and processing the derived one or more features in furtherance of performing a task.

For example, in one or more embodiments, each probe stimulus is followed by a broad response across the entire biological network. This broad response comprises processing of encoded information that is presented to the MEA. This processing is captured by recording electrical activity (μV) from each of the 4096 (or less) electrodes up to 150 ms after probe stimulus. Extracellular voltages (spikes) are identified as time points when the recorded voltage trace exceeds a threshold of ±4 standard deviations from the baseline signal. Spikes are identified online and extracted as spike times occurring at each electrode or as spike patterns accounting for timing of spikes across electrodes.

For example, in one embodiment, before each stimulation (e.g., between −100 ms to −55 ms prior to a stimulation), the standard deviation of the raw voltage trace for each channel is assessed. The standard deviation is multiplied by a factor (e.g., 4-6). Any voltage below the 4-6 times the pre-stimulus standard deviation may be counted as a spike. Once the voltage threshold is crossed, counting spikes may be paused for at least a period of time (e.g., 0.5 ms), before starting counting spikes again.

The measured response 1006 transmitted to the processor 106 is an electrical signal obtained with (e.g., measured by using) the MEA. The processor 106B outputs a digital signal comprising a task output 1008 that is a response to the task requested of the BNN system. For example, where the task is a classification task, the input signal comprises an image, and the task output 1008 comprises an indication of a category to which the object represented in the image belongs.

FIG. 7B illustrates a schematic diagram illustrating a feedback loop in the example workflow of FIG. 7A, according to some embodiments of the technology described herein. The schematic diagram of FIG. 7B represents that, in some embodiments, the output of the processor 106B may be fed back into the BNN system as an input signal. Therefore, in some embodiments, the BNN system may be implemented with a feedback loop.

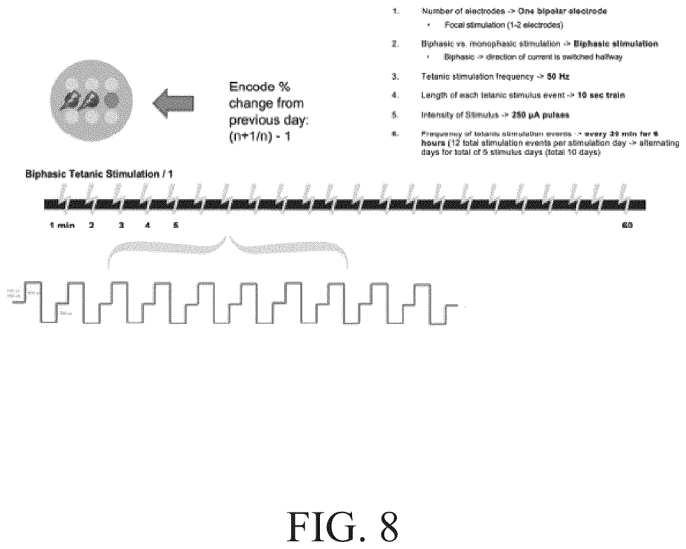

FIG. 8 illustrates aspects of stimulating a biological neural network, according to some embodiments of the technology described herein. FIG. 8 illustrates application of a BNN for data processing and prediction through encoded inputs. In FIG. 8, the process of encoding input signals (e.g., stock market variations in the illustrated example) into a BNN and predictions by the BNN on three subsequent trials (e.g., days) is shown.

In the illustrated embodiment of FIG. 8, 100 days of S&P500 stock price fluctuations are encoded into the BNN by first identifying the two electrodes with the highest response to cellular (e.g., neuronal) stimulation, in a calibration process that is further described herein. This was achieved by administering a stimulus pulse across all electrodes and selecting the two with the greatest response for stimulus presentation. The stimulus parameters included bipolar stimulation across these endpoints, biphasic stimulation at a frequency of 50 Hz for 10 seconds every minute, with a baseline current of 250 μA and 500 μV. To encode the S&P500 values, daily percentage changes in stock prices were converted into corresponding changes in voltage, applying this formula to adjust the stimulus voltage. For instance, a 10% increase in the S&P500 index resulted in a stimulus of 550 μV. This stimulation, which varied in voltage to reflect daily stock market changes, was repeated every minute for 100 minutes to simulate 100 days of data. Spikes from all electrodes were recorded after each stimulus to predict daily S&P500 value changes. For example, if 100 spikes were recorded after the first stimulus and 110 spikes after the second, the BNN predicted a 10% increase in S&P500 market capitalization.

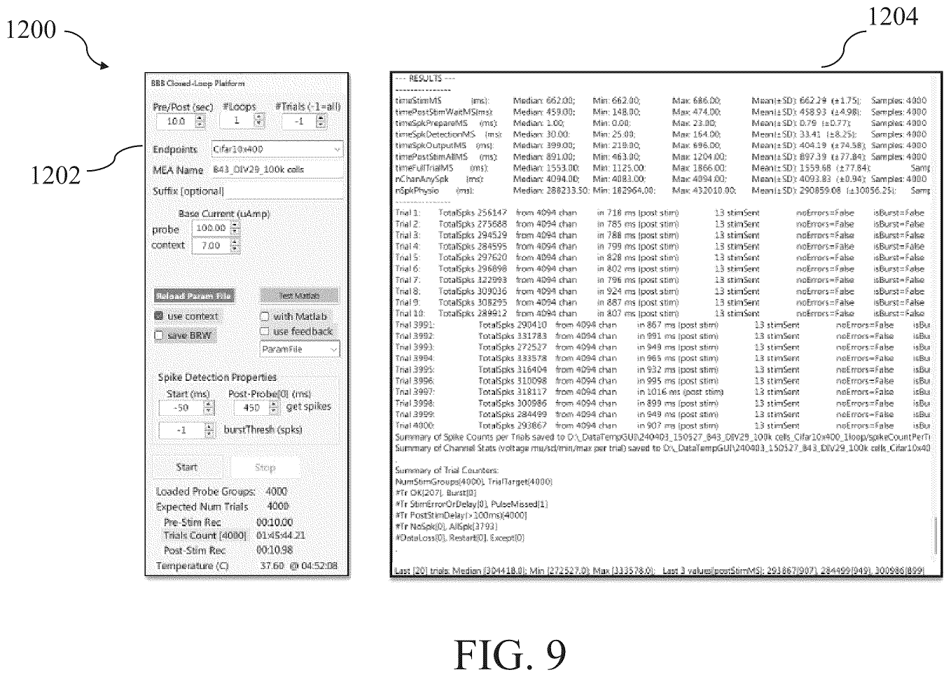

FIG. 9 illustrates an example graphical user interface (GUI) for use with a biological neural network system, according to some embodiments of the technology described herein. The GUI 1200 of FIG. 9 may be used to receive user input comprising one or more values for one or more parameters of the stimulation pattern. For example, the GUI 1200 enables input of different parameters for performing stimulation, including identification of a stimulation pattern (e.g., input characteristics such as voltage, current, and frequency, pattern such as which electrodes to use for transmission and timing of transmitting electrical signals, stimulation protocol). The GUI 1200 further enables viewing the cellular (e.g., neuronal) response of the BNN to the stimulation.

As shown in FIG. 9, the GUI 1200 comprises a first panel 1202 and a second panel 1204. The first panel 1202 enables a user to set experimental settings for the stimulation patterns, which can include pre/post baseline recording in seconds, a trial target which specifies a number of trial to run, and a number of loops (e.g., repetitions of all stimulation types) for the stimulation. The file name, date, and/or time may be added by a user or added automatically by the system. In some embodiments, the GUI comprises a closed-loop recording window which illustrates real-time spike detection. In the illustrated embodiment of FIG. 9, the GUI 1200 further includes the second panel 1204 which illustrates real-time stimulation and data acquisition.

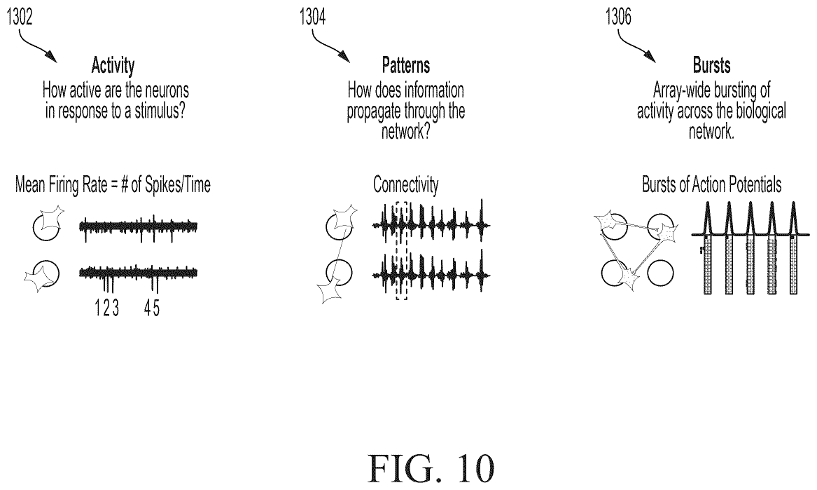

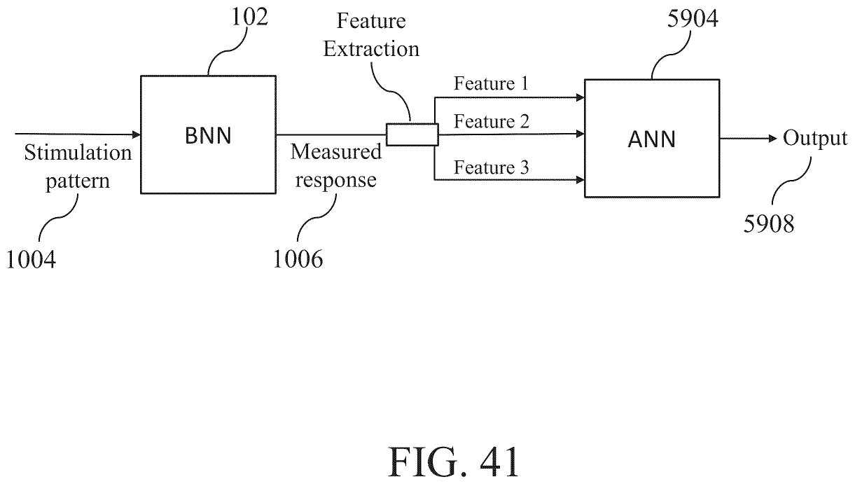

As described herein, a response of the BNN to the stimulation may be measured by one or more electrodes of the MEA. The measured response may comprise one or more voltage measurements and/or calcium transients. In addition, one or more features of the response may be derived from the response. Example features which may be derived from the response of the BNN to the stimulation are described herein (e.g., as described herein, for example with respect to FIGS. 41-47). FIG. 10 illustrates aspects of features that can be derived from features that can be derived from measurements that may be obtained in response to stimulation of a biological neural network, according to some embodiments of the technology described herein.

One class of features that can be derived from the BNN response is electrical activity. Electrical activity of the cells of the BNN can be recorded, reflecting how information is processed by the BNN, which can then be analyzed to extract one or more features from the measured response. Activity 1302 provides an indication of how active neurons are in response to a stimulus. Activity can be evaluated by measuring extracellular voltages (e.g., spikes). High spike values indicate neurons are firing frequently. Spike rates, which can be defined as rates of cellular (e.g., neuronal) firing, can be used to decode information processed within the BNN. Mean spike rate can be calculated as a number of spikes over a certain time period.

A second class of features that can be derived from the BNN response is patterns. Patterns 1304 represent how information propagates through the BNN. One feature in the class of patterns is connectivity. Synapses are functional connections between neurons. The pattern of neural activity (e.g., which neurons fire first in response to stimulation) reflects synaptic connections across the biological network. Patterns of neural activity can be used to decode information processed within the biological network. Patterns of neural activity with a temporal component are reflective of synaptic connections across the BNN.

A third class of features that can be derived from the BNN response is bursts. Bursts 1306 indicate array-wide bursting of activity across the BNN. Bursts of extracellular voltage include spontaneous bursts, occurring not in response to stimulation, and evoked bursts, occurring in response to stimulation. For the BNN, bursts are defined by alternating periods of high and low activity and are a hallmark of functional networks with excitatory and inhibitory neurons. Spontaneous bursts can interfere with information encoding while evoked bursts contain information about stimulus processing (e.g., from which features can be extracted, as described herein, for example, with reference to FIGS. 41-47).

An illustrative example of deriving features from a measured response is now provided herein. In this example, processing the measured response includes use of an ANN to process the measured response of the BNN. To accomplish performance of a classification task using a BANN, integrated spike rates from probe stimulus response are converted to images (.png images or any other suitable type of image) for each probe stimulus loop. Each of these images is then used as an image for training a convolutional neural network (CNN) layer. In parallel to spike-rate images, spike latency and Earth mover distance (EMD) values are used as additional ANN input features. These additional ANN input layers run parallel to the spike-rate CNN layer. Training is performed using standard ANN backpropagation, from outputs (digit classification) to inputs (e.g., various types of inputs described here such as spike-metric inputs). Epochs, batch size and total number of iterations are optimized for classification for each data set. Outcomes are reported as classification accuracy and total number of iterations to achieve steady state.

In some embodiments, spikes extracted after a stimulation can be used to decode cellular (e.g., neuronal) processing and a spike-rate image can be made. This may be achieved by counting the number of spikes from each electrode in a time window (e.g., 0-40 ms) following stimulation. The integer values resulting from these spike counts are placed in a 64×64 numerical array with a one-to-one mapping to the 64×64 electrode array. The numerical array may then be turned into an image or any other suitable 2D representation (or derivative thereof) and provided as input to the CNN.

In some embodiments, additional or alternative to spike rates, spike timing metrics may be used. Spike timing metrics provide a rich readout and can be used to decode cellular (e.g., neuronal) processing of encoded stimuli. Spike timing metrics that may be employed include: (1) the time of the first spike on each of the MEA electrodes and/or (2) the spike timing similarity between all pairs of trials. This latter metric is called the Earth mover's distance (EMD).

Therefore, a number of features of the BNN response may be obtained. Some features comprise or are derived from a measure of spikes of the BNN response. To obtain a measure of the spikes of the BNN response, a respective series of one or more voltages of the response may be measured by the MEA. A number of spikes in the response may be determined based on a number of the measured voltages which exceed a voltage threshold. For example, a voltage measurement may be analyzed to determine if it exceeds a voltage threshold set for spikes of the BNN response. If so, the measurement can be classified as a spike. In some embodiments, the next voltage measurement which qualifies as a spike make be required to occur after a threshold amount of time from the first spike has passed. In this way, individual spikes can be detected separately from other spikes of the BNN response. The threshold voltages and/or threshold times referenced earlier in this paragraph may be set in advance or, alternatively, dynamically adjusted during operation the MEA.

In some embodiments, the feature(s) derived from the response comprise a spike rate. In such instances, the spike rate may be determined by determining a number of spikes measured per time period (e.g., a 20 ms window) in one or more time periods. In some embodiments, measuring the at least one response of the BNN comprises measuring spectral information of response. In some embodiments, measuring the at least one response of the BNN comprises obtaining temporal information (e.g., spike timing, order of spikes, Earth mover's distance) from the response of the BNN. In some embodiments, multiple features of the response of the BNN may be derived from the measured response. For example, the multiple features may comprise one or more of a spike rate, latency, average latency, a sequence of images of the at least one response of BNN (e.g., multiple rate windows), and/or Earth mover's distance. In some embodiments, the information may be calcium influx information (e.g., measured using calcium imaging).

In some embodiments, the one or more features derived from the response may depend on the type of input signal, how the response of the BNN is processed, and/or the task being performed. Similarly, the manner in which input signals are encoded may depend on the input signal received. Input signals may be encoded spatially (e.g., for two-dimensional images), spatio-temporally (e.g., for three-dimensional data such as 3D spatial data or video data), or by a mapping (e.g., for the LLM examples described herein). In one example, where the task is a classification task and the input signal is an image (e.g., of a letter), the encoding is performed spatially and the features derived from the response comprise spike rates. In another example, where the task is a classification task and the input signal is an image (e.g., of a number from an MNIST dataset), the encoding is performed spatially and the features derived from the response comprise spike rates and/or spike patterns. In another example, where the task is a classification task (e.g., of an object from a CIFAR dataset) and the input signal is an image, the encoding is performed spatio-temporally, and the features derived from the response comprise sequences of rates of decoding (e.g., multiple rate windows). In another example, where the task comprises generating a neural-based embedding for a token, the input signal is a token (e.g., text), the encoding is performed by a mapping, described herein, and the features derived from the response comprise spike rates, spike patterns, and/or sequences of frames.

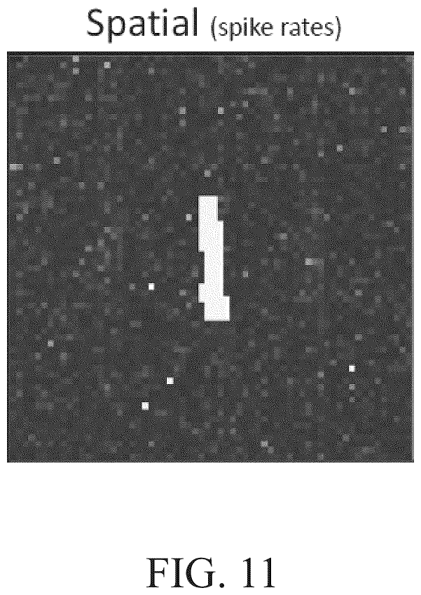

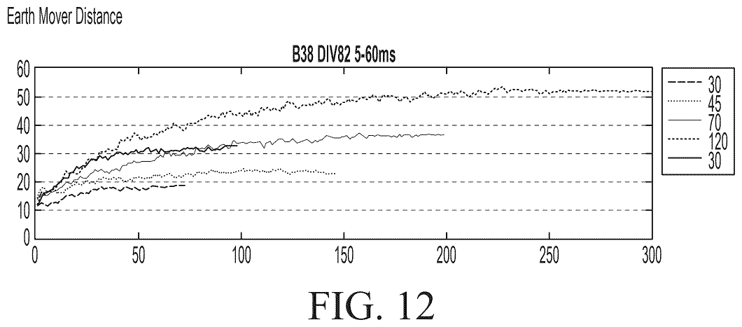

FIG. 11 illustrates spatial features that can be derived from measurements that may be obtained in response to stimulation of a biological neural network, according to some embodiments of the technology described herein. In particular, FIG. 11 illustrates an example representation of spatial measurements (spike rates) derived from a cellular (e.g., neuronal) response of the BNN to a stimulus. In this example, the BNN is used to perform a classification task. More specifically, the BNN is used to identify a number based on an input image.

In some embodiments, as described herein, temporal features can be derived from measurements that may be obtained in response to stimulation of a biological neural network, according to some embodiments of the technology described herein. In particular, one example of temporal measurements derived from a cellular (e.g., neuronal) response of the BNN to a stimulus is spike delays. In this example, the BNN is used to perform a classification task. More specifically, the BNN is used to identify a number based on an input image.

As described herein, spatial-temporal features can be derived from measurements that may be obtained in response to stimulation of a BNN, according to some embodiments of the technology described herein. In particular, one example of spatial and temporal measurements derived from a cellular (e.g., neuronal) response of the BNN to a stimulus is patterns of cellular (e.g., neuronal) activity. In this example, the BNN is used to perform a classification task. More specifically, the BNN is used to identify a number based on an input image.

The above example illustrates that multiple features of the cellular (e.g., neuronal) response may be obtained. In some embodiments, the features derived from the cellular (e.g., neuronal) response may be a combination of spatial (e.g., spike rates) and temporal (e.g., spike delays) features. The features may be combined and processed to generate an output. In this case, the spatial and temporal features are combined and processed together with an ANN in furtherance of performing the image classification. In some embodiments, use of patterns of cellular (e.g., neuronal) responses as opposed to spike rates alone improves the accuracy of the BNN system at performing the classification task.

FIG. 12 illustrates example features that can be derived from measurements that may be obtained in response to stimulation of a biological neural network, according to some embodiments of the technology described herein. In the example embodiments, the response is a neuronal response, however, in some embodiments the response may be a cellular response other than a neuronal response (e.g., where the cells also comprise astrocytes and/or microglia). In FIG. 12, the feature derived from the neuronal response of the BNN to the stimulation is Earth mover's distance (EMD). As described herein, EMD is the spike timing similarity between all pairs of trials.

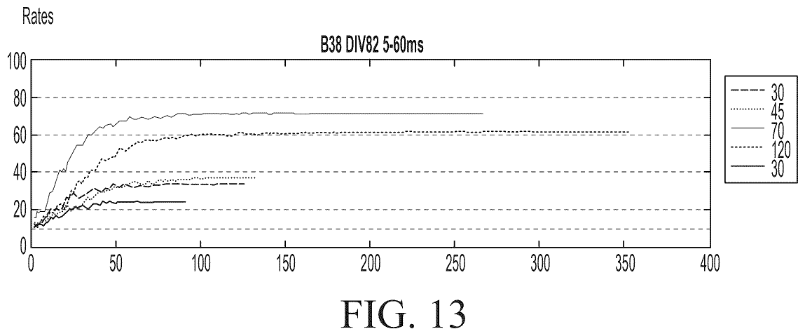

FIG. 13 illustrates an example feature that can be derived from measurements that may be obtained in response to stimulation of a biological neural network, according to some embodiments of the technology described herein. In FIG. 13, the feature derived from the neuronal response is spike rate. As described herein, spike rate is the number of voltage spikes above a threshold in a set time period.

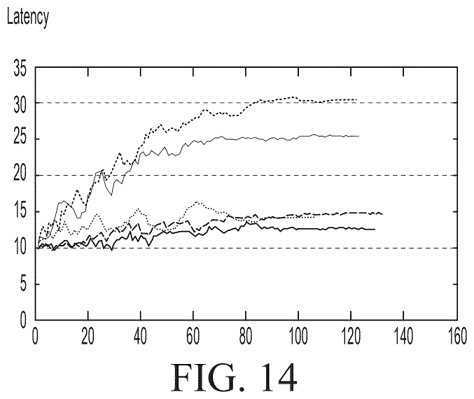

FIG. 14 illustrates another example feature that can be derived from measurements that may be obtained in response to stimulation of a biological neural network, according to some embodiments of the technology described herein. In FIG. 14, the feature derived from the neuronal response is latency. Latency is a measure of the time to the first spike after stimulation of the BNN. Latency can be measured at all electrodes of the MEA, in some embodiments. While spike rate is a digital measurement, latency is an analog measurement with nanosecond precision.

In some embodiments, the feature(s) derived from the neuronal response of the BNN to stimulation provide an indication of which neuron is responding to stimulation. This is in contrast to counting spikes of extracellular voltage from a particular neuron but further identifies from which neuron one or more spikes originate.

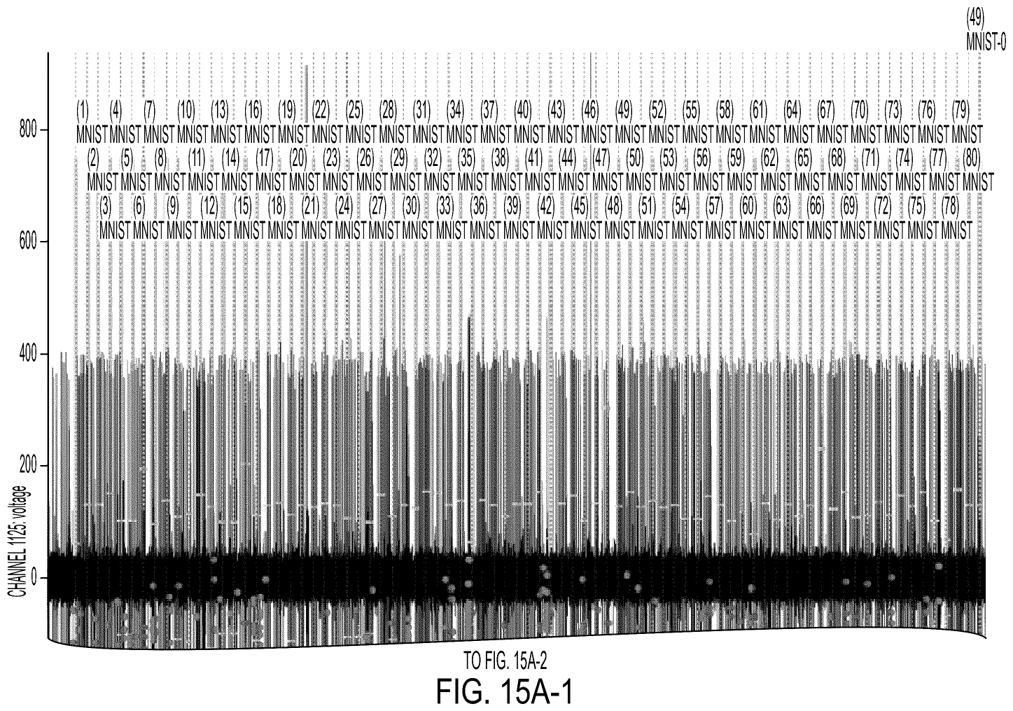

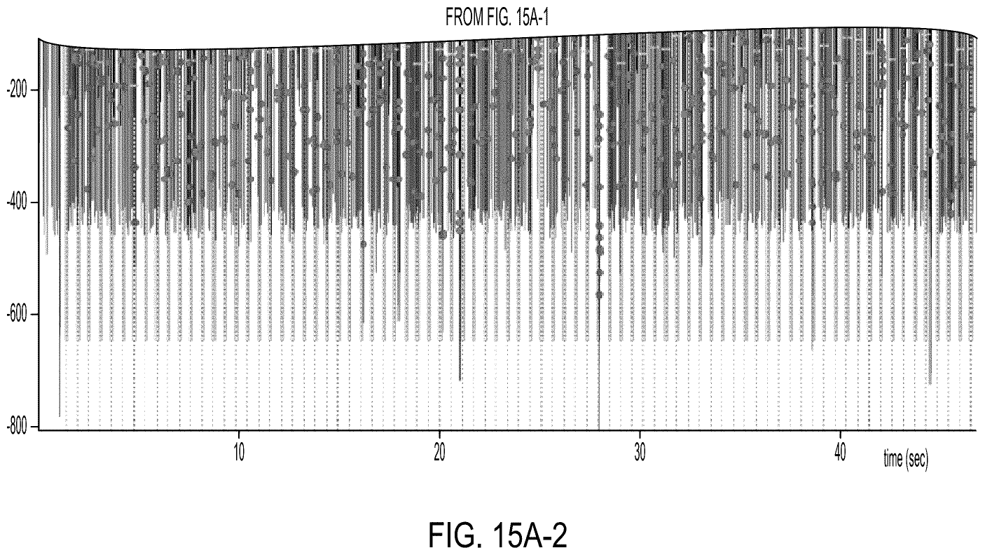

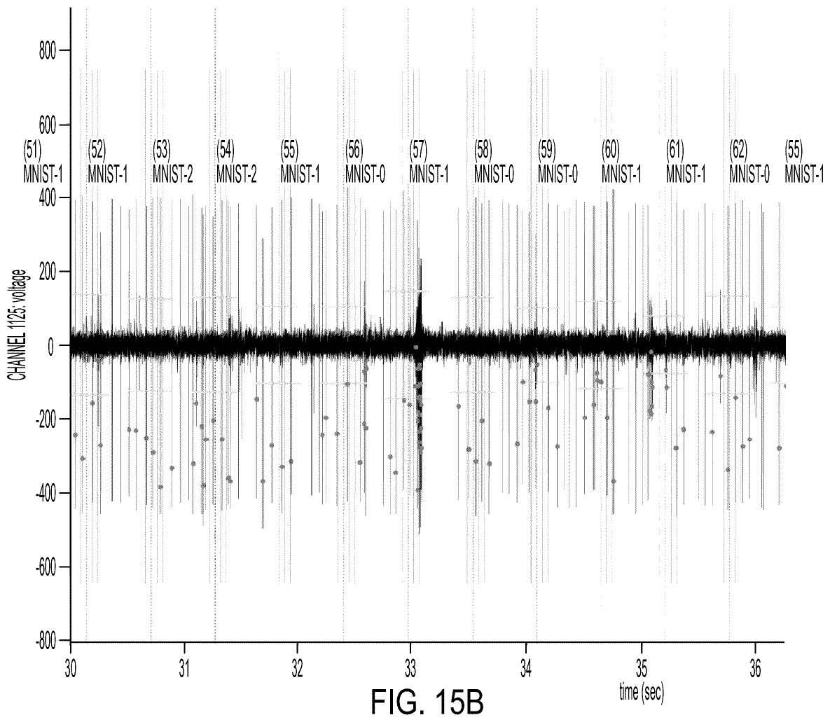

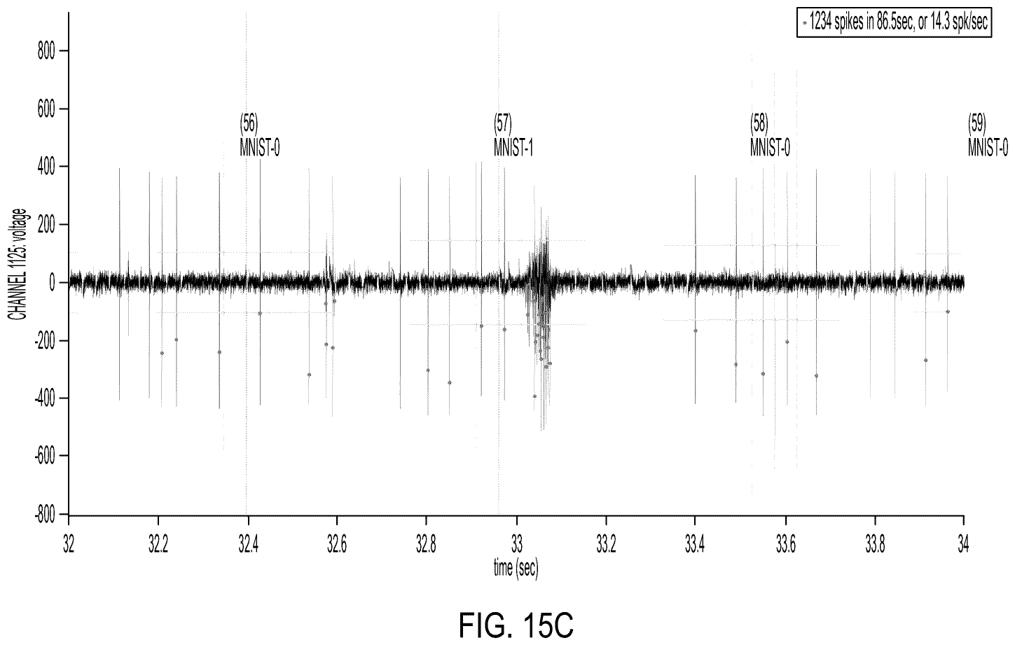

FIGS. 15A-1, 15A-2, and 15B-C illustrate example features that can be derived from one or more measurements that may be obtained in response to stimulation of a biological neural network, according to some embodiments of the technology described herein. In particular, FIGS. 15A-1, 15A-2, and 15B-C illustrate aspects of spike detection. As described herein, voltage spikes in the neuronal response can be detected. Counting spikes in a neuronal response should be performed quickly, in some embodiments. In some embodiments, spike detection is performed based on a sliding time window of measurements in contrast to embodiments where spike detection is performed offline by looking at a fixed point in time. In order to perform spike detection based on sliding windows of time, spikes should be identified sufficiently quickly (e.g., in less than 1 ms). FIGS. 15A-1, 15A-2, and 15B-C illustrate results of using a sliding window to identify spikes in the requisite time frame.

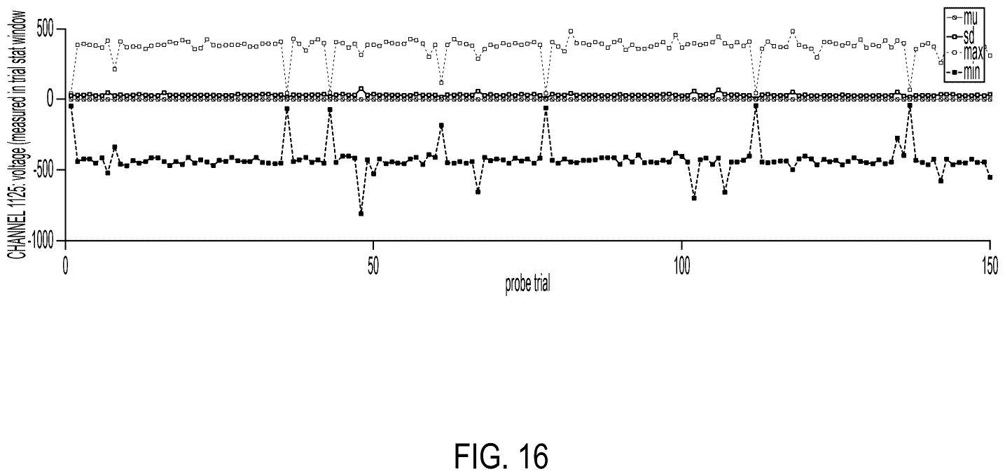

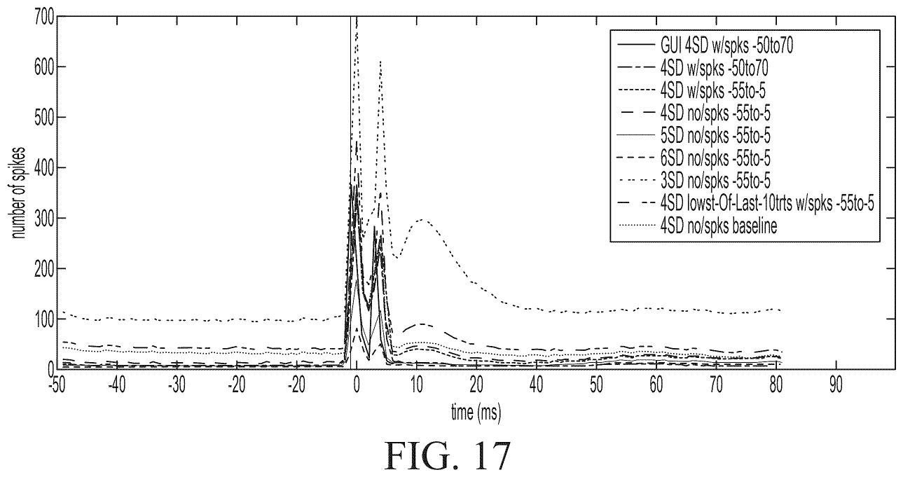

FIG. 16 illustrates example features that can be derived from measurements that may be obtained in response to stimulation of a biological neural network, according to some embodiments of the technology described herein. FIG. 16 illustrates spike detection that is performed “online”, that is, based on a sliding window of time. FIG. 17 illustrates example features that can be derived from measurements that may be obtained in response to stimulation of a biological neural network, according to some embodiments of the technology described herein. FIG. 17 illustrates a comparison of spike detection performed “online”, based on a sliding window of time, vs. spike detection performed “offline”, based on a fixed point in time. As shown in FIG. 16, offline spike detection is much slower than online spike detection. Online and offline spike detection may have comparable results in some situations, but one method may be preferrable over the other in other situations due to difference in accuracy and/or an amount of time taken to identify spikes (e.g., the online method being more computationally efficient if smaller sliding windows are used). In the context of closed-loop training of the BNN, online spike detection may be used.

### IV. Use of ANN to Process BNN Outputs

As described herein, the inventors have recognized that conventional ANNs can be improved by combining a BNN with the ANN to form a BANN system. In some embodiments, the ANN is used to process outputs of the BNN in furtherance of performing a task.

FIG. 18A illustrates a schematic diagram illustrating an example workflow of an example biological and artificial neural network system, according to some embodiments of the technology described herein. FIG. 18A is similar to FIG. 7A except that the processor 106B that receives the measured response 1006 of the BNN to stimulation by the stimulation pattern is replaced with an ANN 104B (which is executed on a processor, but the ANN is emphasized in this figure for clarity). Accordingly, some details of the workflow of FIG. 18A may be omitted where such details do not differ from the workflow of FIG. 7A.

As shown in FIG. 18A, an input signal 1002 is provided to a processor 106. As described herein, the input signal is a signal that is to be processed by the BNN in furtherance of performing a task. The input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal comprises natural language text, numerals, and/or alphanumeric signals. The input signal 1002 is typically provided in digital form to the processor 106. Although a single input signal is shown in FIG. 18A, it should be understood that in some embodiments, the input signal may comprise multiple input signals. In one example, the workflow shown in FIG. 18A is for performing a classification task of classifying a letter in an image. In such an embodiment, the input signal can be an image. Further aspects of the input signal 1002 applicable to the workflow of FIG. 18A are described herein with respect to the workflow in FIG. 7A.

As shown in the example of FIG. 18A, The processor 106 receives the input signal and generates a stimulation pattern 1004 for stimulating the BNN 102 based on the received input signal, as described herein. Further aspects generating the stimulation pattern 1004 applicable to the workflow of FIG. 18A are described herein with respect to the workflow in FIG. 7A. The stimulation performed by the processor 106 may include electrical stimulation, chemical stimulation, optical stimulation (e.g., using one or more lasers), and/or any other suitable form of stimulation of the BNN.

The stimulation pattern 1004 is applied to the BNN 102 by transmitting electrical signals to the plurality of cells of the BNN 102 using the MEA and in accordance with the stimulation pattern 1004. Further aspects applying the stimulation pattern 1004 to the BNN 102 applicable to the workflow of FIG. 18A are described herein with respect to the workflow in FIG. 7A.

A response of the BNN 102 to the stimulation is measured and provided to the ANN 104B for processing. Further aspects measuring a response of the BNN 102 applicable to the workflow of FIG. 18A are described herein with respect to the workflow in FIG. 7A.

In the embodiment shown in FIG. 18A, the ANN 104B processes the measured response 1006 to obtain a task output 1008. As described herein, the measured response may comprise measures of extracellular voltages and/or calcium transients in the neuronal response of the BNN to stimulation. In some embodiments, the measured voltages may be input directly to the ANN 104B. In other embodiments, the measured voltages may additionally or alternatively be processed to obtain an input for the ANN 104B. For example, processing the measured voltages may comprise deriving one or more features of the neuronal response from the measured voltages, as described herein. Further aspects of processing the measured response 1006 to obtain the task output 1008 applicable to the workflow of FIG. 18A are described herein with respect to the workflow in FIG. 7A.

The ANN 104B may be trained to process outputs of the BNN. That is, the ANN may be trained with training data that comprises neuronal responses of the BNN to training stimulation patterns. The training data may comprise measured extracellular voltages obtained in response to stimulation according to the training stimulation patterns and/or may comprise one or more features derived from the measured voltages. In some embodiments, the training data may comprise processed responses of the BNN, for example, may comprise one or more features derived from a measured response of the BNN. Training of the ANN using the neuronal responses of the BNN to training stimulation patterns may be performed in any suitable way.

FIG. 18B illustrates a schematic diagram illustrating a feedback loop in the example workflow of FIG. 18A, according to some embodiments of the technology described herein. The schematic diagram of FIG. 18B represents that in some embodiments, the output of the ANN 104B may be fed back into the BANN system an input signal. Therefore, in some embodiments, the BANN system can be implemented with a feedback loop.

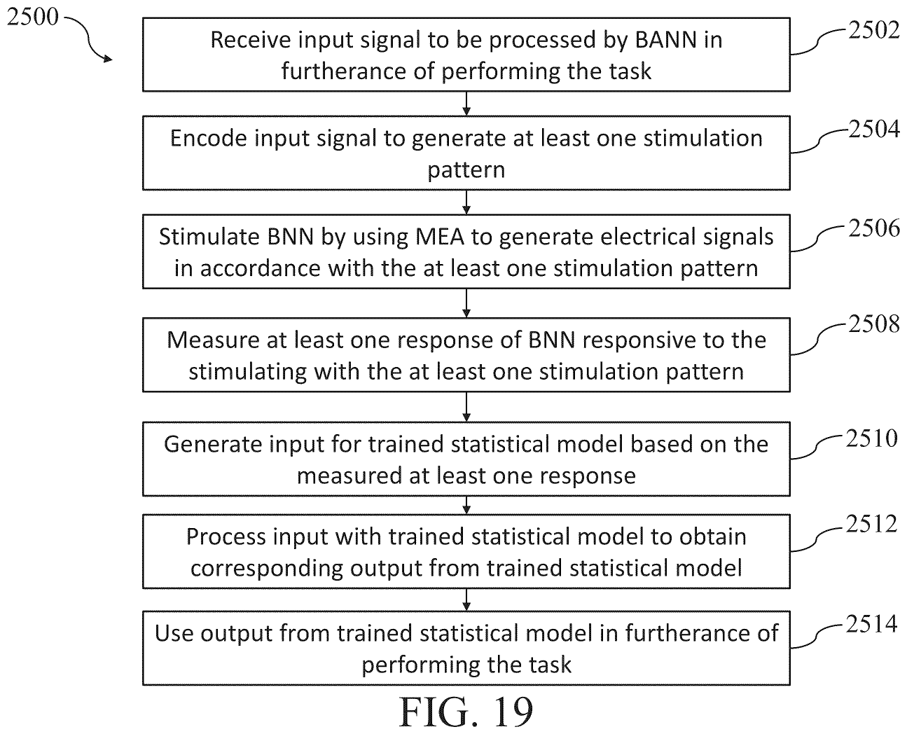

FIG. 19 illustrates an example method 2500 for performing a task using a biological and artificial neural network (BANN) system, according to some embodiments of the technology described herein. The method 2500 may be performed using a BANN system comprising an MEA, a BNN comprising a plurality of cells (e.g., neurons, microglia, and/or astrocytes) arranged on the MEA, a trained statistical model (e.g., a trained neural network or other type of trained statistical model) trained using inputs generated using responses of the BNN to training data inputs, and at least one processor. In this context, importantly, the trained statistical model may be trained on features derived from BNN responses to training data inputs. In this way, the trained statistical model is not merely some off-the-shelf pre-trained model or statistical method, but one that is trained using data derived from measured extracellular voltages obtained in response to cellular stimulation by the MEA according to the training stimulation patterns.

The method 2500 may proceed according to the workflow described herein with respect to FIG. 18A. For example, the method 2500 may begin at act 2502, where an input signal to be processed by the BANN in furtherance of performing the task is received. As described herein, the task to be performed may be any one of a number of tasks. For example, the task may be any one of classification, prediction, dimensionality reduction, reinforcement learning, regression, or the like. Further aspects of performing a task using a BANN system applicable to the method of FIG. 19 are described herein, for example, with respect to the workflow in FIG. 7A.

The input signal is a signal that is to be processed by the BNN in furtherance of performing a task. The input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal may comprises text (e.g., natural language text), alphabetic data, numeric data, and/or alphanumeric data. The input signal may be provided in digital form to a processor. Although a single input signal described in the method 2500, it should be understood that in some embodiments, the input signal may comprise multiple input signals.

At act 2504, the input signal is encoded to generate at least one stimulation pattern. As described herein, the encoding may be performed by a processor. In some embodiments, the processor may perform the encoding by using a trained statistical model (e.g., using a neural network), and the encoding of the input signal to generate the at least one stimulation pattern may be performed by processing the input signal with the trained statistical model. In some embodiments, the trained statistical model comprises an ANN, and the encoding of the input signal to generate the at least one stimulation pattern may be performed by processing the input signal with the ANN.

As described herein, the stimulation pattern may comprise a pattern according to which the BNN is stimulated using one or more electrodes of the MEA. That is, the stimulation pattern provides instructions regarding how stimulation of the BNN with the MEA is to be performed, which may include instructions for which electrodes to use to transmit electrical signals to the BNN, a timing of transmitting the electrical signals, and/or a frequency, voltage, and/or current of the electrical signals transmitted to the BNN. In some embodiments, the input signal may be encoded by the processor into the stimulation pattern spatially (e.g., by controlling which electrodes to use to transmit electrical signals to the BNN) and/or temporally (e.g., by controlling when particular electrodes transmit electrical signals to the BNN).

In some embodiments, such as where the input signal comprises an image, the stimulation pattern comprises a mapping between the input signal and the MEA. For example, the stimulation pattern may be a 1:1, or other suitable ratio other than 1:1 (e.g., greater than, less than), mapping between pixels of the input image to electrodes of the MEA, and the electrical signals transmitted by each electrode may depend on a characteristic of the image at the pixel corresponding to a respective electrode. For example, an intensity or other characteristic of the image at a particular pixel may correspond to a frequency, current, and/or voltage value of an electrical signal applied by the electrode corresponding to that pixel. Further aspects of encoding an input signal to generate a stimulation pattern applicable to the method of FIG. 19 are described herein, for example, with respect to the workflow in FIG. 7A.

At act 2506, the BNN is stimulated by using the MEA to generate electrical signals in accordance with the at least one stimulation pattern. As described herein, once the stimulation pattern is generated, it can be applied to the BNN. Applying the stimulation pattern to the BNN comprises operating one or more electrodes of the MEA to apply electrical signals to the plurality of cells of the BNN in accordance with the stimulation pattern (e.g., according to the timing, location, and characteristics of the electrical signals defined by the stimulation pattern). The stimulation pattern output by the processor may be a digital signal that is converted to an analog signal when the stimulation is applied to the BNN. The process of receiving the input signal, generating the stimulation pattern based on the input signal, and stimulating the BNN in accordance with the stimulation pattern 1004 may be referred to as encoding the input signal into the BNN. Further aspects of applying a stimulation pattern to the BNN applicable to the method of FIG. 19 are described herein, for example, with respect to the workflow in FIG. 7A.

At act 2508, a response of the BNN responsive to the stimulating in accordance with the at least one stimulation pattern performed at act 2506 is measured. As described herein, the plurality of cells of the BNN process the input signals and respond to the stimulation. The response of the BNN, and in particular the response of the plurality of cells, is measured. Specifically, the cells output electrical signals, called extracellular voltages, which can be recorded by one or more electrodes of the MEA as voltage values. The measured response may comprise one or more measurements, such as one or more voltage measurements and/or calcium transient measurements, of the electrical signals generated by the BNN in response to the stimulation. The one or more electrodes of the MEA which record the response the response of the BNN to the stimulation may be different, the same, or partially the same as the electrodes which perform the stimulation. BNN activity can also be measured by visualizing Calcium (Ca2+) transients. Further aspects of measuring a response of the BNN to the stimulating in accordance with the at least one stimulation pattern applicable to the method of FIG. 19 are described herein, for example, with respect to the workflow in FIG. 7A.

At act 2510, an input for a trained statistical model is generated based on the measured at least one response of the BNN at act 2510. In some embodiments, generating the input for the trained statistical model comprises processing the input, such as by deriving one or more features from the measured response. Further aspects of deriving one or more features from a measured response for processing applicable to the method of FIG. 19 are described herein, for example, with respect to the workflow in FIG. 7A. In other embodiments, generating the input for the trained statistical model comprises passing the measured response to the trained statistical model as input without processing the measured response.

At act 2512, the input generated at act 2510 is processed with the trained statistical model to obtain corresponding output from the trained statistical model. As described herein, the trained statistical model may be an ANN in some embodiments such that the processing at act 2512 is performed by processing the input with the ANN. For example, where the trained statistical model comprises an ANN, the ANN may be a neural network having one or more convolutional layers, a neural network having one or more recurrent layers, a neural network having a transformer architecture, or any other suitable neural network. In some embodiments, where the trained statistical model is an ANN, the ANN may be a convolutional neural network. In other embodiments, the trained statistical model is a trained statistical model other than an ANN (e.g., a support vector machine, a Gaussian mixture model, a graphical model, a regression, etc.). Further aspects of processing an input applicable to the method of FIG. 19 are described herein, for example, with respect to the workflow in FIG. 7A.

At act 2514, the output from the trained statistical model may be used in furtherance of performing the task. In some embodiments, the output from the trained statistical model is a response to the task (e.g., a classification of an image, for example). For example, the measured response transmitted to the ANN is an electrical signal obtained with the MEA. The ANN outputs a digital signal comprising a task output that is a response to the task requested of the BANN system. For example, where the task is a classification task, the input signal comprises an image, the task output comprises an indication of a category to which the object represented in the image belongs. Further aspects of using an output (e.g., from a processor) in furtherance of performing a task applicable to the method of FIG. 19 are described herein, for example, with respect to the workflow in FIG. 7A.

An illustrative example of the method 2500 is provided herein. For example, the input signal may comprise one or more images, the task may comprise a classification task comprising classifying the one or more images as belonging to one of a discrete set of classes, and measuring the at least one response of the BNN comprises measuring, using each of the one or more electrodes of the MEA, a respective series of one or more voltages and determining a number of spikes measured based on a number of measured voltages exceeding a voltage threshold.

Examples are further provided herein of using a BANN system, wherein an ANN is provided to process an output of the BNN. In a first example, the BANN system is used to perform classification of the letter “L.”

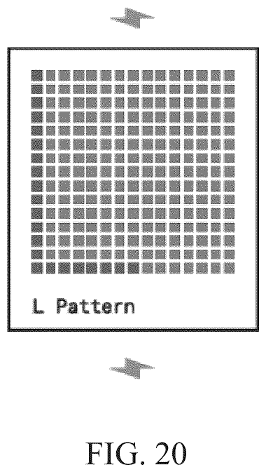

FIG. 20 illustrates a schematic diagram illustrating an example stimulation pattern for a biological neural network, according to some embodiments of the technology described herein. FIG. 20 illustrates a stimulation pattern for the first example described herein. The encoding of the letter L into the BNN is performed spatially by stimulating the BNN using electrodes disposed in particular locations that form an L shape. The decoding of the BNN response in this example is based on spike rates of the BNN response.

In some embodiments, the BANN system can be trained to reinforce the classification of the L shape by using tetanic stimulation. For example, in the first example, cellular (e.g., neuronal) learning through high-frequency tetanic stimulation in the shape of an L pattern can be performed to enable the BNN to learn and more easily recognize this pattern after learning.

In some embodiments, a neuronal response of the BNN to the stimulation pattern of FIG. 20 may be recorded. The captured neuronal response may be used for classification.

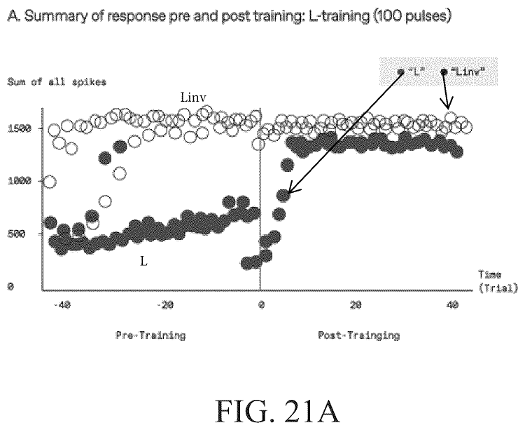

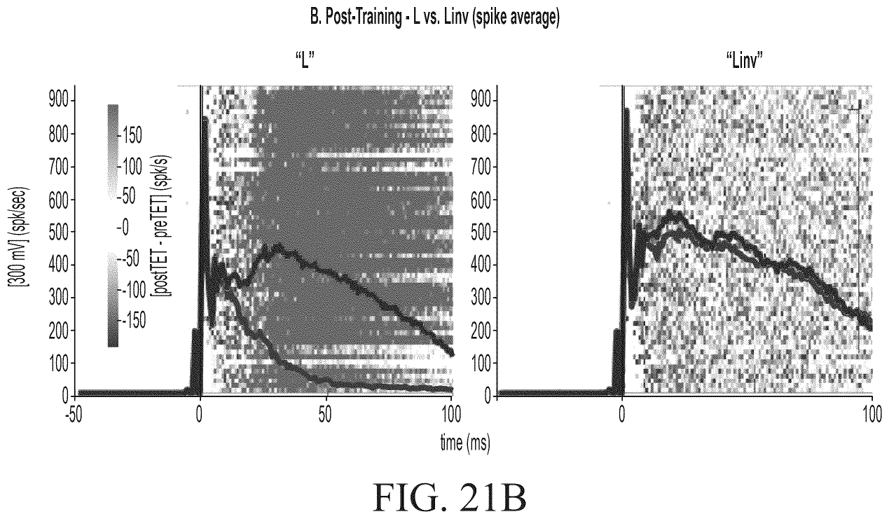

FIGS. 21A-B illustrate example results of a response of a biological neural network to stimulation, according to some embodiments of the technology described herein. FIGS. 21A-B illustrate performance of the ANN at classifying the L pattern before and after training via tetanic stimulation. The results show that the L pattern was learned after 0.4 seconds of tetanic stimulation. Learning is exhibited by the increased MEA-wide neuronal activity in response to L presentation after tetanic stimulation (green bubbles, right) when compared to L presentation prior to tetanic stimulation (green bubbles, left). This is contrast to the “inverted L (invL)” which was not presented during tetany and thus no change in MEA-wide activity was seen pre- or post-tetanic stimulation. In particular, FIG. 21A illustrates results of L classification after tetanic stimulation is performed. The neuronal response of the BNN was recorded both before training, as shown on the left of FIG. 21A, and after training via tetanic stimulation, as shown on the right of FIG. 21A. Closed circles represent the L pattern while open circles represent an upside-down L pattern, used as a control. The neuronal response across the plate was recorded.

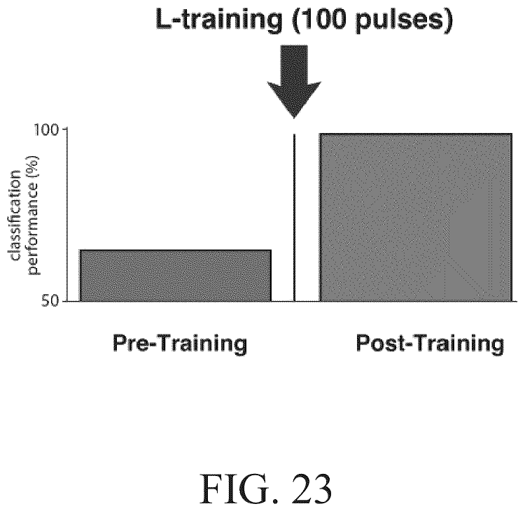

As shown in the right part of FIG. 21A, after training is performed, the neuronal response to the right-side up L pattern increased, while the neuronal response to the upside-down L pattern remained unchanged. This increase in neuronal response (as defined by increased MEA-wide response) of the right-side up L pattern after training suggests that learning occurred in 0.4 seconds. These results were reproducible across multiple MEAs and multiple data. The neuronal response may be provided to a classifier, such as in the example shown in FIG. 23, for example.

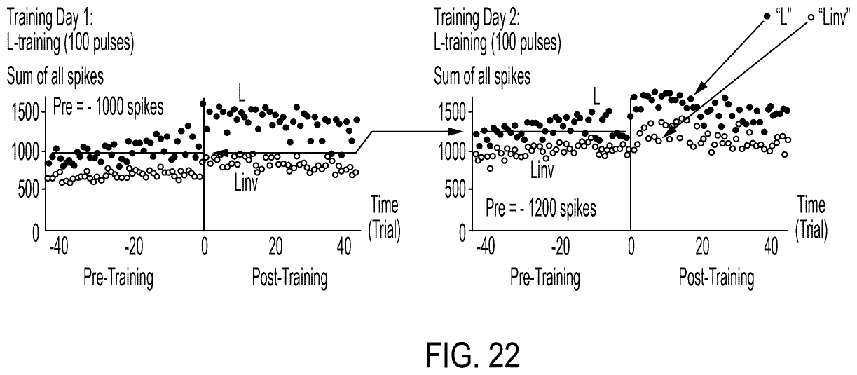

FIG. 22 illustrates example results of a biological neural network at classifying a letter in response to stimulation, according to some embodiments of the technology described herein. The results in FIG. 22 relate to accuracy of L classification across multiple days. In particular, to determine if training of the L pattern persisted over time, the baseline response to the L pattern stimulation 24 hours after initial training was evaluated. A sustained increase in the baseline response on the second day was observed, suggesting that the L training was retained. The results showed that subsequent training further improved L classification.

FIG. 23 illustrates a difference in classification performance of the biological neural network before and after training is performed, according to some embodiments of the technology described herein. In particular, when comparing the energy cost of classifying the L pattern by a BNN (using 0.4 seconds of tetanic stimulation) to the theoretical energy consumption required for training an ANN to classify the same pattern, a 5-fold energy savings with the BANN compared to the ANN was observed. In the example of FIG. 23, the ANN comprises a naïve Bayesian classifier which received array-wide spike rates as input to the classifier.

For example, for BNN L training using a standard MEA set up, the following conditions were used: 100 presentations of the letter L and training with 0.4 seconds of tetanic stimulation. The theoretical energy consumption was 4.15e=19 J/cell (*200,000 cells), 8.3e-14 J for entire well, 2.1e-13 W per training event, and 2.1e-11 W total training. The actual energy consumption (in kilowatt meters) was 10 W. For ANN L training using a standard laptop setup, the following conditions were used: 60,000 images and 20 minutes of training. The energy consumption was 50 W which provided 5-fold energy savings. The theoretical energy savings for future experiments would be higher (billion fold). Using a Naïve Bayes Classifier, model input included spike rates averaged over a first 50 ms. For the dataset, 80% was used for training and 20% for testing with 20 times cross validation. The accuracy of the BANN was comparable to the ANN, both being greater than 95% accurate.

The results of using a BNN to classify a letter (e.g., the letter L) in response to stimulation, may be recorded show that such classification using the BANN is reproducible. For most MEAs, increase in accuracy when using tetanic stimulation for learning was significant for the majority (green shading) of currents tested and for up to ⅔ of cases tested.

A prediction of metrics for successful letter classification (e.g., the letter L) by the biological neural network may be generated, in some embodiments. Through this analysis, it was found that low frequency tetanic stimulation for learning was more successful than high frequency tetanic stimulation. The success of tetanic stimulation for learning was dependent on current, with greater success at greater than 10 μA. In addition, plates with higher baseline firing rates had better response to tetanic stimulation.

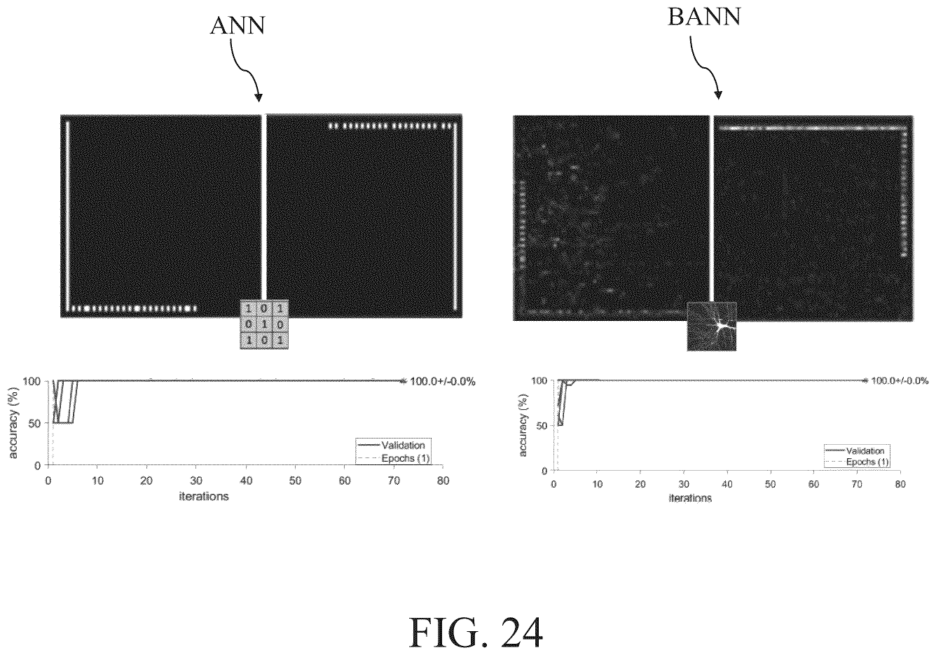

FIG. 24 illustrates aspects of performing a classification task using a biological neural network, according to some embodiments of the technology described herein. FIG. 24 provides an example of using neuronal responses of a BNN to train an ANN. In the illustrated example, the ANN comprises a CNN. FIG. 24 relates to the example provided herein for classifying the letter L. FIG. 24 compares results of a CNN trained either on the L image (ANN) or neuronal responses to L pattern stimulation (BANN). For the BANN, the decoding is based on spike rates derived from the neuronal response. The results show 100% accuracy of classification for both the BANN and the ANN, but with a 50% reduction in training iterations when using a BANN to perform classification as compared to when using an ANN (CNN) alone. This example clearly illustrates that a BANN can be trained with fewer computational resources (due to fewer training iterations required) to achieve results comparable to a conventional CNN, in accordance with the novel techniques described herein. This underscores the improvement to AI technology and computer technology provided by the techniques developed by the inventors and described herein.

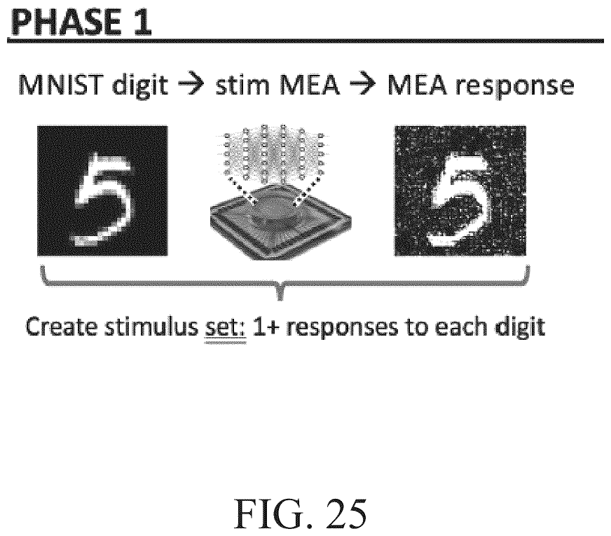

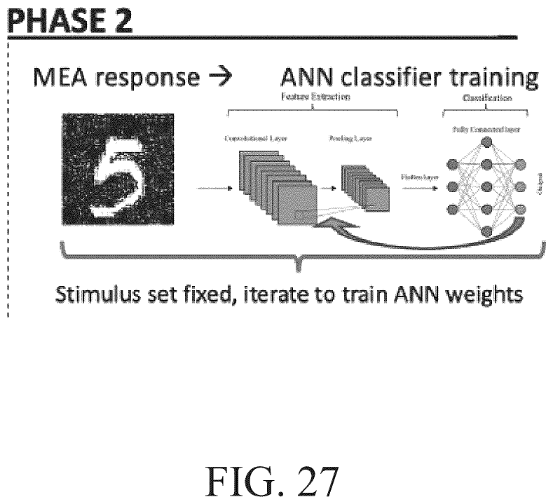

FIG. 25 illustrates aspects of performing a classification task using a biological neural network, according to some embodiments of the technology described herein. FIG. 25 illustrates a workflow for the first example experiment using the BANN system of FIG. 18A to classify the letter L, and further to a second example experiment using the BANN system of FIG. 18A that utilizes an ANN to process an output of the BNN. In the second example shown in the workflow of FIG. 25, the task is classification of an MNIST digit, specifically the number 5. FIG. 27 illustrates further workflow of these examples.

For example, FIGS. 25 and 27 depict a schematic process of encoding visual patterns (e.g., MNIST, CIFAR10, etc.) into a biological neural network, using this encoding for spike or pattern extraction and combining this data into a novel BANN (biological-artificial neural network) architecture. Probe stimuli (e.g., the “5” MNIST digit) are encoded into the biological network through electrical stimulation (spatially in this case but can be encoded temporally) on the MEA. Each probe stimulus is followed by neuronal processing which is represented by a broad response across the entire biological network. This is captured by recording electrical activity (μV) from each of the electrodes and is represented in the spike-rate image (electrodes that are mapped on to the ‘5’ pixels in addition to peripheral electrodes underlying neurons highly connected to neurons under the ‘5’ pixels). Each of these images is then used as an image for training a convolutional neural network (CNN) layer. Parallel to spike-rate images, spike latency and Earth mover's distance values are used as additional ANN input features. Standard ANN classifier training is performed using these multiple biological input types. FIGS. 25 and 27 specifically depicts the processing of MNIST digit of “5”.

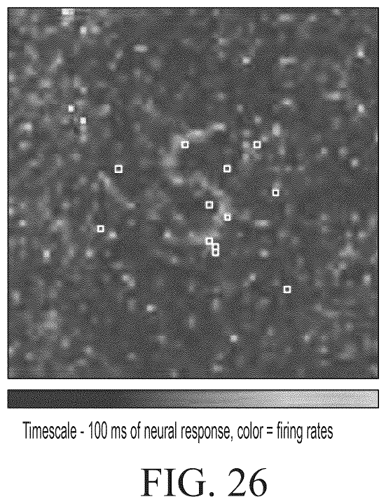

FIG. 26 illustrates a response of a biological neural network to a stimulation pattern applied to perform a classification task using the biological neural network, according to some embodiments of the technology described herein. FIG. 26 relates to the examples described herein for classifying an MNIST digit. In this example, classification performance of BANN on handwritten digits (0-9) of MNIST data was evaluated. Performance of a CNN trained on neuronal responses to MNIST digits was compared with a CNN trained on MNIST digitals alone. The heatmap in this image represents total number of spikes in a 100 ms window with brighter spots representing more spikes. The array is a 64×64 microelectrode array with each pixel representing a single electrodes. The BANN showed improved accuracy with fewer training iterations compared to the standard CNN. Here, the encoding of the MNIST digit into the BNN is performed spatially and the decoding of the BNN response to the stimulation is performed using spike rates. FIG. 26 in particular illustrates stimulation of an MNIST character (the center of the image) and recording of the neuronal response of the BNN to the stimulation according to the stimulation pattern generated from the MNIST image.

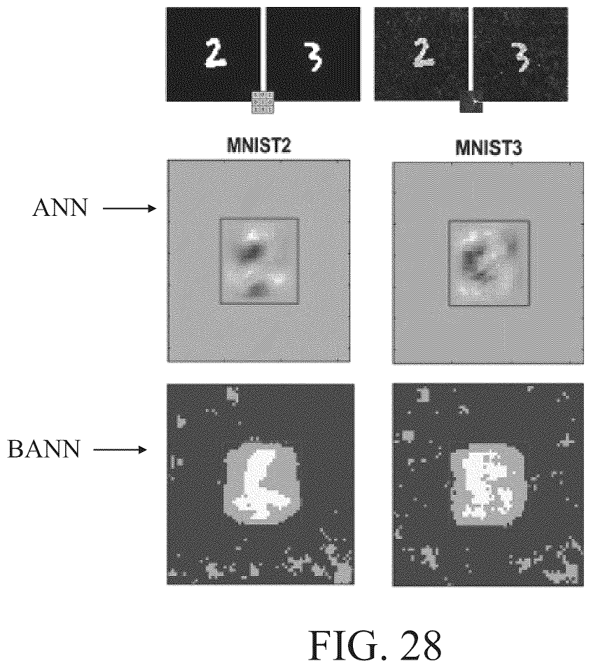

FIG. 28 illustrates a comparison of results of a biological neural network and an artificial neural network at performing a classification task, according to some embodiments of the technology described herein. The results of FIG. 28 relate to the example using the BANN system to perform classification of an MNIST digit. FIG. 28 illustrates that the BANN is more accurate than an ANN (e.g., CNN) alone in classifying 10 MNIST numbers. The green maps are weight matrices showing results from the CNN (top) and the BANN (bottom). The BANN uses connected neurons peripheral to the center number as features for classification which allows it to be approximately 10% more accurate. In the example results of FIG. 28, the input to the BANN is a 64×64 array of spike rates after MNIST stimulation. The input to the ANN is a 64×64 array of the original grayscale MNIST digits.

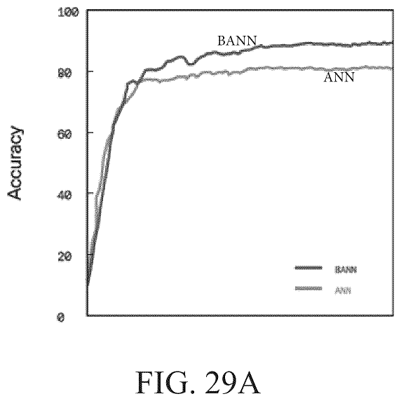

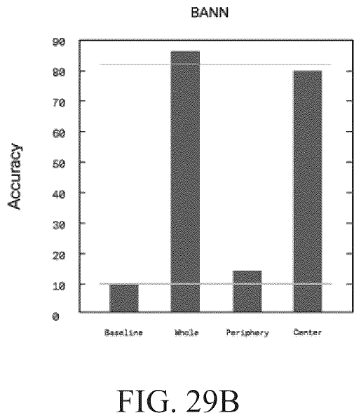

FIG. 28 illustrates how the BANN improves the accuracy and efficiency of multi-class (10 classes) classifications of MNIST characters. FIG. 28 shows the representative weight matrices post-classification for ANN (top) and BANN (bottom) for the characters “2” (left) and “3” (right). ANN classification (top) relies on modifying pixel weights immediately surrounding the 24×24 pixel character space (indicated by a box). Here, a brighter shading signifies the upregulation of pixels, while a daker shading denotes their downregulation. In contrast, BANN classification modifies pixel weights not only within the 24×24 pixel character space (in the box) but also in the additional 3520 peripheral pixels. The brighter shading highlights the top 5% of pixels used for classification, and the darer shading the top 20%. The pixels involved in classification outside the 24×24 pixel character space represent neurons highly connected to those activated directly by electrical stimulation (arranged spatially as “2” or “3”), thereby providing additional features for classification. FIG. 29A shows that the BANN network architecture is approximately 10% more accurate than a standard CNN network architecture at steady state. FIG. 29B shows that classification of 10 MNIST characters depends on the stimulation of peripheral pixels, thus incorporating additional features exclusive to the highly connected biological network. At baseline (left), there is a 10% chance of classification. Classification using only the 24×24 pixel character space (center) yields a result similar to ANN (approximately 80% classification). However, combined classification from both the 24×24 pixel character space and peripheral pixels (whole) results in improved accuracy over ANN (around 88%). Classification relying solely on peripheral pixels (periphery) achieves an accuracy roughly 8% above chance (10%). Through testing the BANN, it was found that the BANN achieves steady state with fewer iterations than the ANN, making it a more efficient system for MNIST classification. Overall, the data suggests that encoding MNIST digits through a biological network increases both accuracy and efficiency due to the enhanced dimensionality and neuronal processing of data and the resultant increase in the total number of features used for classification.

A comparison of efficiency of a biological neural network and an artificial neural network at being trained to perform a classification task demonstrates that the BANN improves computational efficiency over a purely in silico CNN at performing classification tasks (with same or better accuracy), for example in the context of MNIST digit classification. Indeed, the BANN (bottom) has fewer iterations to steady state than the CNN (top). As fewer iterations are required for training, and both the ANN and BANN achieve similar accuracy, use of the BANN provides for critical computational savings, which imply energy savings.

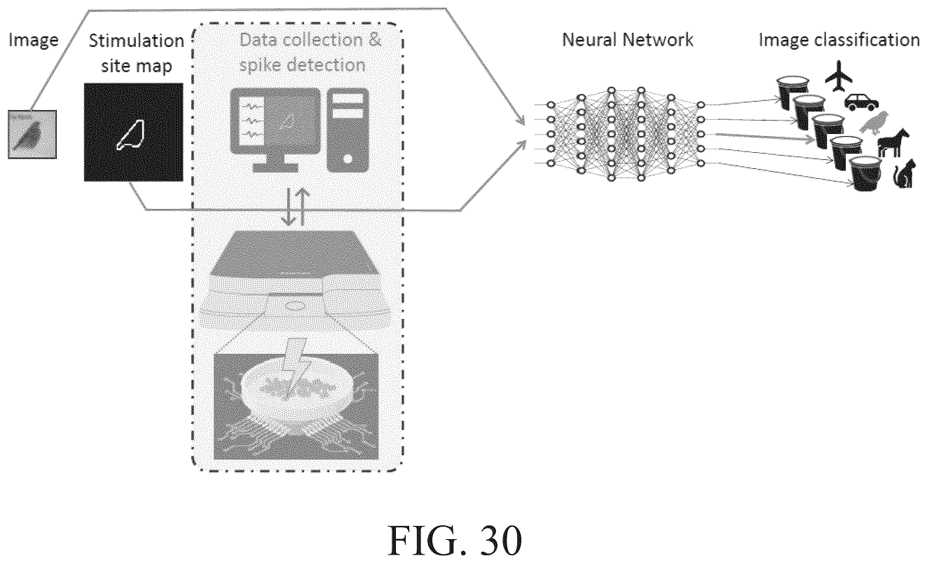

FIG. 30 illustrates a schematic diagram illustrating encoding of visual patterns into stimulation patterns for processing with a biological neural network, according to some embodiments of the technology described herein. FIG. 30 illustrates another example of use of a BANN system to classify images as belonging to one of several object categories. Images from a CIFAR10 data set were processed by the BANN. Here, an ANN is used to process a measured response to stimulation of the BNN. A stimulation pattern for the BNN is generated based on the CIFAR image input. Input to the ANN could either be the original image and/or the cellular (e.g., neuronal) response of the BNN to electrical stimulation in a pattern corresponding to the object's shape.

The process shown in FIG. 30 uses encoding for spike or pattern extraction and combines this data into a novel BANN (biological-artificial neural network) architecture, in an embodiment. Probe stimuli (e.g., the CIFAR image, number 5 MNIST digit) are encoded into the biological network through electrical stimulation (spatially in this case but in other embodiments, the encoding could be performed temporally) on the MEA. Each probe stimulus is followed by cellular (e.g., neuronal) processing which is represented by a broad response across the entire biological network. This is captured by recording electrical activity (μV) from each of the electrodes and is represented in a spike-rate image. Each of these images is then used as an image for training a convolutional neural network (CNN). Parallel to spike-rate images, spike latency and Earth mover's distance values are used as additional ANN input features. Standard ANN classifier training is performed using these multiple biological input types. FIG. 30 depicts an embodiment of an example approach for image processing (MNIST, CIFAR 10, etc.).

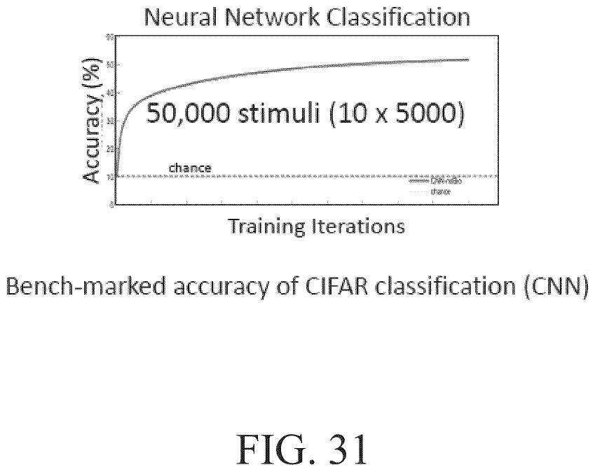

FIG. 31 illustrates a graph showing accuracy of a biological neural network at performing a classification task according to the workflow of FIG. 30, according to some embodiments of the technology described herein. FIG. 31 provides a benchmarking of CIFAR 10 classification accuracy of a standard CNN without use of a BNN.

### V. Use of ANN to Generate BNN Stimulation Patterns

As described herein, the inventors have recognized that ANNs can be improved by combining a BNN with the ANN to form a BANN system. As described herein, while ANNs can be used to process measured BNN responses and/or features derived therefrom, in some embodiments, the ANN of a BANN system may be used for a different purpose, namely to generate stimulation patterns for stimulating the BNN. FIG. 32A illustrates a schematic diagram illustrating an example workflow of an example biological and artificial neural network system, according to some embodiments of the technology described herein.

FIG. 32A is similar to FIG. 7A except that the processor 106 that generates the stimulation pattern 1004 is replaced with an ANN 104A (a processor would generate a stimulating pattern using the ANN 104A, but ANN 104A is shown alone for clarity). Accordingly, some details of the workflow of FIG. 32A may be omitted where such details do not differ from the workflow of FIG. 7A.

As shown in FIG. 32A, an input signal 1002 is provided to an ANN 104A. The input signal may be provided to the BANN system in furtherance of performing a task (e.g., classification, prediction, dimensionality reduction, reinforcement learning, regression, or the like). As described herein, the input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal comprises natural language text, numerals, and/or alphanumeric signals. The input signal is typically provided in digital form to the processor 106. Although a single input signal is shown, it should be understood that in some embodiments, the input signal may comprise multiple input signals. In one example, the workflow shown in FIG. 32A is for performing a classification task of classifying an object in an image. In such an embodiment, the input signal can be an image. Further aspects of the input signal 1002 applicable to the workflow of FIG. 32A are described herein with respect to the workflow in FIG. 7A.

The ANN 104A receives the input signal and generates a stimulation pattern 1004 for stimulating the BNN 102 based on the received input signal 1002. The ANN 104A uses the input signal 1002 to generate a stimulation pattern 1004 for the BNN. Generation of the stimulation pattern may comprise generating a digital signal based on the digital input signal. That is, the input signal is encoded by the ANN 104A to generate at least one stimulation pattern for stimulating the BNN.

As described herein, the stimulation pattern 1004 may comprise a pattern according to which the BNN 102 is stimulated using one or more electrodes of the MEA. That is, the stimulation pattern 1004 provides instructions regarding how stimulation of the BNN 102 with the MEA is to be performed, which may include which electrodes to use to transmit electrical signals to the BNN, a timing of transmitting the electrical signals, and/or a frequency, voltage, and/or current of the electrical signals transmitted to the BNN. In some embodiments, the input signal 1002 may be encoded by the ANN 104A into the stimulation pattern 1004 spatially (e.g., by controlling which electrodes to use to apply electrical signals to the BNN) and/or temporally (e.g., by controlling when particular electrodes apply electrical signals to the BNN).

In some embodiments, such as where the input signal comprises an image, the stimulation pattern comprises a mapping between the input signal and the MEA. For example, the stimulation pattern may be a 1:1, or other suitable ratio other than 1:1 (e.g., greater than, less than), mapping between pixels of the input image to electrodes of the MEA, and the electrical signals transmitted by each electrode may depend on a characteristic of the image at the pixel corresponding to a respective electrode. For example, an intensity or other characteristic of the image at a particular pixel may correspond to a frequency, current, and/or voltage value of an electrical signal applied by the electrode corresponding to that pixel.

Further aspects generating a stimulation pattern for stimulating the BNN based on the input signal applicable to the workflow of FIG. 18A are described herein with respect to the workflow in FIG. 7A. However, in the embodiment of FIG. 32A, the processor which generates the stimulation pattern is an ANN 104A. In some embodiments, the ANN 104A is a convolutional neural network. The ANN 104A may be trained to generate stimulation patterns for the BNN based on one or more input signals. That is, the ANN may be trained with training data that comprises input signals and corresponding stimulation patterns. Training of the ANN using the example stimulation patterns generated based on training input signals may be performed in any suitable way.

The stimulation pattern 1004 is applied to the BNN 102 by transmitting electrical signals to the plurality of cells of the BNN 102 using the MEA and in accordance with the stimulation pattern 1004. A response of the BNN 102 to the stimulation is measured and provided to the processor 106 for processing. As described herein, the measured response may comprise measures of voltages and/or calcium transients in the cellular (e.g., neuronal) response of the BNN to stimulation. In some embodiments, the measured voltages may be input directly to the processor 106. In other embodiments, the measured voltages may additionally or alternatively be processed to obtain an input for the processor 106. For example, processing the measured voltages may comprise deriving one or more features of the cellular (e.g., neuronal) response from the measured voltages, as described herein. The processor 106 processes the measured response 1006 to obtain a task output 1008.

FIG. 32B illustrates a schematic diagram illustrating a feedback loop in the example workflow of FIG. 32A, according to some embodiments of the technology described herein. The schematic diagram of FIG. 32B shows that in some embodiments, the output of the processor 106 may be fed back into the BANN system as an input signal. Therefore, in some embodiments, the BANN system can be implemented with a feedback loop.

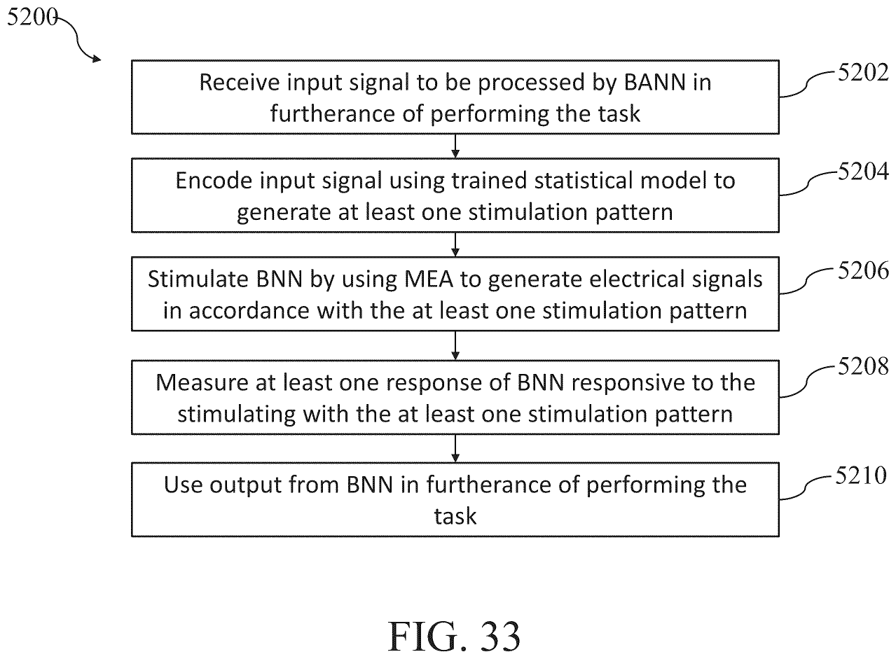

FIG. 33 illustrates an example method 5200 for performing a task using a biological and artificial neural network system, according to some embodiments of the technology described herein. The method 5200 may be performed using a BANN system comprising an MEA, a BNN comprising a plurality of cells (e.g., neurons) arranged on the MEA, a trained statistical model, and at least one processor.

The method 5200 may proceed according to the workflow described herein with respect to FIG. 32A. For example, the method 5200 may begin at act 5202, where an input signal to be processed by the BANN in furtherance of performing the task is received. As described herein, the task to be performed may be one or more of a number of tasks (e.g., classification, prediction, dimensionality reduction, reinforcement learning, regression, or the like). Further aspects of performing a task applicable to the method of FIG. 33 are described herein, for example, with respect to the workflow in FIG. 7A.

As described herein, the input signal is a signal that is to be processed by the BNN in furtherance of performing a task. The input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal comprises natural language text, numerals, and/or alphanumeric signals. The input signal is typically provided in digital form to the processor 106. Although a single input signal is shown, it should be understood that in some embodiments, the input signal may comprise multiple input signals. In some embodiments, the input signal may be one or more of a number of different types of input signals. Further aspects of receiving the input signal applicable to the method of FIG. 33 are described herein, for example, with respect to the workflow in FIG. 7A.

At act 5204, the input signal is encoded to the generate at least one stimulation pattern. In the example method 5200, the encoding is performed by a trained statistical model. Generation of the stimulation pattern may comprise generating a digital signal based on the digital input signal. That is, the input signal is encoded, using the ANN, to generate at least one stimulation pattern for stimulating the BNN. In some embodiments, as described herein, generation of the at least one stimulation pattern may be performed by processing the input signal 1002 with the trained statistical model, such as an ANN (e.g., a convolutional ANN).

The stimulation pattern may comprise a pattern according to which the BNN is stimulated using one or more electrodes of the MEA. That is, the stimulation pattern provides instructions regarding how stimulation of the BNN with the MEA is to be performed, which may include which electrodes to use to transmit electrical signals to the BNN, a timing of transmitting the electrical signals, and/or a frequency, voltage, and/or current of the electrical signals transmitted to the BNN. In some embodiments, the input signal may be encoded by the ANN into the stimulation pattern 1004 spatially (e.g., by controlling which electrodes to use to transmit electrical signals to the BNN) and/or temporally (e.g., by controlling when particular electrodes transmit electrical signals to the BNN).

In some embodiments, such as where the input signal comprises an image, the stimulation pattern comprises a mapping between the input signal and the MEA. For example, the stimulation pattern may be a 1:1, or other suitable ratio other than 1:1 (e.g., greater than, less than), mapping between pixels of the input image to electrodes of the MEA, and the electrical signals transmitted by each electrode may depend on a characteristic of the image at the pixel corresponding to a respective electrode. For example, an intensity or other characteristic of the image at a particular pixel may correspond to a frequency, current, and/or voltage value of an electrical signal applied by the electrode corresponding to that pixel.

For example, at act 5204, the trained statistical model may process the input signal to generate the stimulation pattern for stimulating the BNN. In some embodiments, the trained statistical model comprises an ANN, and encoding the input signal comprises encoding the input signal using the ANN to generate the stimulation pattern for the BNN. In some embodiments, the ANN comprises one or more convolutional layers (e.g., as part of a convolutional neural network).

In some embodiments, as described herein, encoding the input signal using a trained statistical model to generate the at least one stimulation pattern comprises transforming the input signal into a set of input signals, each of the input signals in the set of input signals being derived from the input signal and the stimulation pattern comprises a respective stimulation pattern for each of the input signals in the set of input signals. In some embodiments, the input signal comprises an image and the set of input signals comprises a set of images. In some embodiments, the input signal comprises a two-dimensional image, the trained statistical model comprises a plurality of convolutional kernels, and the set of images comprise images generated by respective ones of the plurality of convolutional kernels of the convolutional neural network. In some embodiments, each respective input signal of the input signals in the set of input signals is derived using a respective convolutional kernel of the ANN.

In some embodiments, the trained statistical model comprises an artificial neural network (ANN) which may comprise one or more convolutional layers (e.g., may be a convolutional neural network (CNN)) and encoding the input signal using the trained statistical model comprises: processing the input signal using at least one convolutional layer to obtain first images; binarizing the first images to obtain binarized images; inflating the binarized images to obtain inflated images; padding the inflated images to obtain a set of padded images; and organizing the set of padded images into a set of images to form the at least one stimulation pattern. Further aspects of encoding the input signal by generating a stimulation pattern application to the method of FIG. 33 are described herein, for example, with respect to the workflow in FIG. 7A.

At act 5206, the BNN is stimulated by using the MEA to generate electrical signals in accordance with the at least one stimulation pattern. For example, applying the stimulation pattern to the BNN may comprise operating one or more electrodes of the MEA to apply electrical signals to the plurality of cells of the BNN in accordance with the stimulation pattern (e.g., according to the timing, location, and characteristics of the electrical signals defined by the stimulation pattern). The stimulation pattern output by the ANN may be a digital signal that is converted to an analog signal when the stimulation is applied to the BNN. The process of receiving the input signal, generating the stimulation pattern based on the input signal, and stimulating the BNN, in accordance with the stimulation pattern may be referred to as encoding the input signal into the BNN. Further aspects of stimulating the BNN in accordance with the at least one stimulation pattern applicable to the method of FIG. 33 are described herein, for example, with respect to the workflow in FIG. 7A.

In response to the application of the stimulation pattern, the cells (e.g., neurons, astrocytes, and/or microglia) may process and respond to the stimulus. The processing of the cells may be measured and used in furtherance of performing a task at acts 5208-5210, as described herein.

At act 5208, a response of the BNN responsive to the stimulating with the at least one stimulation pattern performed at act 5206 is measured. Further aspects of measuring a response of the BNN applicable to the method of FIG. 33 are described herein, for example, with respect to the workflow in FIG. 7A.

At act 5210, the measured at least one response from the BNN is used in furtherance of performing the task. For example, the at least one response of the BNN may be a response to the task (e.g., a classification of an image, for example). For example, where the task is a classification task, the input signal comprises an image, the task output comprises an indication of a category to which the object represented in the image belongs. In some embodiments, the at least one response from the BNN is processed (e.g., using at least one processor, trained statistical model, and/or ANN to generate the task output based on the at least one response of the BNN). Processing the measured response may include deriving one or more features, examples of which are described herein, from the measured response and processing the derived one or more features in furtherance of performing a task. Further aspects of using the measured at least one response from the BNN in furtherance of performing a task applicable to the method of FIG. 33 are described herein, for example, with respect to the workflow in FIG. 7A.

Examples are further provided herein of using a BANN system, wherein an ANN is provided to generate a stimulation pattern for stimulating the BNN based on the input signal.

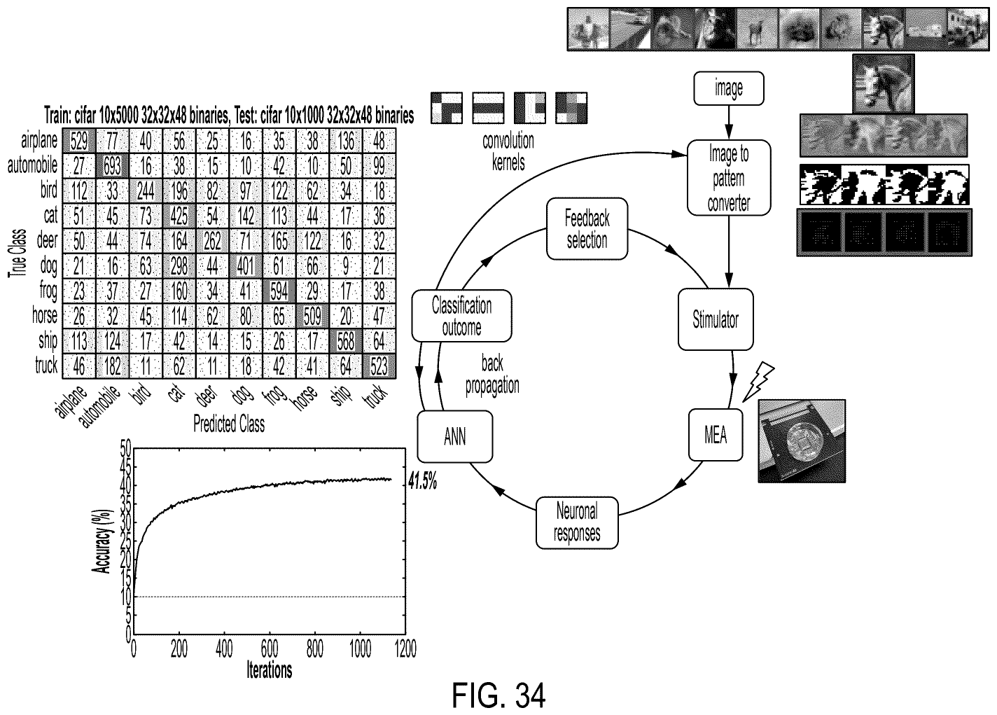

FIG. 34 illustrates an architecture of a biological and artificial neural network system, where an artificial neural network is used to determine a stimulation pattern for the biological neural network, according to some embodiments of the technology described herein. In particular, FIG. 34 depicts an embodiment of a BANN network architecture where the ANN is first used to define data encoded into a BNN, which is then used for high-dimensional data representation. This is followed by an ANN, specifically a CNN for image classification and further training within a closed-loop BANN system. As such, FIG. 34 illustrates a classification before and after closed-loop training. In the illustrated embodiment of FIG. 34, object images were used to train ANNs to classify images. Deriver kernels (outer loop) were then utilized in converting pictures to patterns of stimulation. Cellular (e.g., neuronal) responses to these stimulation patterns are then classified and can be used to provide closed-loop feedback in the form of stimulation (inner loop) (e.g., electrical, chemical, and/or optical stimulation).

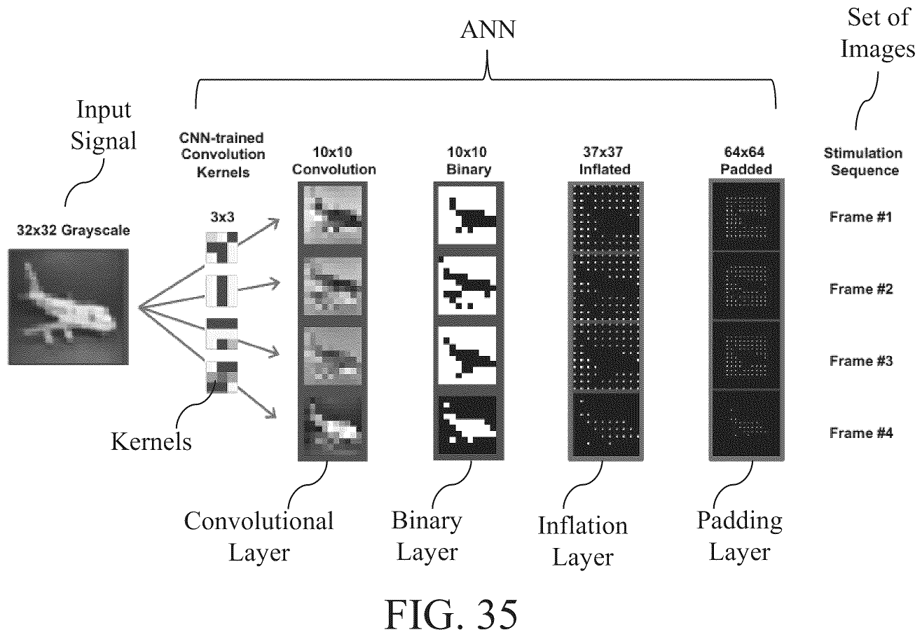

FIG. 35 illustrates an example workflow for tokenizing images into stimulation patterns using an artificial neural network, according to some embodiments of the technology described herein. In particular, FIG. 35 relates to an implementation of the BANN which uses an ANN to generate the stimulation pattern for the BNN.

As shown in FIG. 35, an input signal is received. In this example, the input is an image from a CIFAR-10 dataset having been converted to grayscale. The image is input to the ANN to transform the image into one or more stimulation patterns for stimulating the BNN. In the illustrated example of FIG. 35, real-world images from the CIFAR-10 data set, which includes images belonging to different categories such as planes, cards, birds, and animals, are converted into spatial and temporal stimulation patterns. The ANN identifies image features such as scale and contrast, which are then encoded into the BNN through spatial and temporal stimulation. The decoding of the BNN response to the stimulation pattern generated using the ANN may be by a sequence of frames of spike rate (e.g., movies of rates).

FIG. 35 illustrates that the ANN may transform the input image into a set (e.g., sequence) of images (e.g., tokens) which each correspond to a stimulation pattern. To perform stimulation, each stimulation pattern of the set of images may be applied in sequence. The output of the ANN therefore is a set of frames, which may be binary versions of each image specifying a stimulation pattern on an MEA.

The ANN of the example shown in FIG. 35 may be trained to extract image features to form the set of images which comprise a sequence of discrete stimulation patterns. The input signal in the example of FIG. 35, which is a grayscale image, is processed with the ANN to obtain the set of input signals for the BNN. The set of input signals comprise a set of stimulation patterns, each stimulation pattern being derived from the input image. The stimulation of the BNN is then performed based on the set of images by stimulating the BNN with each stimulation pattern in the set of stimulation patterns one at a time, with gaps (e.g., 100 ms) between each stimulation. This technique may be advantageous where stimulation is performed with fewer electrodes than the number of pixels in the input image.

FIG. 35 illustrates an example architecture of an ANN that may be used to generate a stimulation pattern for the BNN. In the illustrated embodiment of FIG. 35, the ANN comprises a convolutional neural network (CNN). The CNN comprises convolution kernels and multiple layers following the convolution kernels, including convolutional layers, binary layers, inflation layers, and padding layers. The CNN may be trained on the CIFAR dataset. For example, a part of the CIFAR dataset may be withheld for training while the remainder of the CIFAR dataset is used for validation and/or testing.

The technique reflected in FIG. 35 may be performed in other ways, in some embodiments. For example, in some embodiments, another technique such as wavelet decomposition, a short-time Fourier transform, a time-frequency decomposition, a time-scale decomposition or any other suitable transformation may be used in place of the ANN to generate the stimulation patterns. In both techniques, the technique involves breaking down an input image into multiple components with the components being used to generate a temporal sequence of stimulation patterns. In other words, the image is transformed into a set (e.g., temporal sequence) of images, each of which represents a different aspect of the input image.

In one example, the ANN of FIG. 35 has the following example architecture. In particular, in one example, stimuli for stimulation of the MEA (e.g., electrical, chemical, and/or optical stimulation) is generated by an ANN that is a convolutional neural network (CNN). The example CNN, referred to as CNN-step, replaces the standard relu layer with a step function, which creates a binary version of the convolved images. The example CNN includes the following layers: image input layer (32×32), 2D convolution layer (4 kernels of dimension 5×5, stride of 3, no padding), batch normalization layer, step function layer (binarization step in place of relu), fully connected layer, SoftMax layer, and a classification layer.

The example CNN was trained on 50,000 grayscale versions of images in the CIFAR-10 database (real world objects from 10 categories with pixel dimensions 32×32). The four trained kernels were then extracted and used to convert an independent set of 10,000 CIFAR images into four binary patterns of dimension 10×10. Each of the 40,000 binary patterns was then enlarged 5-fold by adding intermediate zeros to get a 46×46 binary image and zero-padding to make a final binary image of dimension 64×64. This pattern was then used to stimulate the MEA with values of 1 in the binary pattern corresponding to the corresponding electrode in the 64×64 array (or in some cases, a neuronally active electrode in close proximity). The four stimulation patterns that encoded each picture image were delivered in succession and neuronal responses were recorded.

Firing rate responses of the MEA (typically from 15-45 ms after stimulation) to the four stimulation patterns were recorded and used for classification. Classification was performed with a multi-channel CNN (referred to as CNN-stack), with a standard rectified linear unit (ReLU) layer (layer structure otherwise as for the CNN-step). The dimensions of the input layer were 64×64×4 (i.e. the dimensions of the electrode array x four sets of responses to the four stimulation patterns), for a total of 16,384 inputs per image. Classification accuracy into the appropriate CIFAR category was used to assess performance.

Experiments typically involved 700 images from four categories, each being delivered as four distinct stimulation patterns. Larger stimulus sets of 4,000 (four categories) or 10,000 (10 categories) were also employed. The number of trained kernels used to generate the stimulation patterns varied from 1-48, and 3, 4, or 12 patterns per image were used to stimulate the MEA.

The learning rate for the example CNN-step function described herein was typically 0.001, but sometimes lower (0.0025-0.0001) to ensure smoothly increasing learning curves. Learning rate for the CNN-Stack function was usually 0.001. The batch size for both CNN architectures was typically 512 or 1024.

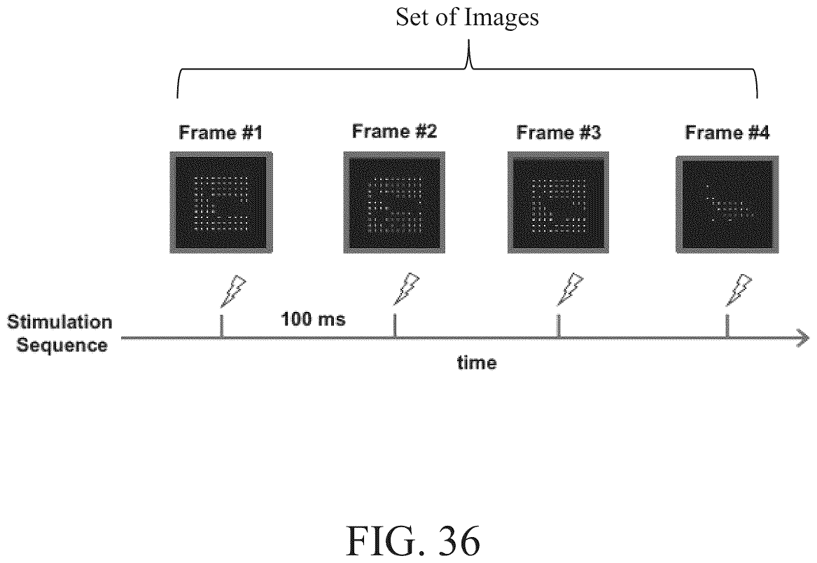

FIG. 36 illustrates an example of applying a set of images in the form of a stimulation pattern to a biological neural network, according to some embodiments of the technology described herein. As described herein, the set of images generated by processing the input image with the ANN may be used to stimulate the BNN by applying each stimulation pattern in a sequence, as shown schematically in FIG. 36. Each discrete representation of the original image is used to stimulate a different pattern of electrodes. Neuronal responses to each of the four patterns (movie frames) are concatenated into a 3D “stack” (64×64×4 frames) and analyzed with a multi-channel CNN.

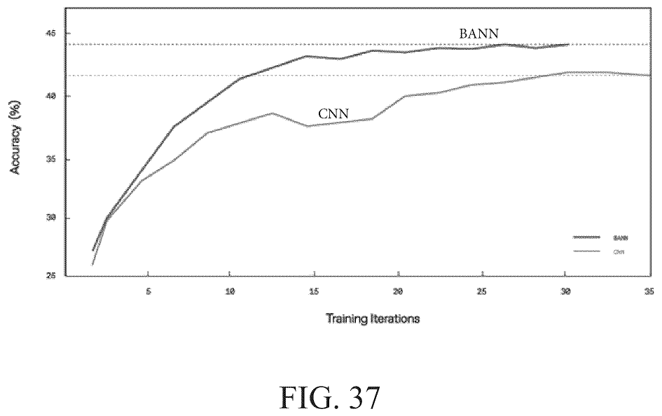

FIG. 37 illustrates a graph illustrating classification accuracy of a biological neural network which receives stimulation patterns generated by an ANN, according to some embodiments of the technology described herein. As seen in the results shown in FIG. 37, a CNN trained on neuronal responses (both spatial and temporal) to CIFAR images showed improved classification with less training time and computational resources compared to a CNN trained on baseline images. Accordingly, for a set training time, the BANN systems performs with greater accuracy than a conventional ANN. Similarly, the BANN system, reaches a set accuracy more quickly than a conventional ANN. That is, the BANN system performed at a higher accuracy and reached a steady state faster than an ANN performing the same task. At steady state, the BANN system is 40% more accurate than the CNN, relative to a baseline. In this example, the CNN was trained on 50,000 sequences of images (movies).

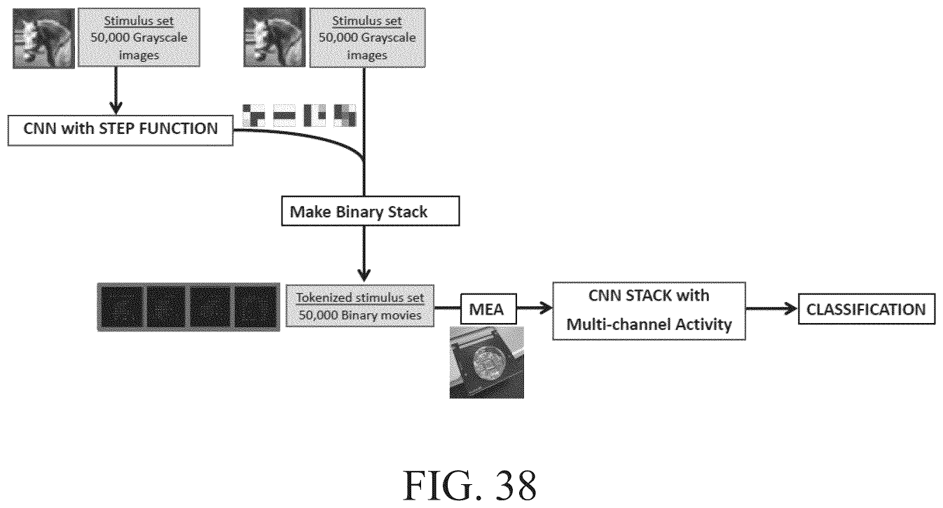

FIG. 38 illustrates another schematic diagram of a workflow for generating a stimulation pattern for a biological neural network, according to some embodiments of the technology described herein. A large collection of real world objects was used to define the kernels that were then used to discretize an image into a small number of binary stimulation patterns. Neuronal responses to each of these binary stimulation patterns were then combined into a spatio-temporal sequence and categorized using a CNN.

### VI. Combination of BNN with Multiple ANNs

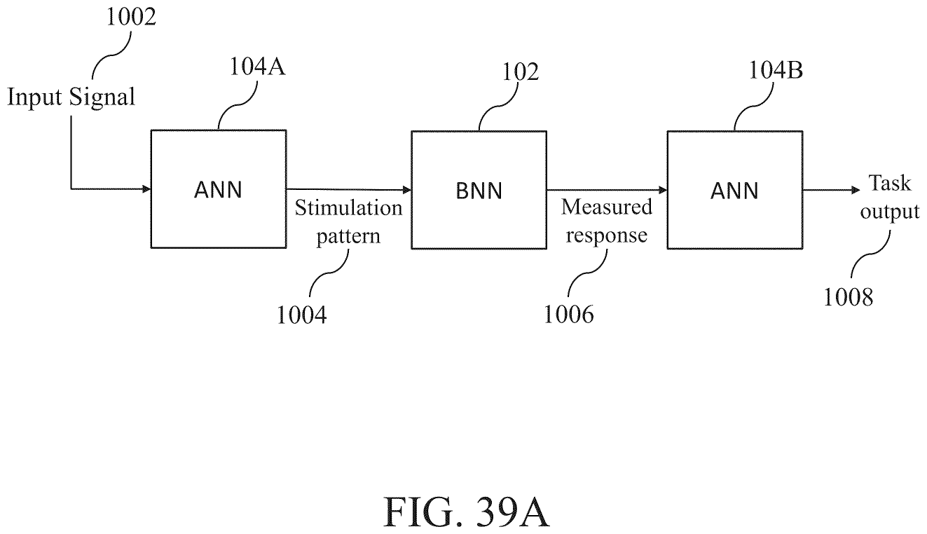

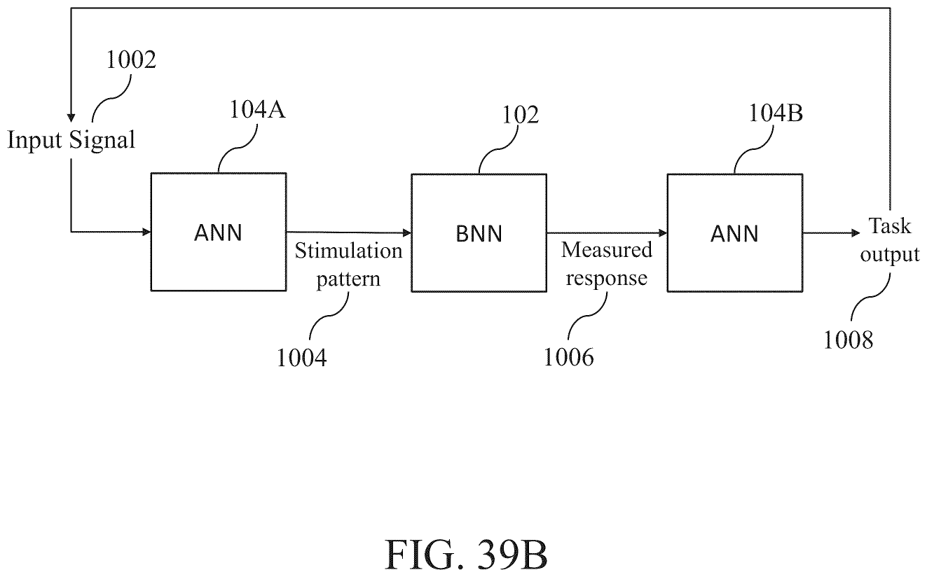

As described herein, the inventors have recognized that ANNs can be improved by combining a BNN with the ANN to form a BANN system. In some embodiments, the ANN is used to generate stimulation patterns for stimulating the BNN and a second ANN is used to process the response of the BNN. FIG. 39A illustrates a schematic diagram illustrating an example workflow of an example biological and artificial neural network system, according to some embodiments of the technology described herein.

FIG. 39A is similar to FIG. 7A except that the processor 106 that generates the stimulation pattern 1004 is replaced with a first ANN 104A and the processor 106 that processes the measured response 1006 of the BNN 102 is replaced with a second ANN 104B. In this way, the workflow of FIG. 39A is a combination of the workflows of FIGS. 18A and 32A. Accordingly, some details of the workflow of FIG. 39A may be omitted where such details do not differ from the workflow of FIG. 7A, FIG. 18A, or FIG. 32A.

As shown in FIG. 39A, an input signal 1002 is provided to an ANN 104A. As described herein, the input signal may be one of any number of signals (e.g., one-dimensional, two-dimensional, three-dimensional, or four-dimensional data). In some embodiments, the input signal comprises multiple input signals. In one example, the workflow shown in FIG. 39A is for performing a classification task of classifying an object in an image. In such an embodiment, the input signal can be an image.

The ANN 104A receives the input signal and generates a stimulation pattern 1004 for stimulating the BNN 102 based on the received input signal 1002. In some embodiments, the ANN 104A is a convolutional neural network.

The ANN 104B may be trained generate stimulation patterns for the BNN based on one or more input signals. That is, the ANN may be trained with training data that comprises input signals and corresponding stimulation patterns. Training of the ANN using the example stimulation patterns generated based on training input signals may be performed in any suitable way.

The stimulation pattern 1004 is applied to the BNN 102 by transmitting electrical signals to the plurality of cells of the BNN 102 using the MEA and in accordance with the stimulation pattern 1004. A response of the BNN 102 to the stimulation is measured and provided to the ANN 104B for processing. As described herein, the measured response may comprise measures of voltages and/or calcium transients in the cellular (e.g., neuronal) response of the BNN to stimulation. In some embodiments, the measured voltages may be input directly to the ANN 104B. In other embodiments, the measured voltages may additionally or alternatively be processed to obtain an input for the ANN 104B. For example, processing the measured voltages may comprise deriving one or more features of the neuronal response from the measured voltages, as described herein. The ANN 104B processes the measured response 1006 to obtain a task output 1008.

FIG. 39B illustrates a schematic diagram illustrating a feedback loop in the example workflow of FIG. 39A, according to some embodiments of the technology described herein. The schematic diagram of FIG. 39B represents that in some embodiments, the output of the ANN 104B may be fed back into the BANN system as an input signal. Therefore, in some embodiments, the BANN system can be implemented with a feedback loop.

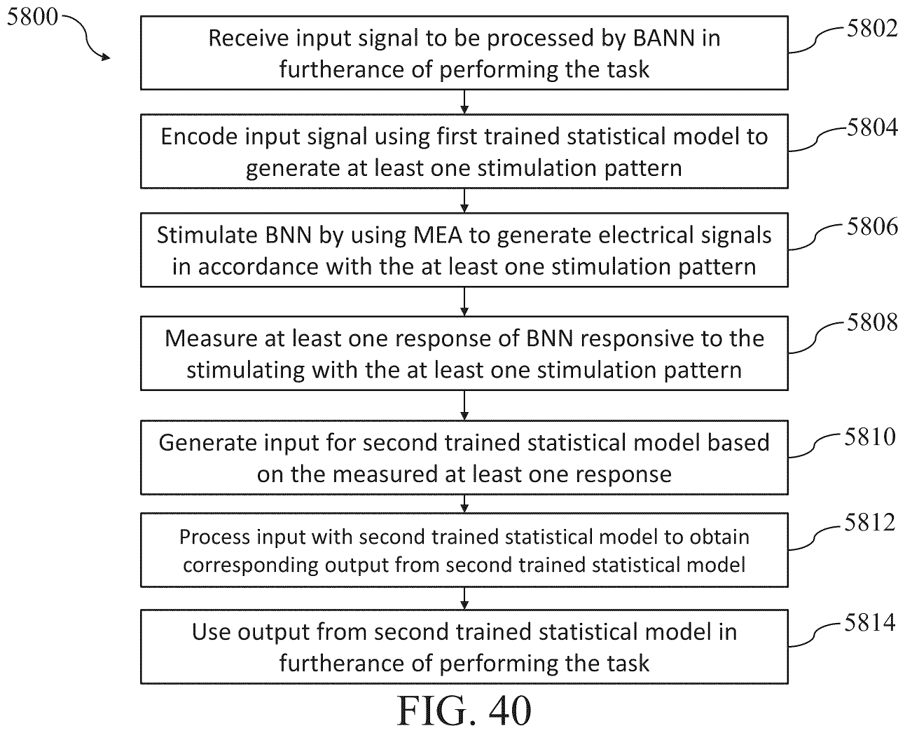

As described herein, the combination of ANNs with BNNs can be implemented in any suitable manner. For example, an ANN may be used to generate a stimulation pattern for a BNN. In some embodiments, an ANN may be used to process a measured response of the BNN to application of a stimulation pattern. In some embodiments, one or more ANNs may be used both to generate a stimulation pattern for the BNN based on one or more input signals and process a measured response of the BNN to stimulation of the BNN by the stimulation pattern. FIG. 40 illustrates an example method 5800 for performing a task using a combination BANN system.

The method 5800 may be performed using a BANN system comprising an MEA, a BNN comprising a plurality of cells (e.g., neurons) arranged on the MEA, first and second trained statistical models, the second trained statistical model being trained using inputs generated using responses of the BNN to training data inputs, and at least one processor. It should be appreciated the example method 5800 is just one example method that can be performed with a combination BANN system, and the other configurations of the BANN system and methods performed using the BANN system are possible.

The method 5800 may proceed according to the workflow described herein with respect to FIG. 39A. For example, the method 5800 may begin at act 5802, where an input signal to be processed by the BANN in furtherance of performing the task is received. As described herein, the task to be performed may be one or more of a number of tasks (e.g., classification, prediction, dimensionality reduction, reinforcement learning, regression, or the like). Further aspects of performing a task applicable to the method of FIG. 40 are described herein, for example, with respect to the workflow in FIG. 7A.

As described herein, the input signal is a signal that is to be processed by the BNN in furtherance of performing a task. The input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal comprises natural language text, numerals, and/or alphanumeric signals. The input signal is typically provided in digital form to the ANN. Although a single input signal is shown, it should be understood that in some embodiments, the input signal may comprise multiple input signals. Further aspects of receiving an input signal applicable to the method of FIG. 40 are described herein, for example, with respect to the workflow in FIG. 7A.

At act 5804, the input signal is encoded to generate at least one stimulation pattern. As described herein, generation of the stimulation pattern may comprise generating a digital signal based on the digital input signal. That is, the input signal is encoded by the ANN to generate at least one stimulation pattern for stimulating the BNN. In some embodiments, as described herein, generation of the at least one stimulation pattern may be performed by processing the input signal 1002 with a trained statistical model, such as an ANN (e.g., a convolutional ANN).

The stimulation pattern may comprise a pattern according to which the BNN is stimulated using one or more electrodes of the MEA. That is, the stimulation pattern provides instructions regarding how stimulation of the BNN with the MEA is to be performed, which may include which electrodes to use to transmit electrical signals to the BNN, a timing of transmitting the electrical signals, and/or a frequency, voltage, and/or current of the electrical signals transmitted to the BNN. In some embodiments, the input signal may be encoded by the ANN into the stimulation pattern spatially (e.g., by controlling which electrodes to use to transmit electrical signals to the BNN) and/or temporally (e.g., by controlling when particular electrodes transmit electrical signals to the BNN).

In some embodiments, such as where the input signal comprises an image, the stimulation pattern comprises a mapping between the input signal and the MEA. For example, the stimulation pattern may be a 1:1, or other suitable ratio other than 1:1 (e.g., greater than, less than), mapping between pixels of the input image to electrodes of the MEA, and the electrical signals transmitted by each electrode may depend on a characteristic of the image at the pixel corresponding to a respective electrode. For example, an intensity or other characteristic of the image at a particular pixel may correspond to a frequency, current, and/or voltage value of an electrical signal applied by the electrode corresponding to that pixel.

As described herein, the encoding may be performed by a trained statistical model, and the encoding of the input signal to generate the at least one stimulation pattern may be performed by processing the input signal with the trained statistical model. In some embodiments, the trained statistical model comprises an ANN, and the encoding of the input signal to generate the at least one stimulation pattern may be performed by processing the input signal with the ANN. Further aspects of encoding an input signal by generating a stimulation pattern applicable to the method of FIG. 40 are described herein, for example, with respect to the workflow in FIG. 7A.

At act 5806, the BNN is stimulated by using the MEA to generate electrical signals in accordance with the at least one stimulation pattern. Applying the stimulation pattern to the BNN may comprise operating one or more electrodes of the MEA to apply electrical signals to the plurality of cells of the BNN in accordance with the stimulation pattern (e.g., according to the timing, location, and characteristics of the electrical signals defined by the stimulation pattern). The stimulation pattern may be a digital signal that is converted to an analog signal when the stimulation is applied to the BNN. The process of receiving the input signal, generating the stimulation pattern based on the input signal, and stimulating the BNN in accordance with the stimulation pattern may be referred to as encoding the input signal into the BNN. Further aspects of stimulating the BNN applicable to the method of FIG. 40 are described herein, for example, with respect to the workflow in FIG. 7A.

At act 5808, a response of the BNN responsive to the stimulating with the at least one stimulation pattern performed at act 5806 is measured. Specifically, the cells output electrical signals, called extracellular membrane potentials (measured in voltage), which can be recorded by one or more electrodes of the MEA as voltage values. The one or more electrodes of the MEA which record the response the response of the BNN to the stimulation may be different, the same, or partially the same as the electrodes which perform the stimulation. BNN activity can also be measured by visualizing Calcium (Ca2+) transients. A processor measures the response of the BNN to the stimulation to obtain a measured response. The measured response may comprise one or more measurements, such as one or more voltage measurements and/or calcium transient measurements, of the electrical signals generated by the BNN in response to the stimulation. Further aspects of measuring a response of the BNN applicable to the method of FIG. 40 are described herein, for example, with respect to the workflow in FIG. 7A.

At act 5810, an input for a trained statistical model is generated based on the measured at least one response of the BNN at act 5808. In some embodiments, generating the input for the trained statistical model comprises processing the input, such as by deriving one or more features from the measured response, examples of which are described herein. In other embodiments, generating the input for the trained statistical model comprises passing the measured response to the trained statistical model as input without processing the measured response. Further aspects of generating an input for the trained statistical model applicable to the method of FIG. 40 are described herein, for example, with respect to the workflow in FIG. 7A.

At act 5812, the input generated at act 5810 is processed with the trained statistical model to obtain corresponding output from the trained statistical model. As described herein, the trained statistical model may be an ANN in some embodiments such that the processing at act 5812 is performed by processing the input with the ANN. For example, where the trained statistical model comprises an ANN, the ANN may be a neural network having one or more convolutional layers or a neural network having a transformer architecture. In some embodiments, where the trained statistical model is an ANN, the ANN may be a convolutional neural network. In other embodiments, the trained statistical model is a trained statistical model other than an ANN. Further aspects of processing an input with a trained statistical model applicable to the method of FIG. 40 are described herein, for example, with respect to the workflow in FIG. 7A.

At act 5814, the output from the trained statistical model may be used in furtherance of performing the task. In some embodiments, the output from the trained statistical model is a response to the task (e.g., a classification of an image, for example). For example, where the task is a classification task, the input signal comprises an image, the task output comprises an indication of a category to which the object represented in the image belongs. Further aspects of using an output of the trained statistical model in furtherance of performing a task applicable to the method of FIG. 40 are described herein, for example, with respect to the workflow in FIG. 7A.

Regarding data flow, the types of ANN, potential configurations and sequence of operations within this innovative network architecture are limitless. The described 2-layer BANN exemplifies one possible data flow structure. In another configuration, an ANN is first used to define data encoded into a BNN, which is then used for high-dimensional data representation. This is followed by an ANN, specifically a CNN for image classification and further training within a closed-loop BANN system.

In the provided example, a CNN facilitates the encoding of images into a BNN. For instance, each input stimulus, such as an image from the CIFAR 10 dataset, is transformed into one or more commands dictating simultaneous stimulation (e.g., electrical stimulation) of specific electrodes on a MEA. This process involves utilizing the attributes of a pretrained ANN (e.g., convolutional kernels, weights of hidden layers) to alter the conversion of stimuli into stimulation patterns for the MEA. Consequently, the CNN guides the encoding process onto the electrode array. Subsequently, the spatiotemporal cellular (e.g., neuronal) response induced by this stimulation pattern, as predetermined by the ANN, is input into an ANN trained to categorize this neuronal representation into one of multiple classes, defined by another, distinct ANN. The sequence of data flow operations in this scenario follows an ANN--BNN--ANN pattern. Thus, the artificial classifier not only interprets the output from the neuronal culture but also shapes how input stimuli are transformed into a sequence of stimulation patterns.

### VII. Techniques for Processing Neuronal Responses

As described herein, in some embodiments, a BANN system may comprise an ANN that processes the response of the BNN to stimulation. According to some aspects, provide for techniques which utilize an ANN to process multiple features derived from a response of a BANN in furtherance of performing a task. ANNs which perform such techniques are further described herein.

FIG. 41 illustrates a schematic diagram illustrating a workflow for processing a response of a biological neural network to a stimulation pattern with an artificial neural network, according to some embodiments of the technology described herein. According to some aspects, the inventors have developed techniques for processing an output of a BNN. That is, the inventors have developed techniques which use an ANN to process a measured response of a BNN to stimulation according to a stimulation pattern in furtherance of performing a task. Instead of processing raw electrical measurements obtained from the MEA, the workflow shown in FIG. 41 includes processing the raw electrical measurements to derive one or more features of the BNN response to the stimulation. Such derived features are input to the ANN and processed for subsequent computation. As shown in FIG. 41, the workflow for the technique described herein includes processing multiple features of a measured response 1006 of the BNN to a stimulation pattern.

The illustrated embodiment of FIG. 41 schematically illustrates three features, features 1-3, derived from the measured response 1006 by a feature extraction component (e.g., a processor) and input to the ANN 5904. In other embodiments, the multiple features extracted from the measured response may consist of two features, four features, five features, or more than five features, as aspects of the technology described herein are not limited in this respect. The multiple features derived from the measured response may comprise any of the features that can be derived from a response of the BNN described herein, including, for example, spike rate, latency, average latency, Earth mover's distance, and/or a sequence of frames of the cellular (e.g., neuronal) response (e.g., a movie).

As described herein, spike rate may be defined as the number of voltage spikes (e.g., voltage measurement above a specified threshold) in a set time window. The spike rate may be measured across all electrodes. In some embodiments, the window of time used to measure the spike rate is 5-30 ms post stimulation of the BNN.

As described herein, latency may be defined as the amount of time between stimulation and the first spike measurement. Latency may be measured at some or all electrodes. While spike rate may be a discrete measurement (representing a count), latency is may be a continuous measurement. Latency may be measured with nanosecond precision.

As described herein, average latency may be defined as the average timing of spikes at a single electrode. As described herein, a video may be defined as a sequence of frames of a response pattern (e.g., multiple images in a sequence illustrating cellular (e.g., neuronal) response during windows of time in the form of spikes). As described herein, Earth mover's distance may be defined as the temporal distance between spikes in a signal measured by an electrode. EMD represents the “cost” of moving between different stimulations. EMD may be an analog value.

As shown in FIG. 41, a stimulation pattern 1004 is applied to the BNN 102. For example, application of the stimulation pattern 1004 to the BNN 102 may be performed using one or more electrodes of the MEA to transmit one or more electrical signals to the BNN 102 in accordance with the stimulation pattern. The BNN 102 responds to the application of the stimulation pattern in a manner which can be measured by one or more electrodes of the MEA. Accordingly, a measured response 1006 of the BNN response to the stimulation in accordance with the stimulation pattern 1004 can be obtained. Application of the stimulation pattern 1004 to the BNN 102 and obtaining a measured response 1006 of the BNN to the stimulation may be performed in the same manner as described herein, for example, with respect to the workflow of FIG. 7A. Accordingly some aspects of the workflow shown in FIG. 41 are omitted herein.

As described herein, the measured response 1006 of the BNN 102 to the stimulation may comprise one or more measurements of voltage and/or calcium transients. As is further described herein, one or more features can be derived from the measured response, including spike count, spike rate, latency, Earth mover's distance, one or more sequences of frames from the BNN response (e.g., images of spike activity), an indication of which neurons respond to the stimulation, and the like. Such one or more features can be derived from the measured response 1006, as illustrated in FIG. 41. For example, in some embodiments, processor 106 may process the measured response to derive the one or more features from (e.g., by performing calculations on) the measured response. In the illustrated embodiment of FIG. 41, multiple features are derived from the measured response 1006.

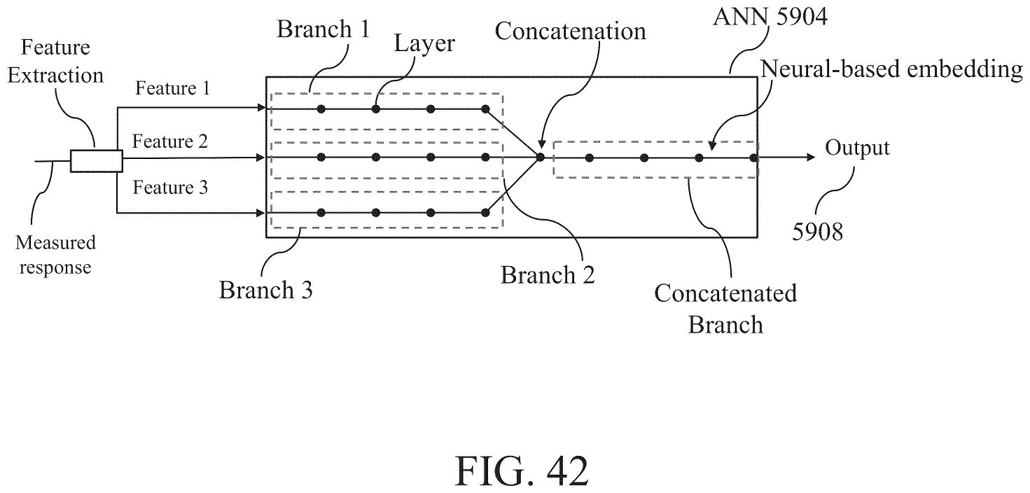

As shown in FIG. 41 the multiple features derived from the measured response 1006 are then provided as input to the ANN 5904. The ANN processes the multiple features to obtain a corresponding output 5908. In some embodiments, the output 5908 may be a response to a task, an embedding to be used in further processing, or another output. For example, in some embodiments, as described herein, the output may be an embedding for an input token, which may be termed a “neural” embedding given the use of a BNN in its generation. The processing of the multiple features (features 1-3 in the illustrated embodiment of FIG. 41) with the ANN 5904 is further described herein, for example, with respect to FIG. 42.

FIG. 42 illustrates additional aspects of the schematic diagram of FIG. 41, according to some embodiments of the technology described herein. FIG. 42 illustrates additional details of the ANN 104 shown in FIG. 41, which processes multiple features derived from the measured response of the BNN to stimulation with a stimulation pattern.

As shown in FIG. 42, the ANN comprises multiple branches (branches 1-3 in the illustrated embodiment of FIG. 42). Each branch receives an input of one feature of the multiple features derived from the measured response by the feature extraction component. Accordingly, the ANN 104 comprises a respective branch for each feature derived from the measured response that is input to the ANN 104. Each branch comprises multiple layers, examples of which are described further herein. The processing of the multiple features with the ANN 5904 initially occurs at a first portion of the ANN 5904 by processing each feature through its respective branch individually, before outputs of each respective branch are concatenated together at a concatenation node to form a concatenated input to a second portion of the ANN 5904.

As shown in FIG. 42, the branches 1-3 are concatenated at a concatenation node. Subsequent to the concatenation, further processing of the concatenated input is performed through the concatenated branch. The concatenated branch comprises multiple layers, examples of which are described further herein. The output 5908 is output from the concatenated branch of the ANN. Thus, in this example, each of the three branches and the concatenated branch comprise respect neural network layers for processing various measured-response derived features independently (in the separate branches) and jointly (in the concatenated branch).

In some embodiments, an output of one of the layers of the concatenated branch may be considered to be a neural-based embedding of “a token”—the token being represented by a stimulation pattern 1004 that is provided as input to BNN 102 whose measured response is used to obtain features provided as input to the ANN 5904. The neural-based embedding may be a numeric vector and be a numeric representation of the token. The dimensions of the numeric vector may be adjusted as desired, in some embodiments. In some embodiments, the neural-based embedding may be the output 5908 of the ANN 5904 and this embedding may be used in subsequent processing. For example, in some embodiments, the ANN 5904 may be used to create a dictionary of neural-based embeddings for a corpus of tokens (e.g., a corpus of words). In some embodiments, the neural-based embedding may be used together with a second ANN, such as a large language model. For example, when an input is provided to a second ANN for performance of a task, the second ANN may use the neural-based embedding corresponding to the input to perform computation in furtherance of performing the task. An example input is text comprising one or more words and an example second ANN is a large language model tasked to generate a response to the input text. Further description of this example is provided herein.

In other embodiments, the neural-based embedding generated by the ANN 5904 may be used in furtherance of performing a task by the ANN 5904. For example, the neural-based embedding may be generated by a layer prior to the final layer of the concatenated branch of the ANN 5904. Subsequent layers of the concatenated branch following the layer which generates the neural-based embedding may process the generated neural-based embedding in furtherance of performing a task. For example, the task may be, in some embodiments, a classification task that is performed by processing the generated neural-based embedding. The output 5908 may, in this example, be an identification of a class to which the signal input to the BANN system belongs.

Table 1, included below, illustrates an example configuration for the respective layers in an example implementation of the ANN 5904 of FIG. 42.

TABLE 1
Example Configuration of Artificial Neural Network 5904

| 1i | input_EMD | Dim: number of examples |
|---|---|---|
| 2o | ReLU_EMD | Rectified linear unit, output Dim: number of examples |
| 3i | input_RAT | 4096 (64 × 64) |
| 4 | conv_RAT | 4096, 4 kernels, kernel dimension 3 × 3 |
| 5 | batchnorm_RAT | batch normalization, eps = 1e−5, train bias(β) and weight(γ) |
| 6 | ReLU_Rat | Rectified linear unit |
| 7o | flat_RAT | 16384 |
| 8i | Input_LSTM | 28672 (64 electrodes × 64 electrodes × 7 time windows) |
| 9 | flat_LSTM | 1 × 4096 (electrodes) |
| 10o | LSTM | 100 hidden units, output D: 100 |
| 11i | input_WAV | D: 64 × 64 (electrodes) |
| 12 | conv_WAV | 4096, 4 kernels, kernel dimension 3 × 3 |
| 13 | batchnorm_WAV | batch normalization, eps = 1e−5, train bias(β) and weight(γ) |
| 14 | ReLU_WAV | Rectified linear unit |
| 15o | flat_WAV | 16384 |
| 16i | Input_LAT | 4096 (64 × 64) |
| 17 | conv_LAT | 4096, 4 kernels, kernel dimension 3 × 3 |
| 18 | batchnorm_LAT | batch normalization, eps = 1e−5, train bias(β) and weight(γ) |
| 19 | ReLU_LAT | Rectified linear unit |
| 20o | flat_LAT | 16384 |
| 21(2, 7, 10, 15, 20) | concatenation | D: concatenate (1 × number of examples) and (1 × 49252) |
| 22 | linear_TRI1 | concatenate (1 × number of examples) and (1 × 49252), 100 |
| 23 | ReLU_TRI1 | Rectified linear unit |
| 24 | linear_TRI2 | 100, number classes |
| 25 | Relu_TRI2 | Rectified linear unit |
| 26 | classes_TRI | number of classes |
| 27 | softmax_TRI | |
| 28 | classoutput_Tri | |

i = input of raw data
o = output to concatenation layer 21

In the example architecture of the ANN 5904 provided in table 1, at layer (1), using spike-times, the distance between all stimulus examples is computed using the algorithm described in SpikeShip: A method for fast, unsupervised discovery of high-dimensional neural spiking patterns, V2, by Sotomayor-Gómez et al, in PLOS Computational Biology, Jul. 21, 2023, https://doi.org/10.1371/journal.pcbi.1011335 which is hereby incorporated by reference in its entirety herein. For a forward pass through the ANN 104, the vector of distances between the example used in the forward pass and all other examples is taken.

At layer 3, a window of desired length post MEA stimulation between 0 and 200 ms is set. Within this window the spikes for each electrode are summed. From this window, a vector of 4096 spike counts is created.

At layer 4, four convolutional kernels of dimension 3×3 on the 64×64 (electrodes) array of spike rates are applied. Variations of this layer include no conv kernel up many (>10) kernels. The dimension of the kernel can be larger than 3×3, in some embodiments, or smaller than 3×3, in some embodiments.

At layer 8, similar to layer 3, but using multiple temporally adjacent or partially overlapping windows, spikes are summed. The described configuration is with 7 windows, but more or less windows can be used if they yield enhanced classification.

At layer 10, the standard LSTM layer is configured with 100 hidden units, but more or less units can be used if it yields enhanced classification. The final state of the hidden units is used as input to the next layer.

At layer 11, the channel-wise average time of all post-stimulus spikes from a time window of desired length post (0-300 ms) MEA stimulation is extracted.

At layer 16, the electrode-wise time of the first spike in the time window 0-300 ms post stimulation is extracted. If there is no spike, the value for the electrode is defaulted to 0. At layer 21, the 1D vectors from layers 2, 7, 10, 15, and 20 are concatenated.

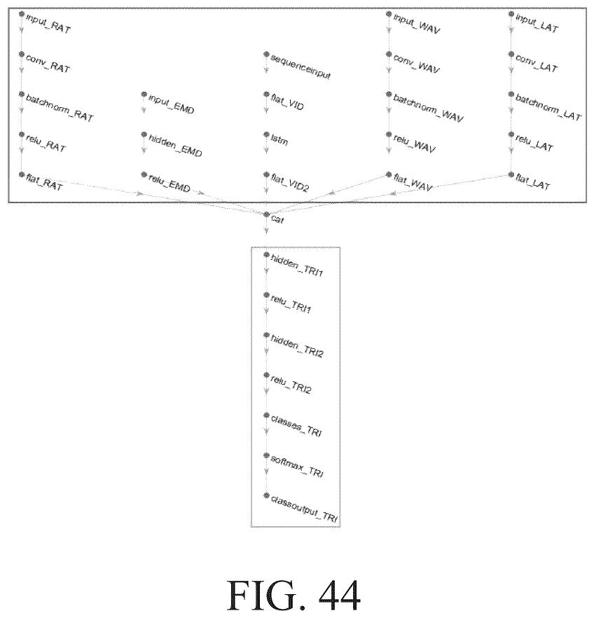

In some embodiments, one or more of the layers of the example architecture shown in FIG. 44 may be omitted from the ANN 104. For example, each of the following layers and the layers preceding the following layers may be omitted from the ANN 104: layers 2, 7, 10, 15, and/or 20.

An artificial neural network for processing multiple features derived from a response of a biological neural network to a stimulation pattern may be trained by estimating values of artificial neural network parameters using training data and suitable optimization software. The optimization software may be configured to perform neural network training by gradient descent, stochastic gradient descent, or in any other suitable way. In some embodiments, Matlab's “Statistics and Machine Learning Toolbox” may be used to train the ANN. In some embodiments, PyTorch may be used to train the ANN.

In one example, the training data includes between 400 and 9,000 classes with 50 or more examples of each class. In another embodiment, more than 9,000 classes (e.g., greater than 100,000 classes) may be used for training. A class is defined by a unique constellation of simultaneous or sequentially stimulated MEA electrodes. A single class example is a single stimulation, simultaneous or sequential, of a unique constellation of electrodes. Data collection may involve interleaving different classes, which means interleaving the stimulation pattern, with unique electrode constellation stimulated with a temporal delay (e.g., a temporal delay of greater than 200 ms, in one example) from the previous stimulation. Data collection for a single dataset can occur across multiple recording sessions that occur on one or multiple data. The input data for the ANN may include spikes collected following stimulation. In some embodiments, the input data for the ANN may include spikes measured during stimulation if electrodes are stimulated sequentially for a single class.

Table 1 indicates example data input dimensions for layers 1, 3, 8, 11, and 16 of the ANN. Namely, layer 1, the Earth Mover's Distance head, is a 1×number of total examples (classes time repeats of each classes) dimensional vector. Layer 3, the rate data-head, is a 64×64 matrix of spike rates evoked during or immediately following MEA stimulation. Layer 8, the LSTM data head, is a 64×64×7 (time windows) matrix of rates from adjacent or partially overlapping time windows during and/or post MEA stimulation. Layer 11, the wave data head, is a 64×64 matrix of mean spike times from spikes collected in a time window of varying set length 0-200 ms post stimulation. Layer 16, the latency data head, is a 64×64 matrix containing the channel-wise delay between an end of a single MEA stimulation and the first spike.

The ANN 104 illustrated in FIG. 42 may have millions of parameters (e.g., between 1 and 10 million parameters, between 5 and 50 million parameters). In one implementation, the ANN may have approximately 5 million parameters. The batch size of hyperparameters may vary from 256 to 16,384 depending on the number of total examples. For each model training, a Bayesian optimizer function may select 10 to 15 learning rates from 0.01 to 1e-6 and find the learning rate with the lowest training loss. Finding the optimal learning rate can be done on the whole ANN, or on each individual data-head classification network (e.g., each branch). In the case that each individual data head network is trained separately, the trained networks indicated by the black box (with the classification layers removed) may be combined with a concatenation layer (layer 21 in the above table) and the ANN layers indicated with the lower box of the example ANN of FIG. 44 are added as layers subsequent to the concatenation layer. The five trained networks along with the untrained layers marked ‘TRI’ in the example ANN of FIG. 44, may then be trained with the Bayesian optimizer to find the learning rate for the partially pre trained network. This process of pre training data head networks can also be performed with a subset of the 5 data heads.

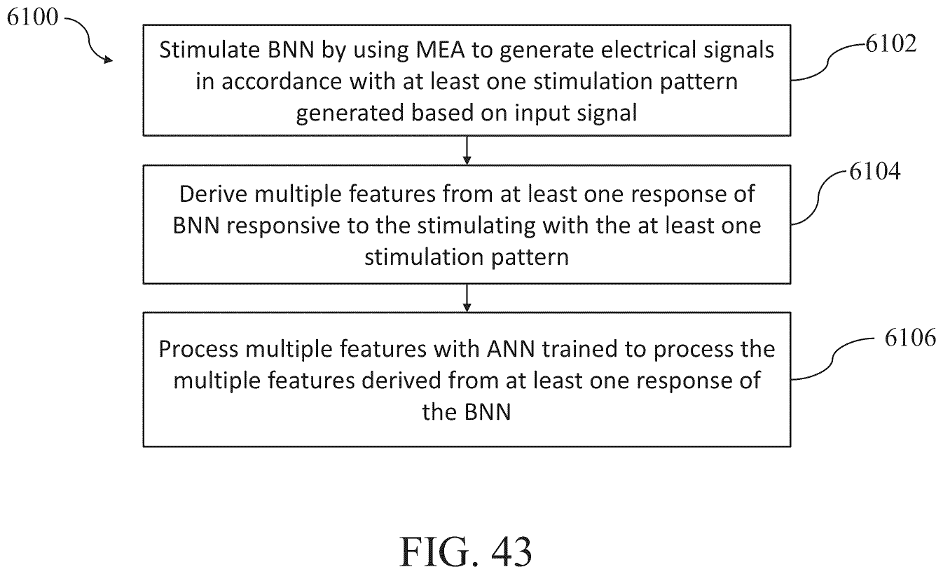

FIG. 43 illustrates an example method 6100 for processing a response of a biological neural network to a stimulation pattern, according to some embodiments of the technology described herein. The example method 6100 may be performed using a BANN system comprising an MEA, a BNN comprising a plurality of cells (e.g., neurons) arranged on the MEA, an ANN, and at least one processor. The method 6100 may follow the workflows schematically illustrated in FIGS. 41-42. The example method may be performed in furtherance of performing a task (e.g., classification, prediction, dimensionality reduction, reinforcement learning, regression, or the like)

The example method 6100 may begin at act 6102, where the BNN is stimulated in accordance with at least one stimulation pattern generated based on an input signal. The stimulating at act 6102 may be performed according to any of the techniques for stimulating the BNN described herein. Applying the stimulation pattern BNN may comprise operating one or more electrodes of the MEA to apply electrical signals to the plurality of cells of the BNN in accordance with the stimulation pattern (e.g., according to the timing, location, and characteristics of the electrical signals defined by the stimulation pattern). The stimulation pattern may be a digital signal that is converted to an analog signal when the stimulation is applied to the BNN. Further aspects of stimulating the BNN in accordance with a stimulation pattern applicable to the method of FIG. 43 are described herein with respect to the workflow in FIG. 7A.

In some embodiments, prior to performing the stimulating at act 6102, the example method 6100 may further comprise receiving an input signal and/or generating the stimulation pattern for performing the stimulating based on the input signal.

For example, the input signal is a signal that is to be processed by the BNN in furtherance of performing a task. The input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal comprises natural language text, numerals, and/or alphanumeric signals. The input signal is typically provided in digital form to the BANN system. In some embodiments, the input signal may comprise multiple input signals. Further aspects of receiving the input signal applicable to the method of FIG. 43 are described herein with respect to the workflow in FIG. 7A.

The BANN system may use the input signal to generate a stimulation pattern for the BNN. Generation of the stimulation pattern may comprise generating a digital signal based on the digital input signal. That is, the input signal is encoded (e.g., by a processor) to generate at least one stimulation pattern for stimulating the BNN. In some embodiments, as described herein, generation of the at least one stimulation pattern may be performed by processing the input signal with a trained statistical model, such as an ANN (e.g., a convolutional ANN). In other embodiments, generation of the at least one stimulation pattern may be performed by the processor without use of an ANN.

The stimulation pattern may comprise a pattern according to which the BNN is stimulated using one or more electrodes of the MEA. That is, the stimulation pattern provides instructions regarding how stimulation of the BNN with the MEA is to be performed, which may include which electrodes to use to transmit electrical signals to the BNN, a timing of transmitting the electrical signals, and/or a frequency, voltage, and/or current of the electrical signals transmitted to the BNN. In some embodiments, the input signal may be encoded by the processor into the stimulation pattern spatially (e.g., by controlling which electrodes to use to transmit electrical signals to the BNN) and/or temporally (e.g., by controlling when particular electrodes transmit electrical signals to the BNN).

In some embodiments, such as where the input signal comprises an image, the stimulation pattern comprises a mapping between the input signal and the MEA. For example, the stimulation pattern may be a 1:1, or other suitable ratio other than 1:1 (e.g., greater than, less than), mapping between pixels of the input image to electrodes of the MEA, and the electrical signals transmitted by each electrode may depend on a characteristic of the image at the pixel corresponding to a respective electrode. For example, an intensity or other characteristic of the image at a particular pixel may correspond to a frequency, current, and/or voltage value of an electrical signal applied by the electrode corresponding to that pixel. Further aspects of generating the stimulation pattern applicable to the method of FIG. 43 are described herein with respect to the workflow in FIG. 7A.

At act 6104, at least one response of the BNN responsive to the stimulating is measured. Specifically, the cells output electrical signals, called extracellular membrane potentials, which can be recorded by one or more electrodes of the MEA as voltage values. The one or more electrodes of the MEA which record the response the response of the BNN to the stimulation may be different, the same, or partially the same as the electrodes which perform the stimulation. BNN activity can also be measured by visualizing Calcium (Ca2+) transients. Measuring the at least one response may comprise deriving, from the at least one response of the BNN, multiple features of the at least one response (e.g., with a feature extraction component which may be a processor, and, in some embodiments, may comprise an ANN). For example, the multiple features may comprise any of the features of the BNN response to stimulation described herein (e.g., one or more of spike rate, latency, average latency, a sequence of images of the at least one response of the BNN, and/or Earth mover's distance). In addition, the multiple features may comprise any suitable number of features (e.g., two features, three features, four features, five features, greater than five features, etc.). Further aspects of measuring the at least one response of the BNN applicable to the method of FIG. 43 are described herein with respect to the workflow in FIG. 7A.

At act 6106, the multiple features derived at act 6104 are processed with an ANN. The ANN may be trained to process the multiple features derived from the at least one response of the BNN. For example, the ANN may be trained based on training data that comprises the types of features derived from the response at act 6104. Further aspects of processing the multiple features derived from the BNN response applicable to the method of FIG. 43 are described herein with respect to the workflow in FIG. 7A.

Processing the multiple features at act 6106 can be performed to obtain an output, such as a task output, as described herein. The processing of the multiple features at act 6106 may be performed in parallel by processing each feature through a respective branch of the ANN, as described herein.

As described herein, the ANN may comprise a plurality of branches, each branch of the plurality of branches configured to receive and process a respective one of the multiple features and wherein each of the plurality of branches of the ANN further comprise one or more additional layers that process the respective one of the multiple features. In some embodiments, the one or more additional layers comprise a convolutional layer, a batch normalization layer, a non-linearity layer, a fully-connected layer, and/or a recurrent layer. In some embodiments, processing the multiple features comprises processing each respective feature in a respective one or the plurality of branches of the ANN. In some embodiments, the processing the multiple features further comprises concatenating outputs of the plurality of branches to generate a concatenated output. In some embodiments, processing the multiple features further comprises performing further processing on the concatenated output. Performing the further processing on the concatenated output may comprise processing the concatenated output using multiple layers of a concatenated branch of the ANN. The processing of the concatenated output may be performed to obtain a neural-based embedding. The neural-based embedding may be used to perform a task with the ANN. In some embodiments, the neural-based embedding may be used to perform a task with a second ANN by inputting the neural-based embedding to the second ANN. The ANN described herein may be implemented using the architecture shown and described with respect to FIGS. 41-42 and/or 44, for example.

As described herein, the method 6100 may be performed in furtherance of performing a task. In some embodiments, the task comprises generation of a neural-based embedding for a token. For example, the input signal from which the stimulation pattern is generated based on may be a token, such as a word. The processing performed at act 6106 may be performed to obtain a neural-based embedding for the input token. In some embodiments, the method may further comprise providing the neural-based embedding as input to a trained statistical model, such as an ANN, and more specifically, a large language model (LLM), and performing a task using the trained statistical model. In some embodiments, the task may comprise a classification task, a prediction task, a dimensionality reduction task, a reinforcement learning task, or a regression task.

FIG. 44 illustrates an architecture of an example artificial neural network for processing a response of a biological neural network to a stimulation pattern, according to some embodiments of the technology described herein. In particular, FIG. 44 illustrates an example neural network that may be used with the example method 6100 illustrated in FIG. 43. As shown in FIG. 44, the example neural network comprises a first portion having a plurality of branches and a second portion where outputs of the plurality of branches are concatenated and processed. The second portion may be appended to the first portion based on a specific task that it is desired for the ANN to perform. For example, in the illustrated embodiment, layers of the ANN are configured for performing a classification task. The second portion of the ANN comprising the concatenated branch of the ANN generates a neural-based embedding that, in the illustrated example, is used to perform the classification task.

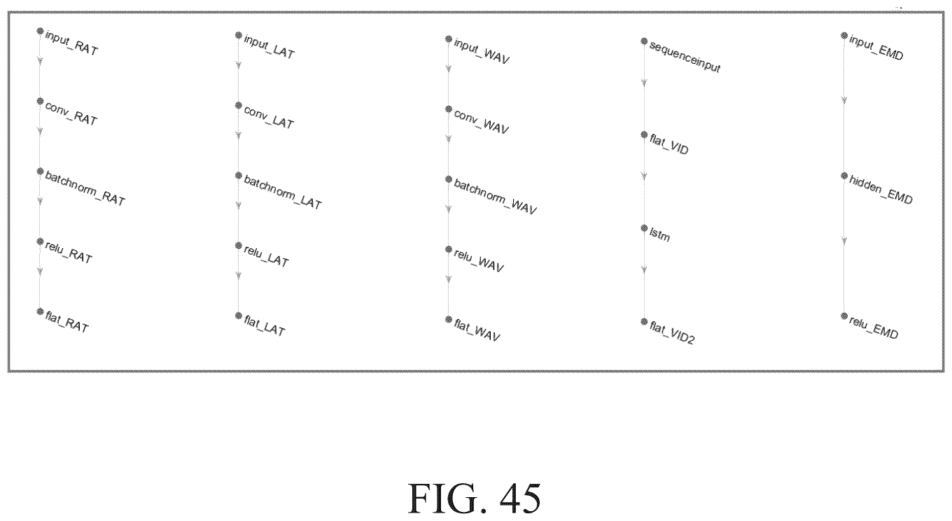

FIG. 45 illustrates an architecture of the example artificial neural network of FIG. 44 that can be applied to different tasks, according to some embodiments of the technology described herein. In particular, FIG. 45 illustrates a portion of the ANN of FIG. 44, specifically, the first portion of the ANN having multiple branches that process inputs in parallel to each other. As described herein, the ANN comprises multiple branches for processing respective features derived from the measured response of the BNN. In the illustrated embodiment, the ANN comprises a respective branch for each one of five features derived from the response of the BNN. The features illustrated in FIG. 45 are spike rate, latency, average latency (WAV), a sequence of frames (e.g., a video), and EMD.

Each branch of the ANN illustrated in FIG. 45 comprises multiple layers. For example, in the illustrated embodiment, each branch of the ANN comprises an input layer representing a step of receiving the feature, and may comprise one or more of a convolutional layer, a batch normalization layer, a recurrent layer (e.g., one or more LSTM layers), a hidden layer, a non-linearity layer (e.g., one or more rectified linear unit layers), and/or a flattening layer. The architecture of the ANN shown in FIG. 45 may be used when processing the multiple features of the BNN response to perform a task, examples of which are provided herein.

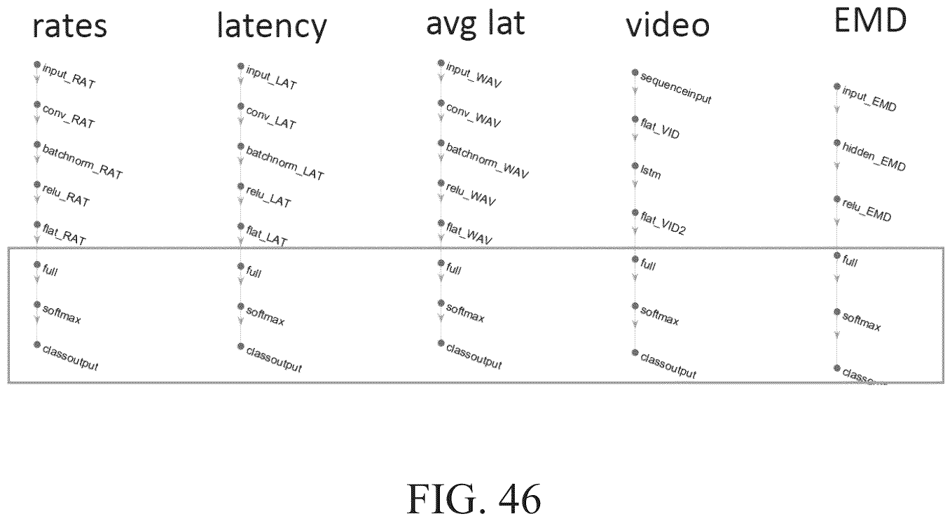

FIG. 46 illustrates an architecture for training the example artificial neural network of FIG. 44, according to some embodiments of the technology described herein. FIG. 46 illustrates a “head” comprising layers that can be appended to the portion of the ANN in FIG. 45 to train the ANN, based on a particular task that it is desired for the ANN to perform. In the illustrated example, the additional layers are configured for use in training the ANN to perform a classification task.

For example, the final layer from each of the training-head networks is concatenated with the final layer of the other training-head networks into a single one-dimensional linear layer. The final concatenated layer can contain one or more (e.g., 1-5) final training head layers, in some embodiments. The concatenated one-dimensional linear layer projects to a fully-connected layer. The fully-connected layer connects to a ReLu layer. The ReLu layer projects to a linear layer where each node in the layer represents a possible class output. The linear layer projects to a softmax layer which projects to a classification output layer.

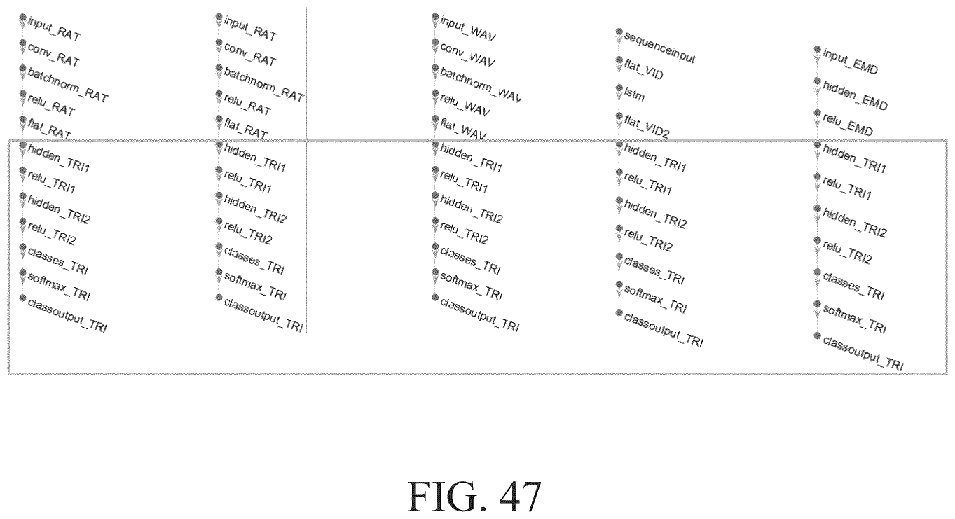

FIG. 47 illustrates another representation of the example artificial neural network of FIG. 44, according to some embodiments of the technology described herein. In the illustrated example of FIG. 47, the branches are not concatenated and instead perform processing of the respective features in parallel through a classification output layer. By contrast, in the example shown in FIG. 44, the branches are concatenated to combine the processing steps at the layers highlighted in the box.

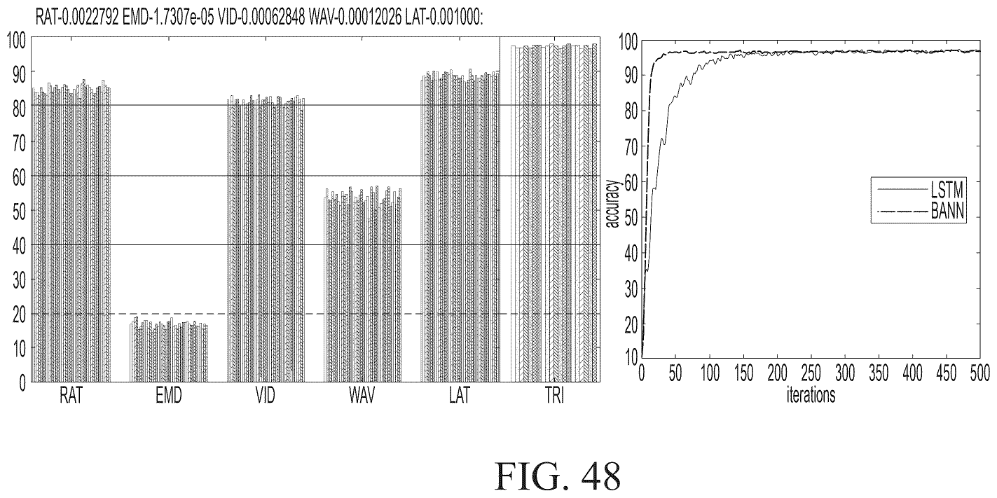

FIG. 48 illustrates graphs depicting results of the example artificial neural network of FIG. 44 at a classification task, according to some embodiments of the technology described herein. The ANN described herein combines all neuronal responses to achieve greater accuracy in performing tasks. FIG. 48 illustrates results of the ANN at performing a classification task. The results show that the ANN described herein achieves a 97% accuracy in sentence classification more efficiently than an ANN (an LSTM, in this example) alone. This is reproducible across several plates (left graph).

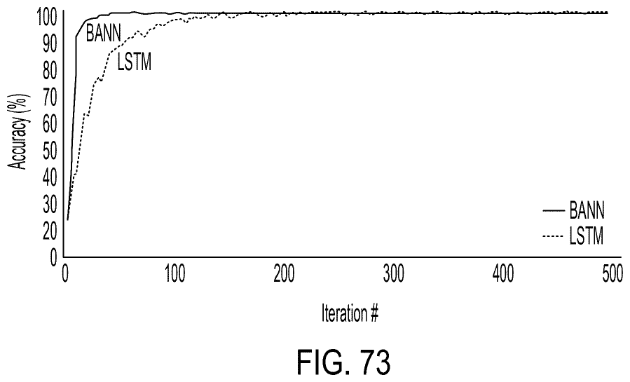

FIG. 73 illustrates an example graph depicting results of a biological neural network's performance at a sentence classification task, according to some embodiments of the technology described herein. FIG. 73 illustrates results of an LSTM trained on neuronal responses at performing a sentence classification task. The results show that the LSTM achieves near-perfect classification more quickly than an LSTM trained on sentences alone, improving performance in the context of fading memory. Here, the BANN shows improved performance (shown by accuracy of performing a sentence classification task) over an ANN (the LSTM shown in FIG. 73).

### VIII. Techniques for Calibrating the BNN

As described herein, some aspects provide for techniques that can be used for calibrating the BNN. For example, according to some aspects there is provided a calibration technique for selecting which electrodes to use when performing stimulation of the BNN.

Highly reactive electrodes are electrodes that respond directly to electrical stimulation. Such highly reactive electrodes may be used to identify “context electrodes”, as described herein. In order to identify these highly reactive electrodes to use during stimulation of the BNN, an initial sequence of probe electrode “PE” stimuli may be performed, for example, by scanning all electrodes for the highest responders. The PE stimulus may be sequentially performed evenly across the MEA with the subset (e.g., 9) of electrodes showing the highest firing rate after probe stimulus being considered highly reactive, or the context electrodes.

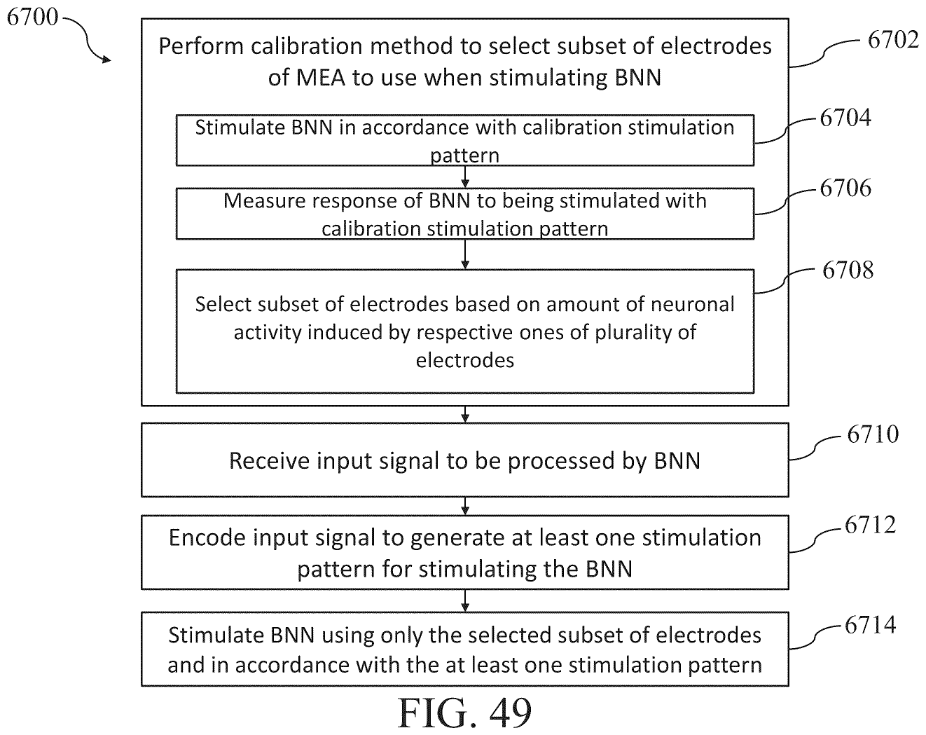

FIG. 49 illustrates an example method 6700 for calibrating a biological neural network, according to some embodiments of the technology described herein. The method 6700 may be performed on and/or with a system comprising an MEA, a BNN comprising a plurality of cells (e.g., neurons) arranged on the MEA, and at least one processor.

The example method 6700 may begin at act 6702 where a calibration method is performed to select a subset of electrodes of the MEA to use when stimulating the BNN. The calibration method at act 6702 may be performed at least in part by performing acts 6704-6708.

At act 6708, the BNN is stimulated in accordance with at least one calibration stimulation pattern. For example, the calibration stimulation pattern may be a pattern that evokes a response from the cells of the BNN such that the electrodes of the BNN can be evaluated. Applying the stimulation pattern to the BNN comprises operating one or more electrodes of the MEA to apply electrical signals to the plurality of cells of the BNN in accordance with the calibration stimulation pattern (e.g., according to the timing, location, and characteristics of the electrical signals defined by the stimulation pattern). Further aspects of generating a stimulation pattern and applying the stimulation pattern to the BNN applicable to the method of FIG. 49 are described herein, for example, with respect to the workflow in FIG. 7A.

At act 6706, at least one response of the BNN to being stimulated with the at least one calibration pattern is measured. Specifically, the cells output electrical signals, called extracellular membrane potentials, which can be recorded by one or more electrodes of the MEA as voltage values. The one or more electrodes of the MEA which record the response the response of the BNN to the stimulation may be different, the same, or partially the same as the electrodes which perform the stimulation. BNN activity can also be measured by visualizing Calcium (Ca2+) transients. Further aspects of measuring a response of the BNN applicable to the method of FIG. 49 are described herein, for example, with respect to the workflow in FIG. 7A.

At act 6708, a subset of the electrodes of the MEA are selected based on an amount of cellular (e.g., neuronal) activity induced by respective ones of the plurality of electrodes. The selected subset of electrodes may be the electrodes which are most responsive (e.g., which evoke the most neuronal activity when used to stimulate the BNN, which measure the most response of the BNN). For example, the selecting the subset of the plurality of electrodes may comprise, determining, based on the measured at least one response of the BNN, a ranking of respective ones of the plurality of electrodes based on the amount of neuronal activity induced by the respective ones of the plurality of electrodes. For example, the ranking may rank the electrodes from highest (e.g., most neuronal activity induced) to lowest (e.g., least neuronal activity induced). The subset of the plurality of electrodes may be selected based on the ranking. For example, a certain number of top electrodes in a particular location (e.g., in each quadrant of the MEA, in the entire MEA) may be selected as the subset. The amount of neuronal activity may be determined based on one or more raw voltage measurements of the BNN response, in some embodiments. In some embodiments, the amount of neuronal activity may be determined based on one or more of the features that can be derived from the BNN response, examples of which are provided herein. For example, in some embodiments, the amount of neuronal activity may be based on a spike rates of the BNN response evoked by respective electrodes.

Subsequent to selecting the subset of the plurality of electrodes of the MEA, the method 6700 continues to act 6710 where an input signal to be processed by the BNN is received. The input signal is a signal that is to be processed by the BNN in furtherance of performing a task. The input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal comprises natural language text, numerals, and/or alphanumeric signals. The input signal is typically provided in digital form to the processor. In some embodiments, the input signal may comprise multiple input signals. Further aspects of receiving an input signal applicable to the method of FIG. 49 are described herein, for example, with respect to the workflow in FIG. 7A.

At act 6712, the input signal received at act 6710 is encoded to generate at least one stimulation pattern for stimulating the BNN. Generation of the stimulation pattern may comprise generating a digital signal based on the digital input signal. That is, the input signal is encoded by a processor, which may be a trained statistical model, such as an ANN, to generate at least one stimulation pattern for stimulating the BNN. In some embodiments, as described herein, generation of the at least one stimulation pattern may be performed by processing the input signal with a trained statistical model, such as an ANN (e.g., a convolutional ANN). In other embodiments, generation of the at least one stimulation pattern may be performed by the processor without use of an ANN.

The stimulation pattern may comprise a pattern according to which the BNN is stimulated using one or more electrodes of the MEA. That is, the stimulation pattern provides instructions regarding how stimulation of the BNN with the MEA is to be performed, which may include which electrodes to use to transmit electrical signals to the BNN, a timing of transmitting the electrical signals, and/or a frequency, voltage, and/or current of the electrical signals transmitted to the BNN. In some embodiments, the input signal may be encoded by the processor into the stimulation pattern spatially (e.g., by controlling which electrodes to use to transmit electrical signals to the BNN) and/or temporally (e.g., by controlling when particular electrodes transmit electrical signals to the BNN).

In some embodiments, such as where the input signal comprises an image, the stimulation pattern comprises a mapping between the input signal and the MEA. For example, the stimulation pattern may be a 1:1, or other suitable ratio other than 1:1 (e.g., greater than, less than), mapping between pixels of the input image to electrodes of the MEA, and the electrical signals transmitted by each electrode may depend on a characteristic of the image at the pixel corresponding to a respective electrode. For example, an intensity or other characteristic of the image at a particular pixel may correspond to a frequency, current, and/or voltage value of an electrical signal applied by the electrode corresponding to that pixel. Further aspects of generating a stimulation pattern applicable to the method of FIG. 49 are described herein, for example, with respect to the workflow in FIG. 7A.

At act 6714, the BNN is stimulated in accordance with the at least one stimulation pattern, and in particular, using only the selected subset of electrodes. Applying the stimulation pattern to the BNN comprises operating the selected subset of electrodes of the MEA to apply electrical signals to the plurality of cells of the BNN in accordance with the stimulation pattern (e.g., according to the timing, location, and characteristics of the electrical signals defined by the stimulation pattern). Further aspects of stimulating a BNN in accordance with a stimulation pattern applicable to the method of FIG. 49 are described herein, for example, with respect to the workflow in FIG. 7A. In some embodiments, the selected subset of electrodes may be used to apply a stimulation pattern to reduce burstiness, as described herein.

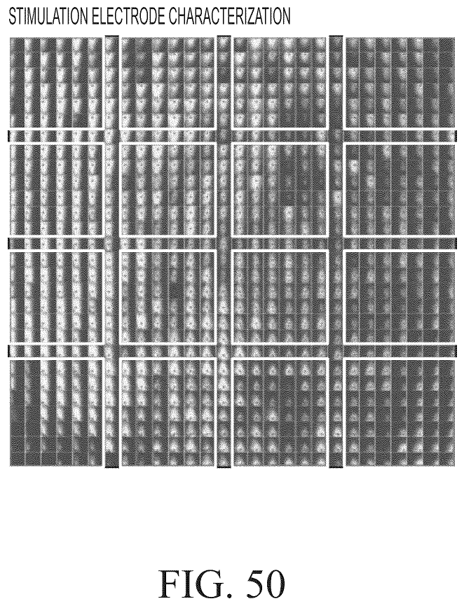

FIG. 50 illustrates stimulation of a biological neural network with a multi-electrode array that shows aspects of the example method of FIG. 49, according to some embodiments of the technology described herein. In particular, FIG. 50 illustrates a selection process for a subset of electrodes where a grid of approximately 1,000 stimulation sites, represented as dots in FIG. 50, are evaluated based on network-wide responses of the BNN (shown by the darker and brighter shading surrounding each dot).

The calibration process shown in FIG. 50 involves probing the MEA to determine electrode activity and basing subsequent stimulation on the determined electrode activity. This process may include applying a single stimulus pulse with each electrode, tracking a response of the BNN at each electrode for a period of time (e.g., 30 seconds after stimulation), and ranking/sorting the electrodes to identify the most highly responding electrodes. That is, the most highly responding electrodes may refer to the electrodes which make each neuron respond the most. In some embodiments, the 36 most electrodes for the whole array are selected as the “context” electrodes. Subsequent stimulation of the BNN may be performed using the selected electrodes.

In some embodiments, the calibration techniques described herein may be performed before stimulation according to a stimulation pattern derived from an input signal is performed. The calibration technique may determine the most “responsive” electrodes to ensure that stimulation to perform a task is performed most efficiently and effectively (e.g., by using the most responsive electrodes). The inventors have recognized that it would be undesirable to stimulate the BNN using unresponsive electrodes, as this is an inefficient use of the BNN that may not lead to successful performance of a task. The calibration techniques described herein avoid this problem. In some embodiments, calibration may include calibration that is performed to identify a set of electrodes, that is, a set of electrodes that may be used for stimulation and/or feedback, as described herein. In some embodiments, calibration may include calibration that is performed to reduce burstiness of the MEA, as described herein. Accordingly, calibration may be performed according to the techniques described herein for one or more purposes.

According to some embodiments, another reason it may be desired to run calibration on an electrode array prior to stimulation is to reduce burstiness of the BNN. In particular, neurons exhibit a burst phenomenon which can occur regularly but not in response to any stimulus. It is desirable to minimize this behavior because it creates noise that conflicts with reading the neuronal response.

For example, unlike in vivo networks, cultured neural networks maintain activity patterns dominated by global bursts, hypothesized to be caused by a lack of input from what would be otherwise connected networks. That is, the cell culture will spontaneously ‘burst’ if not stimulated. A burst is pattern of activity where most cells fire rapidly for ˜100 ms. These array-wide network bursts have been shown to interfere with network entrainment and thus it is desirable to significantly reduce such array-wide network bursts. Several studies have shown that high frequency, rapid stimulation at “highly reactive” electrodes reduces the “burstiness” of dissociated cultures. That is, if the plate is often stimulated bursts can be successfully suppressed. Accordingly, the inventors have developed calibration techniques which interleave stimulation patterns performed to encode input signals to the BNN with calibration stimulation patterns designed to reduce burstiness of the BNN.

In one illustrative example, when tokens are stimulated, stimulation may be performed every 250 ms. This is rapid enough to prevent bursts. If stimulation is performed less often, as may be the case where the input signal comprises data from the MNIST and/or CIFAR datasets, context electrode stimulation between multi-electrode stimulations may be used to reduce burstiness of the BNN. As described herein, context electrodes are electrodes that evoke activity and are not part of the intended (CIFAR, MINIST or other) stimulation. The context electrodes are stimulated up to 100 ms before an intended stimulus. Three to six stimulations with unique context electrodes may be performed. Usually, the same context stimulation electrodes and current is performed before each intended stimulus. Context electrode stimulation may involve a 120 μA positive stimulation, then a 20 μs pause, then 120 μA negative stimulation. The current used for stimulation may be lower than the intended stimuli, for example, between 4-10 μA.

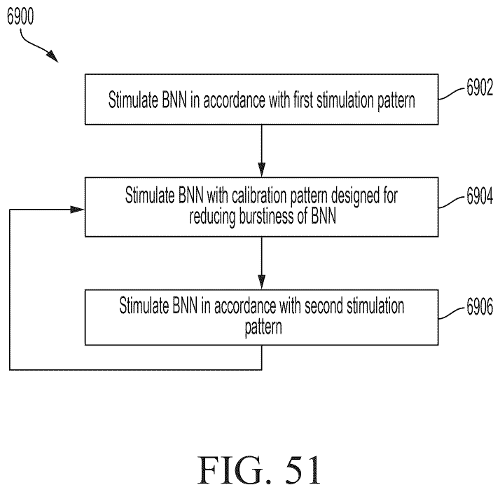

FIG. 51 illustrates an example method 6900 for calibrating a biological neural network, according to some embodiments of the technology described herein. The method 6900 may be performed to reduce burstiness of the BNN by applying a calibration pattern to the BNN that is designed for reducing burstiness of the BNN.

As shown in FIG. 51, the example method may begin at act 6902, where the BNN is stimulated in accordance with a first stimulation pattern. For example, the stimulation performed at act 6902 may be in furtherance of performing a task. That is, the stimulation performed at act 6902 may be so that the BNN produces “evoked” bursts as opposed to bursts which happen not in response to a stimulation. Applying the stimulation pattern to the BNN comprises operating one or more electrodes of the MEA to apply electrical signals to the plurality of cells of the BNN in accordance with the stimulation pattern (e.g., according to the timing, location, and characteristics of the electrical signals defined by the stimulation pattern). Further aspects of applying a stimulation pattern to the BNN applicable to the method of FIG. 51 are described herein, for example, with respect to the workflow in FIG. 7A.

At act 6904, the BNN is stimulated with a calibration pattern that is designed to reduce burstiness of the BNN. For example, the calibration pattern may be performed subsequent to the stimulation of the BNN in furtherance of performing a task. That is, the stimulation patterns applied during use of the BNN to perform a task may be interleaved with the calibration pattern designed to reduce burstiness. In some embodiments, the calibration pattern may be a tetanic barrage applied to the MEA. In some embodiments, the calibration pattern is applied to only a subset of the plurality of electrodes of the MEA (e.g., only the selected subset of electrodes described herein). The inventors have recognized that application of the calibration pattern designed to reduce burstiness of the BNN can “quiet” the BNN by minimizing bursts occurring which are no responsive to stimulation. Applying the calibration pattern to the BNN comprises operating one or more electrodes of the MEA to apply electrical signals to the plurality of cells of the BNN in accordance with the stimulation pattern (e.g., according to the timing, location, and characteristics of the electrical signals defined by the stimulation pattern). Further aspects of applying a calibration pattern to the BNN applicable to the method of FIG. 51 are described herein, for example, with respect to the workflow in FIG. 7A.

At act 6906, the BNN is stimulated in accordance with a second stimulation pattern. In some embodiments, the second stimulation pattern may be the same as the first stimulation pattern. In other embodiments, the second stimulation may be different than the first stimulation pattern. Applying the stimulation pattern to the BNN comprises operating one or more electrodes of the MEA to apply electrical signals to the plurality of cells of the BNN in accordance with the stimulation pattern (e.g., according to the timing, location, and characteristics of the electrical signals defined by the stimulation pattern). Further aspects of applying a stimulation pattern to the BNN applicable to the method of FIG. 51 are described herein, for example, with respect to the workflow in FIG. 7A. Subsequent to act 6906, the method may end, or may loop back to act 6904 where further stimulation of the BNN with a calibration pattern designed for reducing burstiness of the BNN is performed. Accordingly, one or more acts of the method 6900 may be repeated as desired.

Acts 6902-6906 reflect that the calibration pattern designed to reduce burstiness of the BNN can be interleaved with application of stimulation patterns. The application of the calibration pattern designed to reduce burstiness can be applied at any suitable time. As shown in the illustrated embodiment, the calibration pattern is applied between applications of stimulation patterns. In some embodiments, the calibration pattern may be applied after each “cycle” of using the BNN. A cycle of using the BNN may comprise application of a stimulation pattern. In some embodiments, the cycle may further comprise application of positive or negative feedback stimulus to train the BNN. In some embodiments, the cycle may be preceded by performance of the calibration method described herein for selecting a subset of electrode with which to perform stimulation.

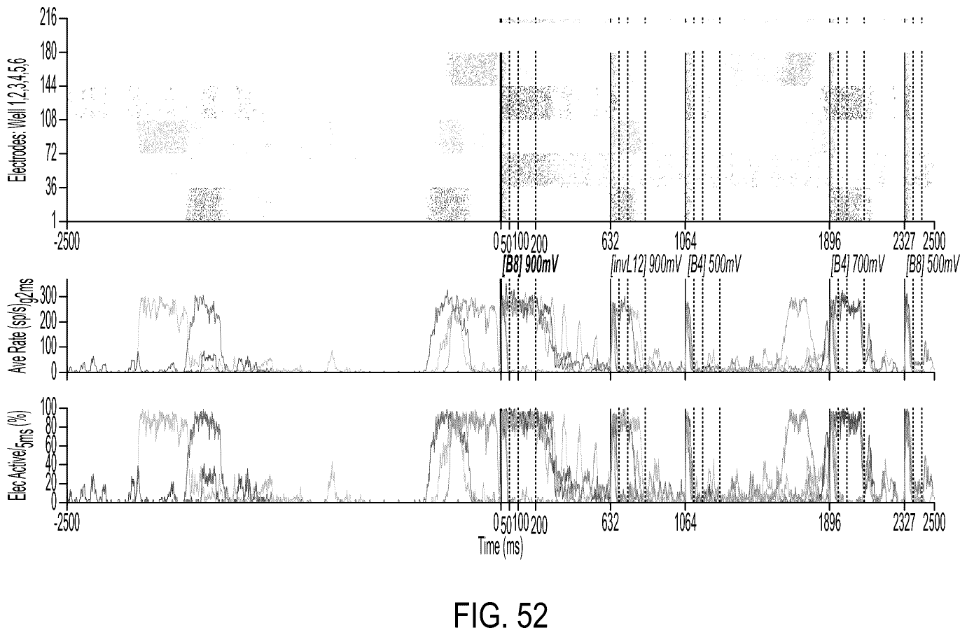

FIG. 52 illustrates graphs depicting identification of bursts in a biological neural network, according to some embodiments of the technology described herein. As shown in FIG. 52, some bursts are evoked in response to stimulation while others are spontaneous, not in response to stimulation. The spontaneous bursts create noise of which is desirable to minimize to improve performance of the BNN.

FIG. 52 illustrates a neuronal activity plot across 6 arrays. Dots in the plots illustrate individual extracellular voltages. Black lines in the plots illustrate probe stimuli (e.g., application of a stimulation pattern). Here, spontaneous bursts (black and white area) and evoked bursts (next to black lines) are identified. The spontaneous bursts occurring for a BNN may be analyzed to evaluate a burstiness of the BNN and/or the efficacy of calibration methods for reducing burstiness.

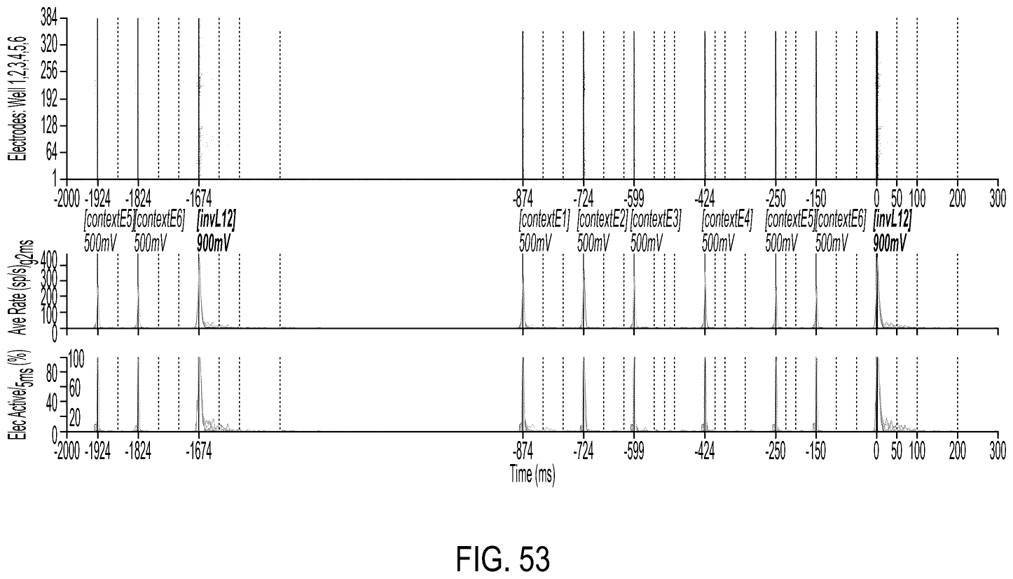

FIG. 53 illustrates graphs depicting results of burst suppression through electrical stimulation, according to some embodiments of the technology described herein. As shown in FIG. 53, burst activity may be suppressed using electrical stimulation. Context electrodes chosen with firing rates 5 SD above baseline for the 20 ms after single electrode stimulation may be used to perform the burst suppression. In the experiment from which the results of FIG. 53 were obtained, the context electrode stimulation parameters were parametrically changed until burst suppression was achieved.

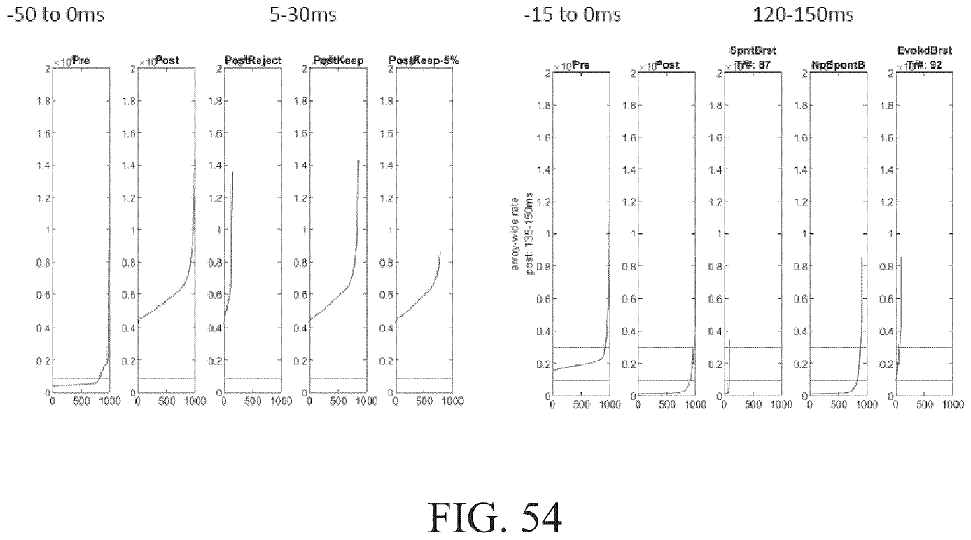

FIG. 54 illustrates graphs depicting thresholds set for burst removal, according to some embodiments of the technology described herein. In some embodiments, spontaneous bursts of a BNN may be monitored to determine whether to perform a calibration method designed to reduce burstiness of the BNN (e.g., if burstiness of the BNN exceeds a threshold). FIG. 54 shows thresholds set for burst removal based on array-wide rates. Evoked bursts are identified using the window 120-150 post stimulation and an interquartile range is established. A threshold is set beyond the interquartile range and any neuronal activity beyond this threshold is identified and removed.

### IX. Applications of BNNs for Large Language Models

In some embodiments, the BNN systems described herein may be used for applications related to large language models (LLMs). For example, in some embodiments, a BNN system may be used to create a neural-based embedding for a token, such as a unit of text (e.g., a word, a sequence of characters, multiple words). In some embodiments, a dictionary of neural-based embeddings may be created which includes a BNN generated neural-based embedding for each token in a corpus of tokens.

The neural-based embedding created using the BNN system may be used in combination with an ANN to perform a task. For example, in some embodiments the token is text and the ANN may be a large language model (LLM), and processing the text with the LLM includes use of a neural-based embedding generated using the BNN for the text.

For example, in some embodiments, text may be processed to obtain tokens (e.g., words or other units of text) and the tokens may be embedded, using the neural embedding techniques described herein, prior to being subsequently processed by an LLM. This would differ from the conventional approach of embedding the tokens using a conventional word embedding approach, for example word2vec, by instead generating neural embeddings using a dictionary of neural-based embeddings created using the BNN techniques described herein. The word2vec techniques is described in the literature, for example, in Tomas Mikolov, Kai Chen, Greg Corrado, and Jeffrey Dean. “Efficient Estimation of Word Representations in Vector Space.” In Proceedings of the International Conference on Learning Representations (ICLR) 2013, which is incorporated by reference herein. As described herein, the inventors have demonstrated that using neural embeddings in lieu of conventional embeddings such as word2vec, improves performance for a fixed computational budget for training or, viewed alternatively, reduces the amount of training required for the same level of performance thereby reducing the amount of computational power needed for training the LLM resulting in computational power (and therefore energy) savings.

State-of-the-art transformer models establish statistical dependencies between linguistic entities such as words, phrases, and paragraphs. Leveraging the brute force of computing, LLMs like GPT-4, with its 1.76 trillion parameters, have made significant advancements in using these relationships for language generation through decoder architectures. However, progress in language understanding through encoding architectures has been slower. Neural tissue offers a huge opportunity on the encoding side of LLMs. Neural tissue, with its non-linear, recurrent, and fading memory characteristics-which maintains information through time, offers a far superior encoding of linguistic relationships than current digital computing offers. This superior analogue encoding can enhance LLM accuracy and reduce energy consumption. As such, the BNN and BANN described herein may be applied towards the encoding of language.

In some embodiments, the initial strategy involves leveraging BNNs for the embedding layer, which encodes words into a high-dimensional neural representation. Similarly, BNNs may be employed in an interstitial layer between embedding and the initial stages of the LLM's transformer network. Both the embedding and post-processing stages, important for training and inference, are computationally demanding and stand to gain from the high-dimensional analog computation capabilities of BNNs. The goal for the BANN is to surpass its ANN counterparts in terms of accuracy and efficiency of execution and training. These aspects are evaluated using standard industry metrics for LLMs, such as accuracy in predicting masked words within sentences or the ability to identify sentences originating from the same document.

An example of the process currently used in one embodiment is as follows: initially, a lexicon of 100 words is employed, generating for each word a respective spatial and temporal (4D) pattern for stimulation in a biological network. Thus, a textual sentence composed words from the lexicon may be turned into a sequence of stimulation patterns having a stimulation pattern for each token (e.g., word) in the sentence. In this way, a series of token stimulations encodes one sentence in the neural tissue. Of note, these tokens are encoded temporally, taking advantage of the non-linear dynamic range of biological networks. In this example, 50,000 neural responses were obtained. Each of the neural responses were the product of a unique spatial pattern used to stimulate the MEA. The responses to a stimulus was the time-to-first-spike on each electrode. Further analysis as performed on the complete 4094 vector of spike latencies as well as a subset of the most active electrodes. The neural response then replaced the silicon token when training a GPT2 model from scratch.

To further optimize this analogue computation, the synaptic weights of the tissue were trained using a closed-loop system to class separation of the spiking outputs, which reflect sentences, before they were input to the ANN for further class separation.

Through training, the BNN learned to optimally classify sentences. This procedure was replicated for all possible word arrangements in the small lexicon and can scale to significantly larger lexicons, including an entire language. Not only is sentence classification (prediction of the next word) enhanced by the biology, but sentence completion as well. The BNN may be used to predict subsequent or missing words in a sentence due to pattern completion properties inherent in neural tissue.

The inventors have recognized that a significant benefit of incorporating a BNN lies in leveraging the analogue computational properties of neural tissue, which throws linguistic entities into a very high dimensional computational space and harnessing the inherent learning properties of BNN's, through synaptic modification. The higher-dimensional space allows for far more accurate and faster identification of class boundaries than digital computing alone can offer online learning which allows for more accurate and efficient classification. Additionally, this approach aims to bypass the problematic disappearing or exploding gradient issue observed in traditional recurrent ANNs like LSTM or GRU.

a. Creating a Dictionary of Neural-Based Embeddings

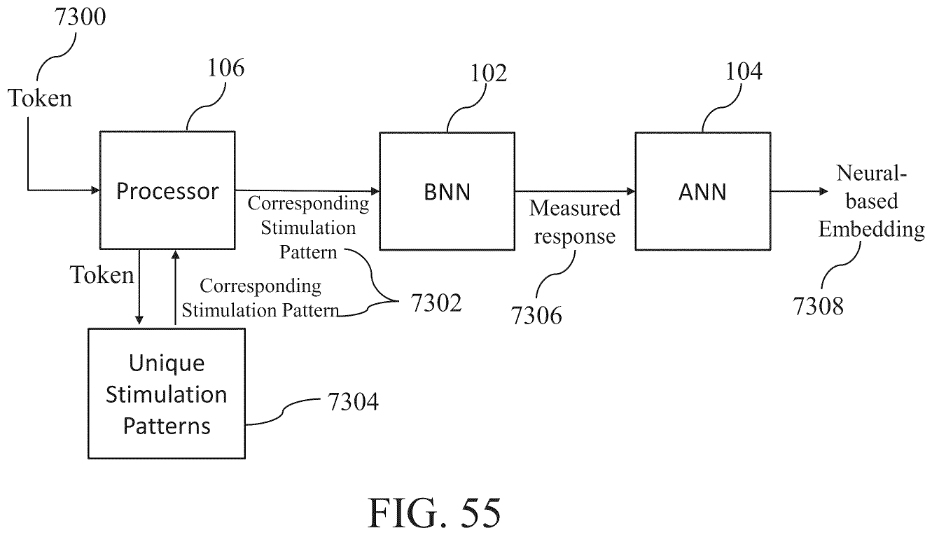

FIG. 55 illustrates a schematic diagram illustrating an example workflow for creating a dictionary of neural-based embeddings using a biological and artificial neural network system, according to some embodiments of the technology described herein. To create a dictionary of neural-based embeddings, a neural-based embedding is created for each token of a plurality of tokens using a BANN system. As described herein, the dictionary of neural-based embeddings may be used to perform a task using an ANN, such as an LLM.

As shown in FIG. 55, a token 7300, which may be a first token of a plurality of tokens, is input to a processor 106. The processor assigns a unique stimulation pattern to the token. For example, a stimulation pattern for the token may be selected from a plurality of unique stimulation patterns 7304. The plurality of unique stimulation patterns 7304 may be stored in a memory accessible to the processor. Techniques for obtaining the plurality of unique stimulation patterns are described herein, for example with reference to subsection (b) herein, discussing identifying unique stimulation patterns.

The selected stimulation pattern is a corresponding stimulation pattern 7302 for the token. For example, in some embodiments, the assignment may be random, while in other embodiments the corresponding stimulation pattern 7302 may be selected based on an existing correspondence of the stimulation pattern to the token prior to assigning the corresponding stimulation pattern 7302 to the token 7300. The stimulation pattern may be considered unique in that it provokes a neuronal response from the BNN that is unique among neuronal responses provoked by others of the plurality of stimulation patterns.

The corresponding stimulation 7302 for the token is then applied to the BNN by stimulating the BNN in accordance with the corresponding stimulation pattern 7302 for the token 7300. Applying the stimulation pattern to the BNN comprises operating one or more electrodes of the MEA to apply electrical signals to the plurality of cells of the BNN in accordance with the stimulation pattern (e.g., according to the timing, location, and characteristics of the electrical signals defined by the stimulation pattern). Further aspects of applying the stimulation pattern to the BNN applicable to the method of FIG. 55 are described herein, for example, with respect to the workflow in FIG. 7A.

A response of the BNN 102 to the application of the corresponding stimulation pattern 7302 is measured to obtain a measured response 7306. The response of the BNN, and in particular the response of the plurality of cells, is measured. Specifically, the cells output electrical signals, called extracellular membrane potentials, which can be recorded by one or more electrodes of the MEA as voltage values. In some embodiments, the measured response may include measurements of calcium transients in the cellular response to the stimulation pattern. The one or more electrodes of the MEA which record the response the response of the BNN to the stimulation may be different, the same, or partially the same as the electrodes which perform the stimulation. BNN activity can also be measured by visualizing Calcium (Ca2+) transients.

The measured response may comprise one or more measurements, such as one or more voltage measurements and/or calcium transient measurements, of the electrical signals generated by the BNN in response to the stimulation. In some embodiments, measuring the BNN response may comprise deriving one or more features from the response of the BNN to the stimulation, examples of which are described herein. Further aspects of measuring the response of the BNN applicable to the method of FIG. 55 are described herein, for example, with respect to the workflow in FIG. 7A.

The measured response 7306 is processed with an ANN 104 to obtain a neural-based embedding 7308 for the token 7300. Further aspects of processing the measured response of the BNN with an ANN applicable to the method of FIG. 55 are described herein, for example, with respect to the workflow in FIG. 7A as well as FIGS. 41-42. For example, the processing of the measured response may be performed in accordance with the method 6100, whereby multiple features are derived from the measured response and processed with an ANN, such as ANN 5904 shown in FIGS. 41-42. In this way, measured responses of the BNN may be processed by an ANN (e.g., having a structure of independent branches and a common branch bringing the processing of the independent branches together through a set of common layers) to generate a neural embedding of a token (e.g., a word), the neural embedding representing the measured response of the BNN to being stimulated with a stimulation pattern for the token (and identified for that token using the techniques described in the following section called “Identifying Unique Stimulation Patterns).

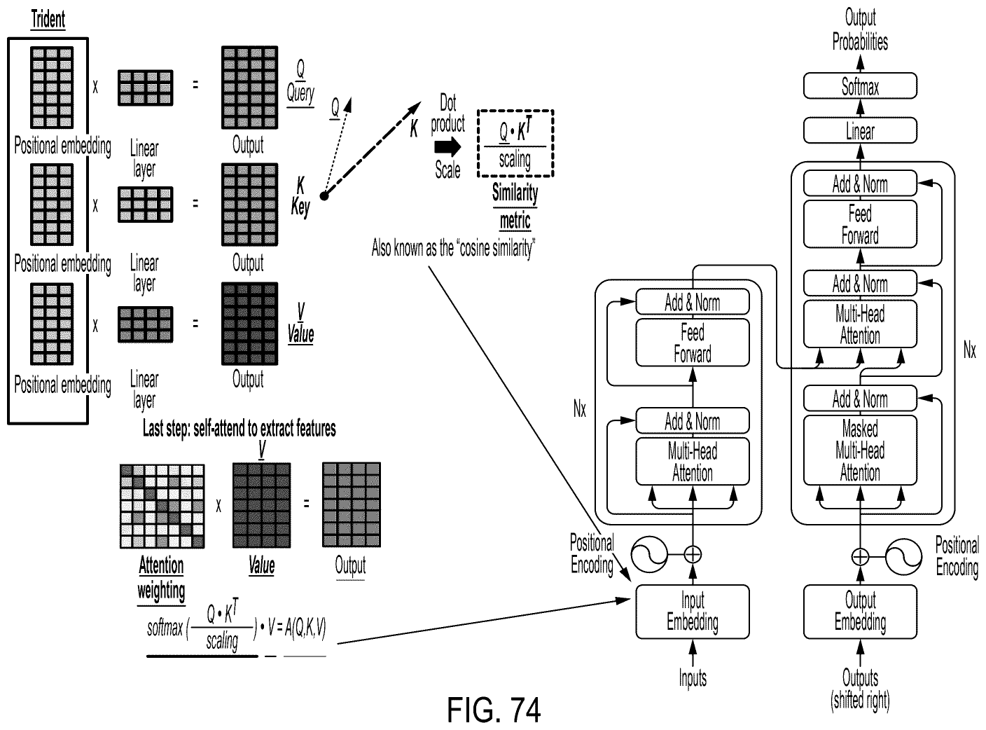

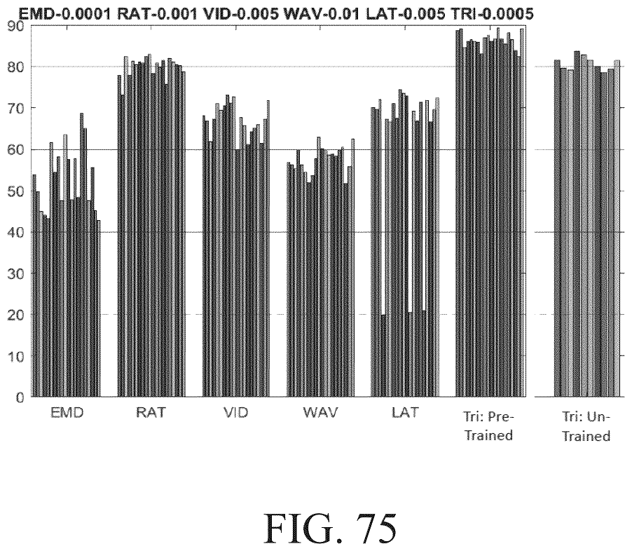

The process shown in the workflow of FIG. 55 may be repeated for each token of the plurality of tokens to obtain a dictionary of neural-based embeddings for the corpus of tokens. The dictionary of neural-based embeddings may be used for subsequent processing, for example, in the context of an LLM. For example, the dictionary of neural-based embeddings may be used to facilitate training an LLM more quickly by setting the embeddings (e.g., input embedding of a transformer-based LLM shown in FIG. 74) with the neural embeddings in the dictionary instead of random initialization or initialization using other models (e.g., word2vec, transfer learning embedding layers from other models such as Llama 3, etc.).

b. Identifying Unique Stimulation Patterns

As described herein, aspects of the technology provided herein include techniques for creating and identifying unique stimulation patterns. In some embodiments, the number of electrodes used per pattern may be determined by how large of a corpus of tokens it is desired to stimulate. Each token in the corpus of tokens is assigned a unique stimulation pattern.

A plurality of stimulation patterns may be created where each independent stimulation pattern generates a unique (e.g., distinguishable) neuronal response. For example, in some embodiments, an ANN may be used to generate the plurality of distinguishable stimulation patterns. In some embodiments, the ANN is an LSTM model. The ANN may be trained on all candidate stimulation patterns and may identify how distinguishable the respective stimulation patterns are. The input to the ANN may be the cellular (e.g., neuronal) response to a stimulation pattern. The neuronal response may be reflected by a series of frames of spike rates and/or patterns.

In one example, the selection of combinations of electrodes used to stimulate tokens (e.g., selection of the stimulation pattern) is performed in the following way. In a dedicated recording, every electrode on the MEA is stimulated 10 times. After one electrode is stimulated, another randomly picked electrode is stimulated until all electrodes on the MEA have been stimulated. In the same fashion, all MEA electrodes are stimulated again. This is repeated 10 times. In the 5-30 ms following each single-electrode stimulation, the number of spikes from all electrodes is counted. The number of spikes a single electrode evokes is averaged across the 10 repetitions. ‘Most active’ electrodes are identified by ordering the electrodes that evoke the highest spike counts to electrodes that evoke the lowest spike counts. In a second step, the 64×64 electrode array is divided into 16 equal 16×16 quadrants. N ‘most active’ electrodes are chosen from each of the 16 quadrants. Four random groups of 4 quadrants were made. Within each quadrant grouping, single electrodes were selected from the N electrodes. All recombinations of the N electrodes are made, with each recombination selecting 1 electrode from each of the 4 quadrants. This yields N\hat{ }4 unique combinations of 4 electrodes, a N row by 4 column matrix. This process is repeated for each of the 4 groupings of 4 quadrants. The resulting 4 lists (N\hat{ }4) recombinations x 4 electrodes, each of the 4 lists coming from a unique grouping of the 4 quadrants, were concatenated along dimension 2 yielding a single list of N\hat{ }4 rows and 16 columns. The 16 electrodes in a single entry of the list are the electrodes used for a single token/class. Combining the 4 electrodes from the 4 quadrant-grouping-lists into a vector of 16 electrodes ensures that each stimulation (representing a token/class) contains combination of 4 electrodes that is unique to that stimulation. The goal is to derive a neural response where the stimulation uniqueness is not dependent on a single electrode (as would be the case if all 16 quadrants were recombined in a programmatic loop with 16 nested for-loops), but rather dependent on 4 unique combinations. The goal of having 4 unique electrode recombinations per token/class is to enhance variability on the neuronal response and subsequent ANN classification. The order of the rows in the list of 16 electrodes are randomized and used to stimulate the MEA.

There are 123 different ways to turn the neural response into vector representations of a token/class (a single MEA stimulation using 16 electrode) for ANN input. Three involve measuring the raw spike response and the remaining 120 involve training a network, such as the ANN 5904, with all permutations of 1 to 5 data-heads and using the final linear layer (the layer before classification), which has a 100-800 1-dimensional shape, as the vector representation of the token/class.

In the illustrated example, there are three raw data extractions (although any number of raw data extractions may be used, in other embodiments), which are also the input to 3 of the 5 data heads of the ANN 5904 (shown in FIG. 44), are rates, latency, and average latency. An example is provided herein for using rates, but the method subsequently described for rates can be applied to the other 2 raw data extractions. The vector of 4096 rates from the 4096 electrodes is reduced to a 100-800 dimensional vector for word2vec or transformer initial word embedding. Dimensionality reduction may be performed in two ways. One way is to perform a principal component analysis (PCA) on the 4096 (electrodes)* #tokens (stimulations) matrix. The loadings of each token onto the 100-800 PC's that explain the most variance become the vector representation for a token. The other dimensionality reduction technique uses the 100-800 1) electrodes with the largest dynamic range across tokens/stimulations and 2) electrodes that are maximally decorrelated from each other. Picking electrodes that evoke signals with these two characteristics is an optimal way to provide maximal information derived from the analogue recurrent processing of the biological neural network to the artificial architecture of digital silicon networks.

The 100-800 dimensional vectors derived from the biological network, which have 123 methods of extraction and two methods for dimensionality reduction, become the initial vectors for training a word2vec or nanoGPT model. The biological vectors replace the random initialization of a word embedding. The biological vectors can either be randomly assigned to a token, or strategically mapped to a token. The method for mapping biological vectors to an ANN token is described herein.

An example of two stimulation patterns include stimulating different constellations of 16 electrodes. The following are two lists of 16 stimulation electrodes derived as described herein: [64, 3975, 3919, 1987, 3275, 581, 1726, 3745, 3239, 3922, 2680, 146, 3468, 3814, 2771, 3093] and [3044, 1607, 2684, 701, 2890, 131, 1133, 189, 398, 3366, 2840, 1296, 3881, 141, 1791, 1558].

Each electrode in the two examples herein were stimulated with these example currents: 20 μA positive current for 120 μs immediately followed by 20 μA negative current for 120 μs. Variants of these examples include, for example: stimulating all electrodes at 5-40 μA, stimulating the 16 electrodes in a temporal sequence with 1-10 ms between stimulations, and using more or less electrodes.

As described herein, aspects of the technology provided herein include techniques for associating a token with a corresponding stimulation pattern. In some embodiments, the tokens may be randomly assigned a corresponding stimulation pattern. In other embodiments, assigning a corresponding stimulation pattern for a token may be based on an existing correlation between the token and the stimulation pattern. For example, in some embodiments, a distance matrix may be generated representing relationships between the tokens. Where the tokens comprise words, the distance matrix may be a word-to-word distance matrix. The word-to-word distance matrix may be generated using a technique such as word2vec, one hot encoding, bag of words, or the like. The word-to-word distance matrix illustrates cosine similarity between word vectors.

A neuro-to-neuro distance matrix identifying relationships (e.g., distances) between cellular (e.g., neuronal) responses evoked from application of a particular stimulation pattern. The neuro-to-neuro distance matrix may be based on spike counts of the neuronal responses evoked by the plurality of unique stimulation patterns. In other embodiments, one or more other features of the neuronal response may additionally or alternatively be used to generate the neuro-to-neuro distance matrix. The corresponding stimulation patterns for each token may be selected such that the distance matrix for the plurality of tokens aligns with the neuro-to-neuro distance matrix for neuronal responses evoked by the stimulation patterns. That is, word vectors that have a particular cosine similarity between them may be mapped to neuronal vectors that have the same or similar cosine similarity between them.

As an example, when neuronal vectors are mapped to word vectors, rather than randomly assigning neuronal vectors to word labels, the following process may be used. First, a word2vec model may be trained using random initializations for the word embeddings. Then, the cosine similarity between all trained word embeddings may be computed. Similarly, the cosine similarity between all neuro-embeddings with dimensionality corresponding to the trained word embeddings may be computed. In some embodiments, a distance metric other than cosine similarity can be used. Using the Gromov-Wasserstein distance between the neuro and word embeddings, the bipartite matching between vectors can be identified. For example, the bipartite matching can be found using equations 8 and 9 detailed in Alvarez-Melis and Jaakkola 2018 paper, toolbox: Python Optimal Transport (POT), which is hereby incorporated by reference in its entirety. The implementation may be in Python.

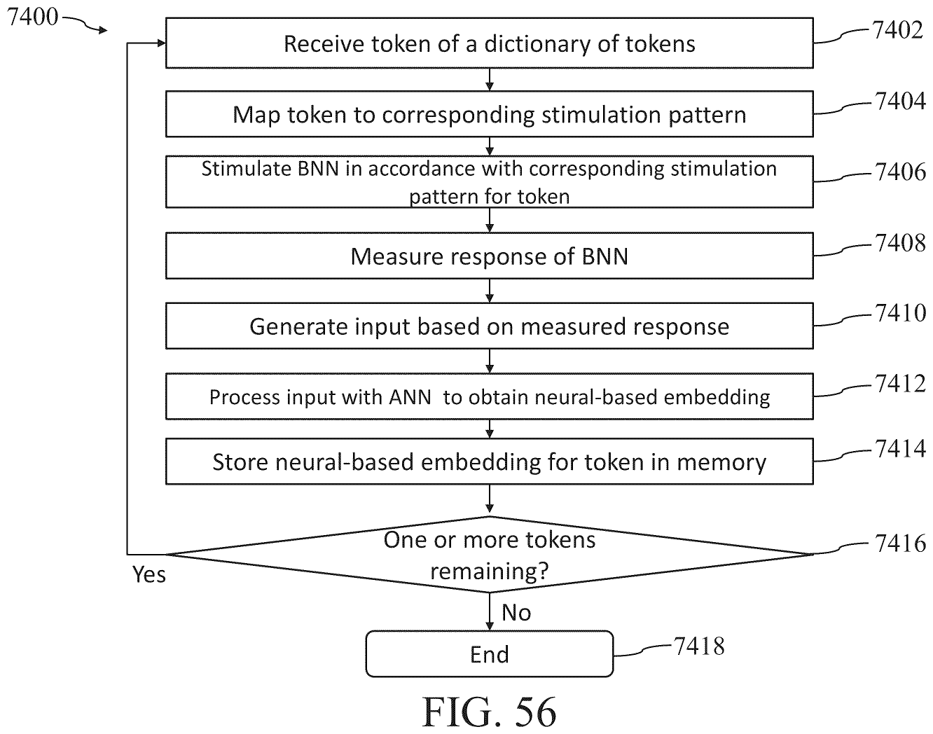

FIG. 56 illustrates an example method for creating a dictionary of neural-based embeddings using a biological and artificial neural network system, according to some embodiments of the technology described herein. The example method 7400 shown in FIG. 56 may be implemented by a BANN system comprising an MEA, a BNN comprising a plurality of cells (e.g., neurons) arranged on the MEA, an ANN trained to process multiple features derived from at least one response of the BNN to a stimulation pattern, and at least one processor.

The example method 7400 may follow the workflow shown in FIG. 55. For example, the method 7400 may begin at act 7402 where a token of a dictionary of tokens is received. In some embodiments, the token may be a word of a dictionary of words. In other embodiments, the token may be an input signal other than a word, for example, any of the input signals described herein.

At act 7404, the token is mapped to a corresponding stimulation pattern. As described herein, mapping the corresponding stimulation pattern to the token may be performed randomly in some embodiments, or may be based on a correlation between the stimulation pattern and the token. The corresponding stimulation pattern may be one of a plurality of unique stimulation patterns.

At act 7406, the BNN is stimulated by using the MEA to generate electrical signals in accordance with the corresponding stimulation pattern for the token. Applying the stimulation pattern to the BNN comprises operating one or more electrodes of the MEA to apply electrical signals to the plurality of cells of the BNN in accordance with the stimulation pattern (e.g., according to the timing, location, and characteristics of the electrical signals defined by the stimulation pattern). Further aspects of applying the stimulation pattern to the BNN applicable to the method of FIG. 56 are described herein, for example, with respect to the workflow in FIG. 7A.

In some embodiments, the method comprises preconditioning the BNN using at least some of the tokens of the dictionary of tokens prior to performing the stimulating at act 7406. The inventors have recognized that performing the preconditioning of the BNN prior to performing the stimulating may increase efficiency of the BNN.

At act 7408, a response of the BNN responsive to the stimulating with the corresponding stimulation pattern for the token may be measured. The response of the BNN, and in particular the response of the plurality of cells, is measured. Specifically, the cells output electrical signals, called extracellular voltages, which can be recorded by one or more electrodes of the MEA as voltage values. The one or more electrodes of the MEA which record the response the response of the BNN to the stimulation may be different, the same, or partially the same as the electrodes which perform the stimulation. BNN activity can also be measured by visualizing Calcium (Ca2+) transients. The measured response may comprise one or more measurements, such as one or more voltage measurements, of the electrical signals and/or calcium transient measurements generated by the BNN in response to the stimulation. Further aspects measuring a response of the BNN responsive to the stimulating applicable to the method of FIG. 56 are described herein, for example, with respect to the workflow in FIG. 7A.

At act 7410, an input is generated based on the measured response obtained at act 7408. In some embodiments, generating the input comprises processing the measured response. For example, generating the input may comprise deriving one or more features of the cellular (e.g., neuronal) response, examples of which are provided herein. In some embodiments, generating the input comprises passing the input to the ANN without processing the measured response. Further aspects generating an input based on the measured response applicable to the method of FIG. 56 are described herein, for example, with respect to the workflow in FIG. 7A and FIGS. 41-42.

At act 7412, the input generated at act 7410 may be processed with an ANN to obtain a neural-based embedding. For example, the ANN may be of the type described herein configured to process multiple features of a response such that processing the input at act 7412 comprises processing multiple features derived from the at least one response of the BNN with the ANN. For example, the ANN may be ANN 5904 described herein, and the processing of the input may be performed in accordance with the techniques described herein with respect to FIGS. 41-43.

At act 7414, the neural-based embedding for the token generated at act 7412 is stored in memory. At act 7416 it is determined whether one or more tokens of the plurality of tokens remain for which to generate a neural-based embedding. If yes, the method 7400 returns to act 7402 where the method 7400 is repeated for a remaining token. If no, the process proceeds to act 7418 where the process ends.

In some embodiments, the method further comprises generating a plurality of stimulation patterns. The generating the plurality of stimulation patterns may be performed in accordance with the techniques described herein. The plurality stimulation patterns generated may be selected from at act 7404 when the token is mapped to a corresponding stimulation pattern. In some embodiments, generating the plurality of stimulation patterns is performed using an ANN.

In some embodiments, the method further comprises identifying a plurality of unique stimulation patterns. Identifying the plurality of unique stimulation patterns may be performed in accordance with the techniques described herein. The plurality of unique stimulation patterns may be distinguishable from each other. For example, each of the plurality of unique stimulation patterns may evoke a unique cellular (e.g., neuronal) response from the BNN when the BNN is stimulated in accordance to the stimulation pattern. The method may further comprise determining a correspondence between each token of the dictionary of tokens and a respective one of the plurality of unique stimulation patterns to determine the correspond stimulation pattern for each token. Determining the correspondence between each token of the dictionary of tokens and the respective one of the plurality of unique stimulation patterns may comprise using word2vec, or similar technique, to determine the correspondence between each token of the dictionary of tokens and the respective one of the plurality of unique stimulation patterns.

As described herein, the dictionary of neural-based embeddings created according to the method 7400 may be used to perform one or more tasks. For example, in some embodiments the method comprises performing one or more tasks using a second ANN that incorporates the dictionary of neural-based embeddings created according to the method 7400.

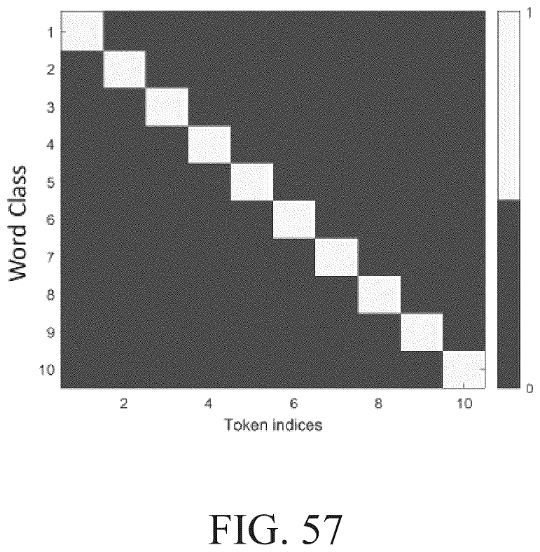

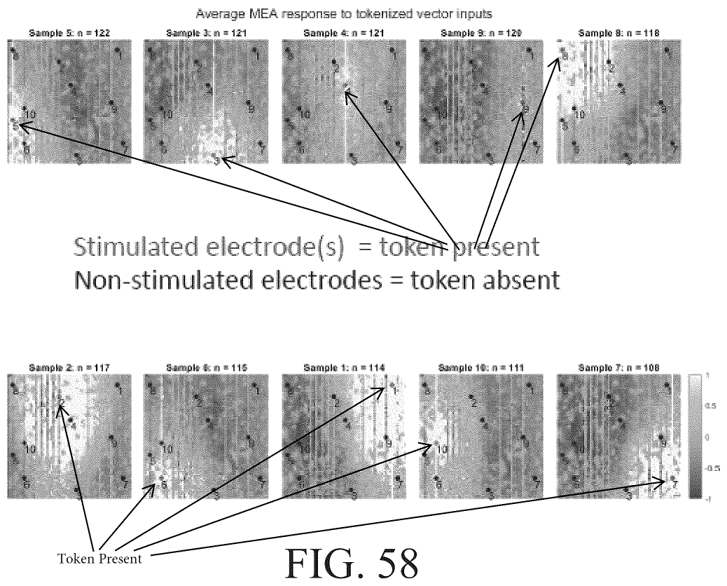

FIG. 57 illustrates a graph depicting a mapping of tokens to stimulation patterns, according to some embodiments of the technology described herein. In particular, FIG. 57 illustrates a mapping of one-hot encoded tokens (more specifically, words) to active electrodes. Stimulating through these electrodes produces reproducible spatial activation patterns on the MEA. FIG. 58 illustrates images showing average electrode response to tokenized vector inputs, according to some embodiments of the technology described herein.

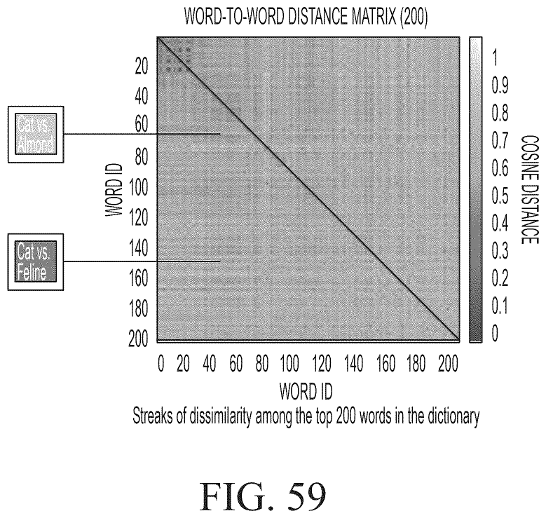

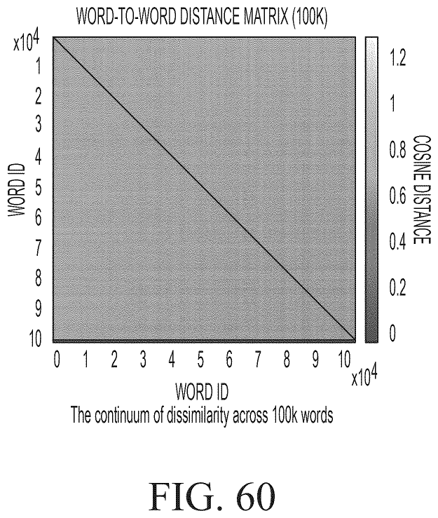

FIG. 59 illustrates an example matrix of word-to-word distances, according to some embodiments of the technology described herein. As described herein, the matrix of word-to-word distances may be used to assign corresponding stimulation patterns to tokens. The word-to-word distance matrix of FIG. 59 characterizes complex inter-relationships among words. FIG. 60 illustrates another example matrix of word-to-word distances, according to some embodiments of the technology described herein. The matrix of FIG. 60 illustrates a continuum of dissimilarity across 100,000 words.

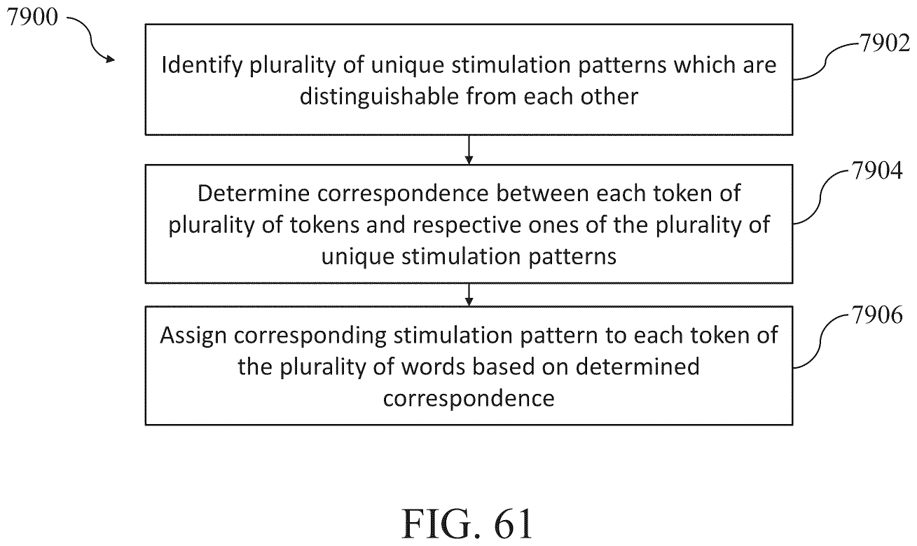

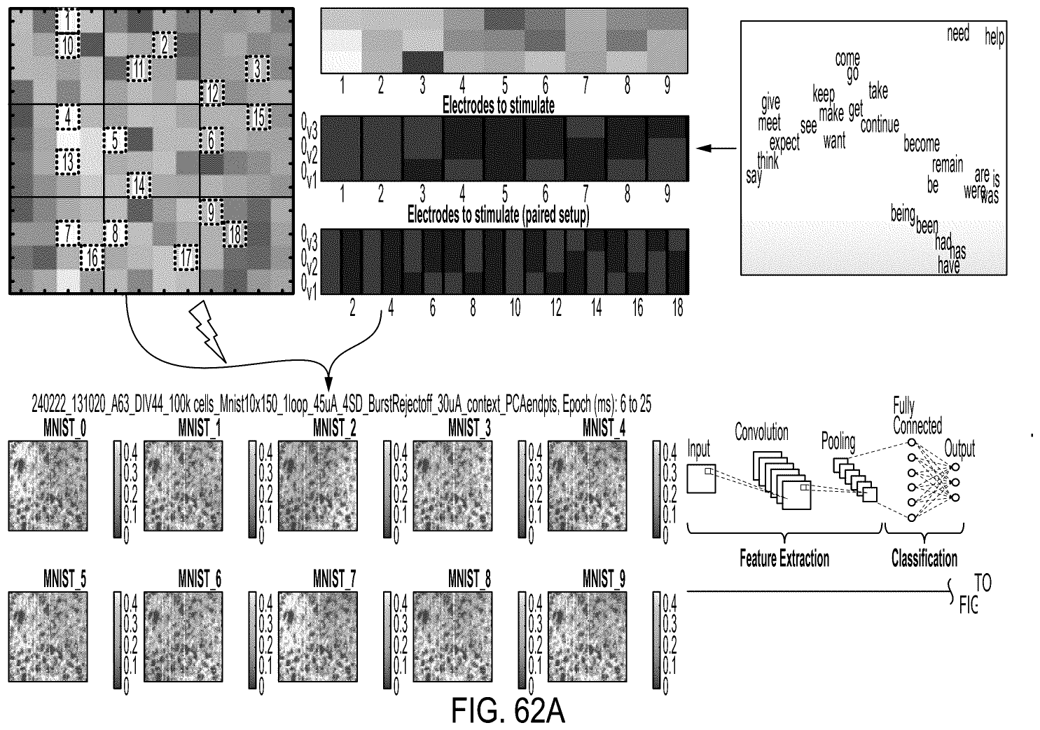

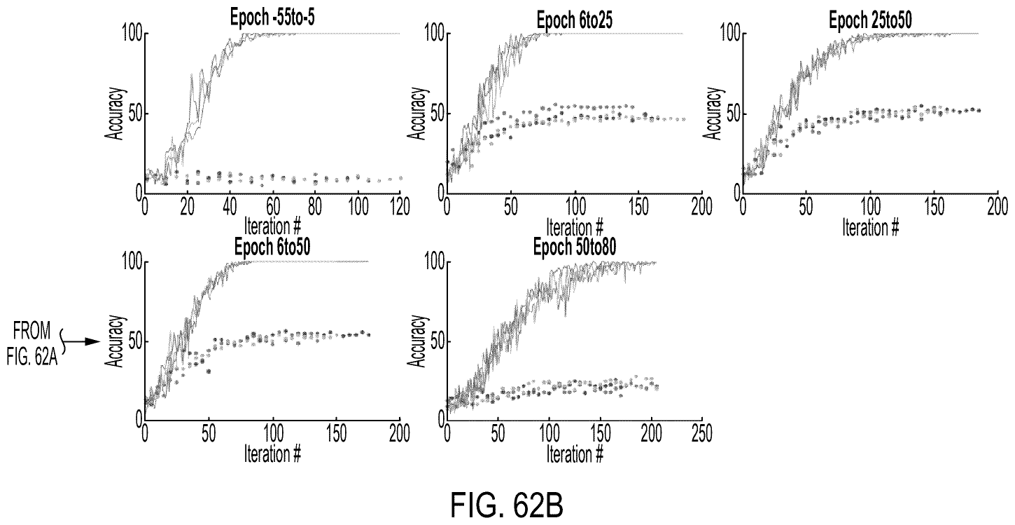

FIG. 61 illustrates an example method 7900 for assigning stimulation patterns to tokens, according to some embodiments of the technology described herein. The example method 7900 begins at act 7902 where a plurality of unique stimulation patterns which are distinguishable from each other are identified. The plurality of unique stimulation patterns being distinguishable from each other may indicate that neuronal responses evoked by the BNN in response to stimulation according to the stimulation patterns are distinguishable from each other. As described herein, identifying the plurality of unique stimulation patterns may be performed using an ANN (e.g., an LSTM).

At act 7904, a correspondence between each token of a plurality of tokens and respective ones of the plurality of unique stimulation patterns is determined. For example, the correspondence may be based on relationships between neuronal responses evoked by the stimulation patterns (e.g., measured by spike rates) and corresponding relationships between tokens. Determining the correspondence between each token and respective one of the plurality of unique stimulation patterns may be performed according to the techniques described herein.

At act 7906, each token is assigned a corresponding stimulation pattern based on the determined correspondence at act 7904. Each token of the plurality of tokens is assigned a respective one of the plurality of unique stimulation patterns. By assigning a stimulation pattern to a token, when a token is input to a BNN system, the BNN is stimulated in accordance with the stimulation pattern corresponding to the input token. Assigning each token to a corresponding stimulation pattern may be performed in accordance with the techniques described herein.

FIGS. 62A-62B illustrate aspects of generating stimulation patterns for a biological neural network, according to some embodiments of the technology described herein. FIGS. 62A-62B illustrate aspects of feature extraction to build stimulation patterns. FIGS. 62A-62B further illustrate encoding of information into the BNN. The encoding occurs at biologically active sites where stimulation (data input) triggers network activity. These are identified by sampling a subset (grid) of electrodes across the full MEA (top left of FIG. 62A). FIGS. 62A-62B further illustrate an embedding representation of raw data. FIGS. 62A-62B illustrate stimulation according to a mapping between embedding dimension and electrodes, including stimulating at a particular current, amplitude, and time. FIGS. 62A-62B illustrate decoding (readout) from the BNN to train and test a classifier.

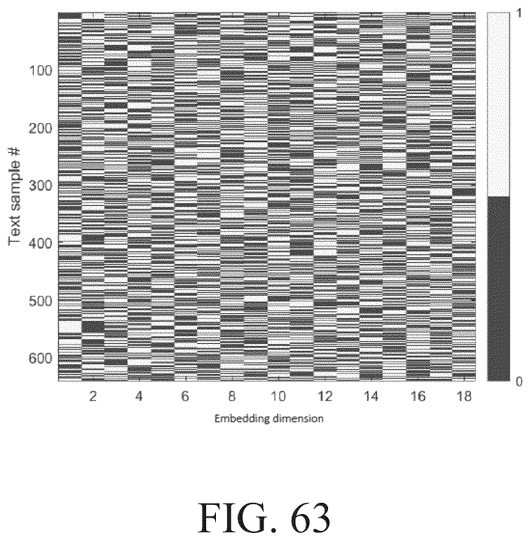

FIG. 63 illustrates an example look-up table of embeddings for text inputs, according to some embodiments of the technology described herein. FIG. 63 illustrates stimulation patterns from embedding vectors. Features of embeddings can be thresholded to generate a look-up table of electrodes to stimulate on. This may be performed by tokenizing input, extracting an initial sample embedding of a chosen dimensionality, and thresholding embedding vectors to generate a binary pattern for on/off stimulation.

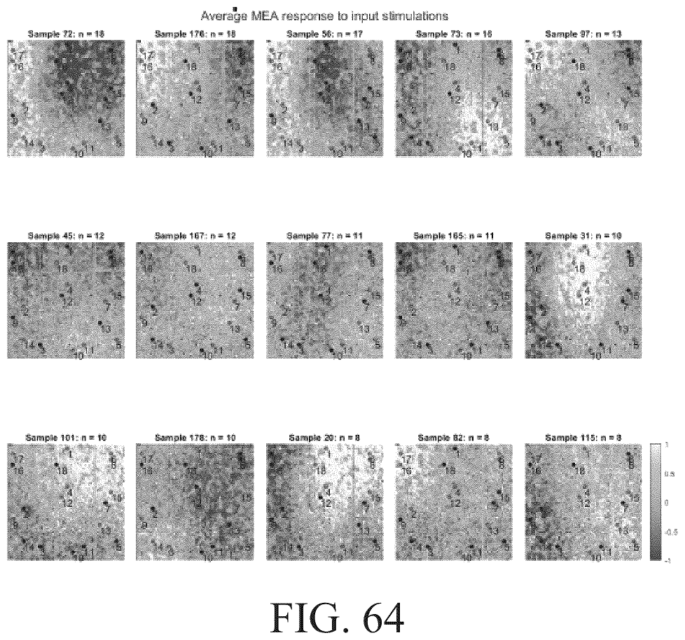

FIG. 64 illustrates example images of a response of a biological neural network to stimulation patterns, according to some embodiments of the technology described herein. For the results shown in FIG. 64, a process may be performed including the following aspects. Embedding dimensions are assigned to chosen active electrodes with good neuron coverage. A binary pattern is stimulated on each trial. A spike rate response to stimulation is extracted across the 64×64 MEA. Responses to different input stimuli show complex and distinguishable patterns. The stimulation may be fine-tuned to characteristics and response properties of the MEA to produce more robust responses and allow for more propagation of network activity. Embeddings of network stimuli can be mapped to “good” (e.g., most active) stimulation electrodes in the MEA to maximize information content being passed on.

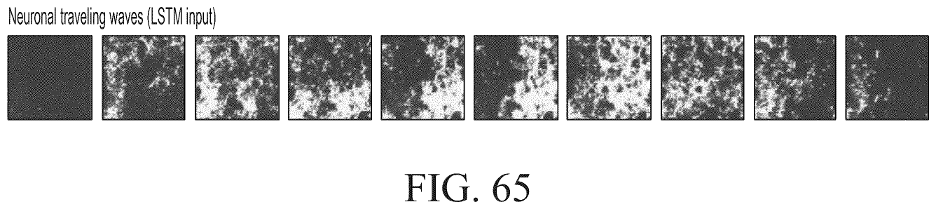

FIG. 65 illustrates aspects of a process for generating unique stimulation patterns for a biological neural network, according to some embodiments of the technology described herein. Cellular (e.g., neuronal) responses may be projected to embedding subspace. Stimulation patterns illicit neuronal traveling waves which is a dynamic and distributed population response with high intrinsic dimensionality. FIG. 65 illustrates the neuronal traveling waves. Neuronal traveling waves are projected into an optimal subspace using a deep-LSTM

network. Deep-LSTM networks successfully separate neuronal responses to 1,000 unique patterns with greater than 99% accuracy and minimal training examples. Novel words are projected to the embedding subspace (embedding dimension N) based on the activation of the penultimate layer of the network. The trained neuronal embedding vector of length N has an intrinsic dimensionality much greater than N due to the biological underpinnings of the embedding. The neuro-embedding is product 1.

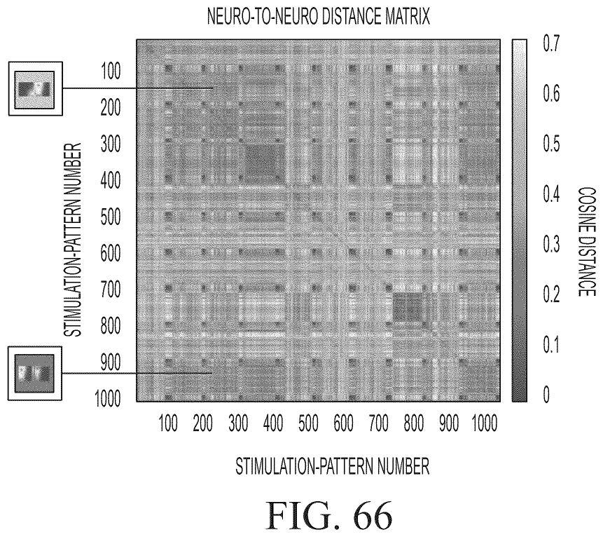

FIG. 66 illustrates an example matrix of distance between neuronal responses to different stimulation patterns, according to some embodiments of the technology described herein. To obtain the matrix shown in FIG. 66, neuro-to-neuro distance distributions across stimulation responses are calculated. Neuronal responses to two different stimulation patterns can be highly similar, different, or somewhere in between depending on the complex interaction of the underlying BNN. The complex inter-relationship among neuronal responses are characterized in the neuro-to-neuro distance matrix shown in FIG. 66. Sub-space projection as well as distance metric calculation affect the observed distributions. As described herein, signature neuro-to-neuro distance distributions are optimally mapped to analogous word-to-word distance distributions to create a dictionary of word-to-word neural embeddings.

c. Use of Dictionary of Neural-Based Embeddings

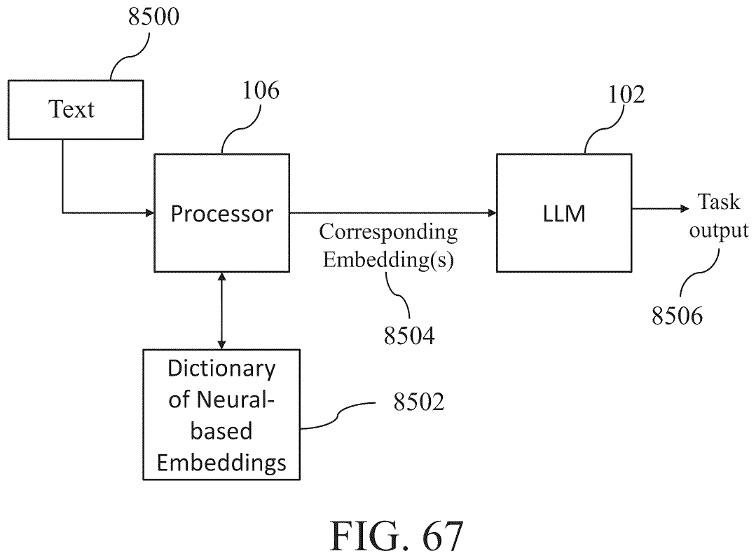

As described herein, a dictionary of neural-based embeddings generated using a BNN may be used to perform a task. For example, the dictionary of neural-based embeddings may be used to initialize an ANN (e.g., a transformer). FIG. 67 illustrates a schematic diagram illustrating an example workflow for performing a task using a dictionary of neural-based embeddings, according to some embodiments of the technology described herein.

As shown in FIG. 67, text 8500 (or, in other embodiments, another token) is input to the processor 106. For example, the input may be any of the input signals described herein (e.g., one-dimensional, two-dimensional, three-dimensional, or four-dimensional data). The processor 106 retrieves a neural-based embedding 8504 from a dictionary of neural-based embeddings 8502 corresponding to each word in the text. The dictionary of neural-based embeddings may be obtained using a BANN system, for example, according to the techniques described herein (e.g., method 7400).

The corresponding embedding 8504 for each word in the text 8500 is input to an ANN (e.g., an LLM 102) to obtain a task output 8506. As described herein, the input may be text 8500 and the corresponding embedding 8504 may be input to an LLM 102. However, in other embodiments, the input may be a token other than text and/or the corresponding embedding 8504 may be input to an ANN other than an LLM.

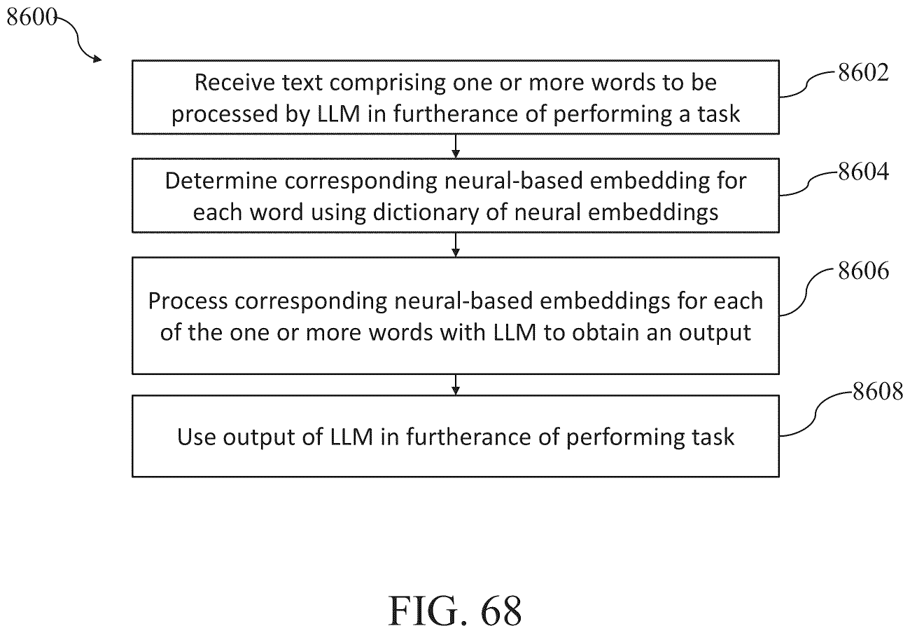

FIG. 68 illustrates an example method for performing a task using a dictionary of neural-based embeddings, according to some embodiments of the technology described herein. The example method 8600 of FIG. 68 may be performed using a system comprising an LLM and at least one processor.

The method 8600 may follow the workflow shown in FIG. 67. For example, the method 8600 may begin at act 8602 where text comprising one or more words to be processed by an LLM in furtherance of performing a task (e.g., generating a response (e.g., a textual response), making a prediction or classification, extracting information, creating a summary, identifying a topic, predicting masked words within sentences, identifying sentences originating from the same document, etc.) is received. For example, the text may be natural language text, for example, text that can be provided by a user interacting with an LLM part of a chatbot. As another example, the text include computer code. Though text is not limited to natural language text or computer code and, additionally or alternatively, may include any other suitable types of alphanumeric and/or symbolic strings (e.g., strings representing biological sequences such as nucleic acids or proteins).

At act 8604, a corresponding neural-based embedding for each word in the text is determined using a dictionary of neural-based embeddings. The dictionary of neural-based embeddings may have been generated using a BNN prior to the performance of process 8600. For example, the dictionary of neural-based embeddings may be generated by using the example method 7400 prior to commencing execution of process 8600, in some embodiments. In other embodiments, the dictionary of neural-based embeddings may be generated as part of process 8600, as aspects of the technology described herein are not limited in this respect.

At act 8606, the corresponding neural-based embedding for each word of the one or more words determined at 8604 is processed with an LLM to obtain an output. For example, the determined neural-based embedding may be a vector that is a numerical representation of the input. The determined neural-based embedding may be input to the LLM for processing. In some embodiments, the LLM may be trained using the dictionary of neural-based embeddings.

At act 8606, the output obtained from the LLM as a result of the processing at act 8606 is used in furtherance of performing a task. For example, the output may be a response of the LLM to the task. The output may be a digital signal comprising a task output that is a response to the requested task. For example, the output may be a response to input text, a summarization of input text, an indication of text to be provided for missing words/characters/symbols in an input text, an identification of a topic for a task, a classification of an input text as being of a particular type, etc. As one example, where the task is a prediction task and the input signal comprises text comprising one or more words, the output may be a prediction of one or more words to complete and/or respond to the input text.

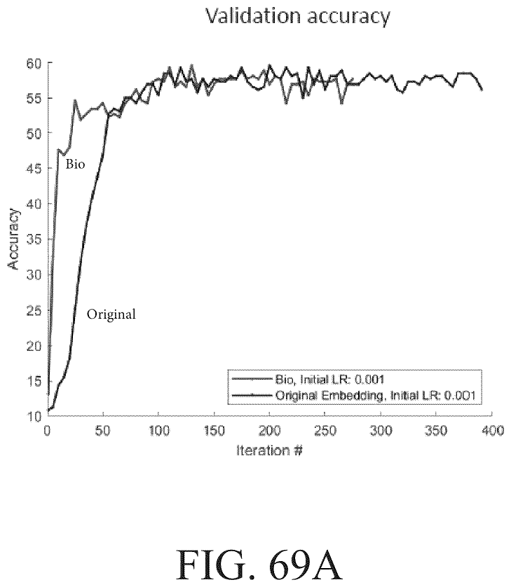

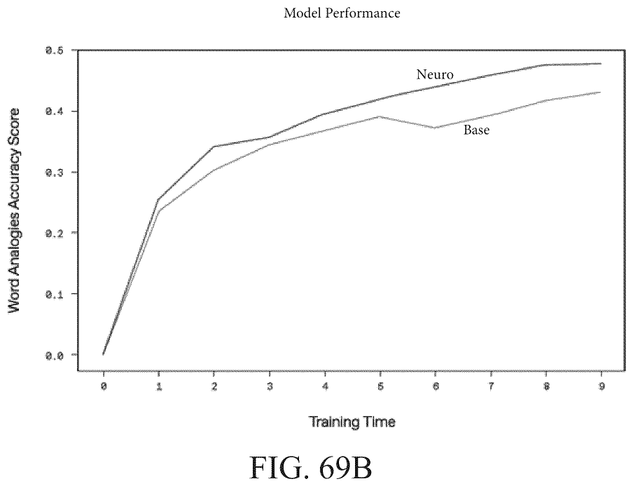

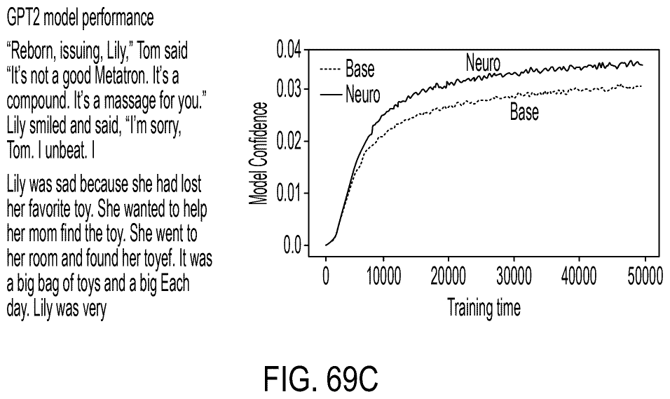

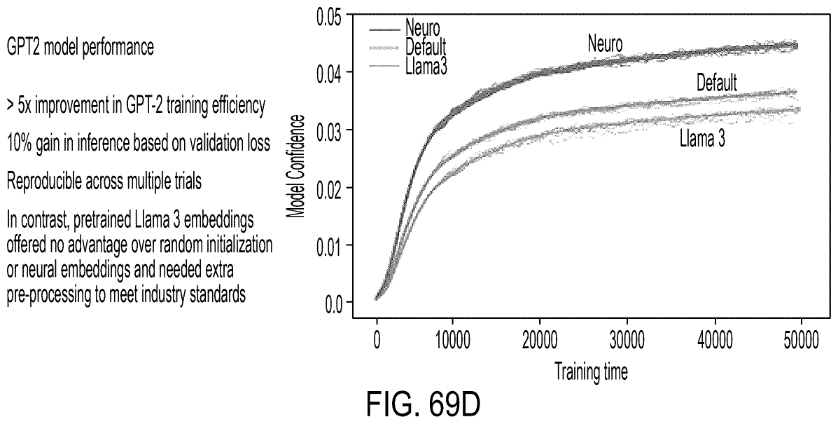

FIGS. 69A-D illustrate example graphs depicting accuracy and efficiency of a biological and artificial neural network system at performing a word classification task, according to some embodiments of the technology described herein. FIG. 69B shows that an LLM, when initialized with the Bio-LLM embedding layer, achieves better accuracy than the same model initialized using the standard method. The model achieves better accuracy than small language models with 3× less training time and 3× cost savings. For the example of FIGS. 69A-D, the ANN used is an LLM, encoding is performed via use of neural-based embeddings and temporal stimulation, and decoding the neuronal response is performed using spike rates, spike patterns, and/or sequences of frames (e.g., movies) of the neuronal response.

Although examples are provided herein where the input signal comprise text, it should be appreciated that the technique described herein may be extended to embodiments where a different input signal other than text may be received. For example, ANNs, including chatbots, to which the input signal may be provided include ANNs that operate on input image data, text data, acoustic data, and other types of data, and many such models embed this data prior to processing the data.

The input signal is a signal that is to be processed by the BNN in furtherance of performing a task. The input signal can be any suitable type of input signal. For example, the input signal may comprise one-dimensional, two-dimensional, three-dimensional, or four-dimensional data. For example, the input signal may comprise time series data, in some embodiments. As an example, the input signal may comprise values that vary over time, such as stock market values over a selected time period. In some embodiments, the input signal comprises acoustic data. In some embodiments, the input signal comprises one or more images (e.g., one or more monochrome images, one or more color images). In some embodiments, the input signal comprises one or more videos (e.g., multiple frames of images in a sequence). In some embodiments, the input signal comprises natural language text, numerals, and/or alphanumeric signals. The input signal is typically provided in digital form to the processor. In some embodiments, the input signal may comprise multiple input signals. Further aspects of receiving an input signal applicable to the method of FIG. 68 are described herein, for example, with respect to the workflow in FIG. 7A.

FIG. 69A illustrates accuracy of BANN and ANN on word classification. For this example, spike rates only are used for classification (e.g., the measured response of the BNN which is used to perform the classification task comprises spike rates). The process includes training ANNs to classify input labels and comparing ANNs trained on MEA spike rate responses to classification of original input stimulation patterns. Input information is extractable from high-dimensional MEA response. The results show that using the BANN system classifies words more accurately than ANN alone. The results further show that use of the BANN is more efficient than an ANN alone as use of the BANN system requires fewer iterations of training to reach an acceptable accuracy of classification.

FIG. 69B illustrates a comparison of the performance two LLMs initialized in different ways. The “Neuro” LLM was initialized using a dictionary of neural-based embeddings. On the other hand, the “Base” model was initialized using a non-neural-based embedding technique (e.g., random initialization). The results show model performance as a metric of word analogies accuracy score relative to training time for a word prediction task. The Neuro model shows improved performance as seen by the word analogies accuracy score which is higher than the score of the Base model (e.g., for the same amount of set training time). In addition, the Neuro model reaches a set accuracy score with less training time as compared to the Base model.

FIG. 69C illustrates a further comparison of Base and Neuro models. FIG. 69C illustrates the model results after initializing the models and training the models of a set number of iterations. The results show that the Neuro model has improved performance over the Base model as demonstrated by the model confidence metric. The model confidence is a metric of extraction perplexity and is a measure of the model's confidence in its own predictions. The performance of the model is improved when the model is more confident is in its prediction of the next word. The accompanying text further illustrates that the output text of the Neuro model (bottom text) is more coherent than the Base model (top text).

FIG. 69D illustrates a comparison of three models, including the Base and Neuro models of FIGS. 69B-C, and a third model initialized using Llama3 embeddings. For each model, a word prediction task was performed 25 times, illustrating that the results of each model are consistent among trials. The results show that the Neuro model has improved model confidence that is reproducible across multiple trials. The Neuro model also reaches a set model confidence in less training time. In contrast, the model initialized with Llama3 embeddings did not show an advantage over random initialization and required additional pre-processing to meet industry standards.

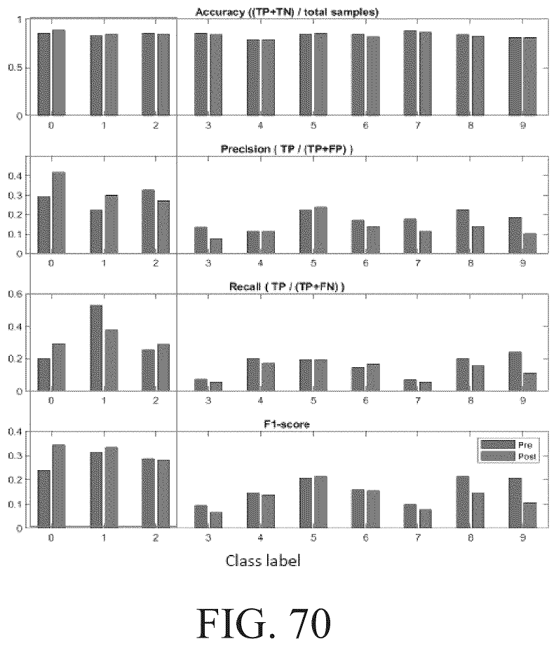

FIG. 70 illustrates example graphs depicting results of training a biological neural network to perform a word classification task, according to some embodiments of the technology described herein. FIG. 70 illustrates results of training a BNN for word classification with closed loop stimulation. For the results of FIG. 70, experiments were re-run with a subset of classes with a trained classifier. For incorrect classifications to presented test inputs, repeated patterns of electrodes are stimulated to induce new patterns of activity. The overall performance of the model on full class set before and after training was evaluated. The results of the trained class subset show improvement in performance of a word classification task after closed-loop training was performed.

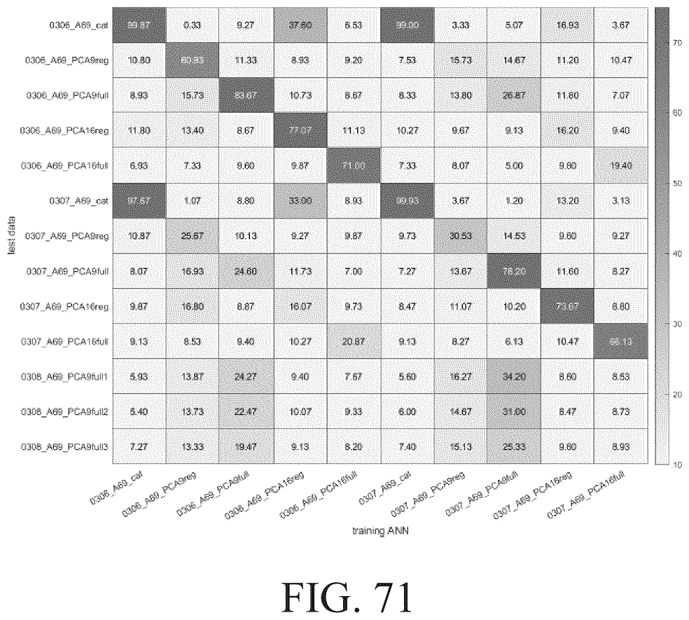

FIG. 71 illustrates an example diagram illustrating performance of a biological neural network at performing a word classification task, according to some embodiments of the technology described herein. FIG. 71 illustrates that the ability of the model to perform word classification stays stable across days. Even over time, the classification accuracy of the BANN system remains high as the BNN does not lose its connectivity over this time.

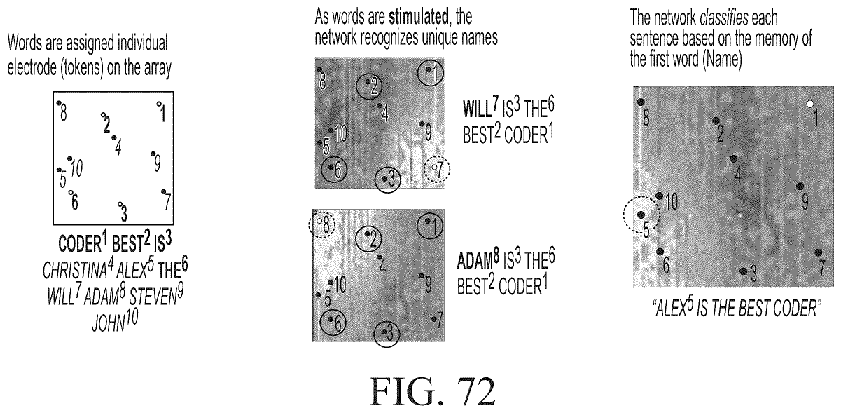

FIG. 72 illustrates an example workflow for using a biological neural network to perform sentence classification, according to some embodiments of the technology described herein. FIG. 72 illustrates an example of using a BANN system to perform 5-word sentence sequence encoding by changing token 1. FIG. 72 illustrates an encoding scheme that maps stimulation tokens to words, integrating BANN technology into large language models. Sentences were classified by altering only the first word. The networks demonstrate the ability to classify sentences by leveraging organic memory. Here, the model is an LLM, encoding of the input data to the BNN is performed using a mapping (e.g., neural-based embedding(s)) and temporal stimulation, and the decoding is performed using spike rates, spike patterns, and/or sequences of frames (e.g., movies).

FIG. 74 illustrates an example architecture of a transformer-based large language model in which the embedding layer is initialized using a dictionary of neural embeddings, according to some embodiments of the technology described herein. The ‘positional embedding’ (left-most matrix labeled trident and enclosed with a box, 7 words long-3 dimensions per word (300 in Word2vec)) is the word2vec (or similar embedding) of a word with the addition of the position of the word in a sentence. This initial embedding (the box ‘Input Embedding’ and ‘output embedding’ in the transformer diagram) can be trained. The neural-embedding is a better starting point to train a word2vec embedding. The output ‘positional embedding’ matrix would then better identify similar/dissimilar words in the ‘similarity metric’ at the upper middle-left of the slide. This leads to more efficient LLM training which provides energy and therefore cost savings.

In some embodiments, the dictionary of neural-based embeddings may be implemented into an LLM having a transformer architecture using a ‘Mini-LLM’. The ‘Mini-LLM’ refers to a smaller version of a standard transformer model that can easily be trained. In some embodiments, nanoGPT (https://github.com/karpathy/nanoGPT) may be used. nanoGPT reproduces GPT-2. Default parameters for nanoGPT, which can all be reconfigured, are: 12 transformers each with 12 attention heads, 1024 token context window, initial token embedding length of 768, with total model parameters of 124 million. A “Neuro-LLM” replaces the initial random 768 vectors (the “input embedding” box in the transformer diagram of FIG. 74) with neural-embeddings. The model may be trained from scratch with neural-embeddings to determine if the model trains faster or improves the performance of the model at next word prediction. As described herein, neural embeddings can be randomly assigned to token labels or mapped according to an established correspondence. If they are mapped, in some embodiments, the neural embeddings can be mapped using word2vec. The neural embeddings can similarly be mapped by mapping them to trained GPT embeddings. The neuro embeddings, which are the product of recurrent analogue processing and encoded into cell culture with a scheme that creates relationships among the tokens, yield greater global minima during model training and therefore find superior final model parameters than randomized initial word embeddings. These deeper global minima make training more efficient.

As can be appreciated from the foregoing, the neural-based embeddings described herein may be integrated with an LLM in a number of different ways. In some embodiments, the input embedding layer of an LLM may be initialized with the neural embeddings instead of a conventional embedding such as by initial randomization or using an embedding model such as word2vec. For example, as described in the example of the preceding paragraph, the initial randomly-initialized 768 vectors in the input embedding of the transformer shown in FIG. 74, may instead by initialized with neural embeddings. Subsequent to that, in some embodiments, the input embedding layer parameter values may be frozen while the remaining LLM parameters (e.g., parameters of transformers, attention heads, etc.) are trained using training data. In this way, the biologically-learned mapping is not forgotten during subsequent training. Alternatively, in other embodiments, the input embedding layer parameters may also be updated during training along with the other LLM parameters during training. In some such embodiments, the learning rate for updating the input embedding layer parameters may be set to be smaller than for other parameters such that embedding parameters are changed to a lesser degree than other parameters, again, such that the biologically-learned mapping is not forgotten.

After an LLM is trained (regardless of whether or not the input embedding layer parameters were frozen or not during training of the LLM), the trained LLM may be used to process text to perform any suitable task that an LLM may be used for including, but not limited to, predicting a subsequent word or words, filling in a word in the text, predicting a missing or masked word in the text, identifying a topic for the text, generating a summary for the text, identifying whether two pieces of text (e.g., two sentences) are from a common source (e.g., the same document), and the like. As described herein, especially with respect to FIGS. 69A-D, initializing an LLM in this way prior to training and using neural embeddings facilitates achieving comparable performance to LLMs initialized with other techniques (e.g., randomly, using other embeddings such as word2vec) while requiring fewer iterations to be trained to get to this same level of performance. As a result, such neural-embedding based initializations for LLMs have the effect of reducing computational resources needed for training an LLM, which is an improvement to AI technology and computer technology, saving computational resources as well as energy consumed by training such models.

Accordingly, some embodiments provide for a method of using a dictionary of neural-based embeddings to process text using a large language model (LLM), the LLM having an embedding layer (see e.g., input embedding layer in FIG. 74) and a plurality of transformers, each of the transformers having one or more attention heads (see e.g., transformers and attention heads shown in FIG. 74), the method comprising: receiving text comprising one or more tokens to be processed by the LLM; determining a corresponding token embedding for each of the one or more tokens by using parameters of the embedding layer to obtain token embeddings, the parameters of the embedding layer determined using the dictionary of neural-based embeddings, the dictionary of neural-based embeddings having been generated using a biological neural network (BNN) comprising neurons arranged on a multi-electrode array; and processing the obtained token embeddings using the plurality of transformers part of the LLM to obtain LLM output.

In some embodiments, the method further comprises determining the parameters of the embedding layer using the dictionary of neural-based embeddings. For example, the determining may include setting the parameters of the embedding layer to the neural-based embeddings. In some embodiments, such parameters may be further updated (e.g., using a smaller learning rate for embedding parameters than for other parameters) using training data as part of training the LLM. On the other hand, in some embodiments, the LLM may be trained at least in part by fixing the parameters of the embedding layer during training and updating other parameters of the LLM (e.g., parameters of the transformers) using further training data.

Some embodiments provide for a method for training a large language model (LLM) using a dictionary of neural-based embeddings, the method comprising: obtaining a dictionary of neural-based embeddings, the dictionary of neural based embeddings being generated using a biological neural network (BNN) comprising neurons arranged on a multi-electrode array, the dictionary of neural based embeddings including a neural embedding for each of one or more words in a lexicon; initializing parameters of an input embedding layer of the LLM using neural embeddings in the dictionary of neural-based embeddings; and after the initializing, training an LLM using training data comprising text having words in the lexicon to obtain a trained LLM, the training comprising updating the parameters of the input embedding layer of the LLM. The trained LLM may in turn be used to process input text to perform any of a variety of tasks such as filling in a missing word in the text or predicting the next word(s) following the text, and/or other tasks, examples of which are provided herein.

In some embodiments, processing the text using the trained LLM involves embedding the text using the updated parameters of the input embedding layer of the LLM to obtain text embeddings. In some embodiments, the LLM comprises a plurality of transformers each having a respective plurality of attention heads, and processing the text further comprises processing the obtained text embeddings using the plurality of transformers part of the LLM to obtain LLM output.

FIG. 75 illustrates example results of a large language model applied to a sentence classification task, according to some embodiments of the technology described herein. FIG. 75 illustrates features extracted from the neuronal response of a BANN in performance of a sentence classification task across application of a sequence of stimulation patterns for multiple trials. The sequence of stimulation patterns applied for the results shown in FIG. 75 is as follows: 6-2-3-4-5; 7-2-3-4-5; 8-2-3-4-5; 9-2-3-4-5; 10-2-3-4-5, with the numbers 2-10 corresponding to the stimulation pattern assigned to the nth token (e.g., word) in the sentence of words. It can be seen that, the performance of the LLM at sentence classification remains consistent while the initial stimulation pattern is varied among the five trials. In particular, the first stimulation pattern in the above sequences is varied (simulation patterns representing token sequences “6”, “7”, “8”, “9”, and “10” are applied first) followed by a common sequence of four stimulation patterns corresponding to tokens “2”, “3”, “4”, and “5”. The results indicate that the LLM performance remains consistent-given that the only difference is in the initial stimulation pattern, this experiment demonstrates that the BANN does not forget the impact of the initial stimulation pattern.

According to another experiment, 9-word sentence classification is performed with permuted tokens. The experimental parameters are as follows: use of context electrodes for stimulation for 40 ms at 14 μA. Further trials were performed with 9 single electrode stimulations for 5 ms ISI at 20 μA. The stimulation pattern is as follows: 1-2-3-4-5-6-7-8-9, 1-3-2-4-5-6-7-8-9, 2-1-3-4-5-6-7-8-9, 2-3-1-4-5-6-7-8-9, 3-1-2-4-5-6-7-8-9, 3-1-2-4-5-6-7-8-9, with the numbers 1-9 corresponding to the stimulation pattern assigned to the nth token (e.g., word) in the sentence of words. In particular, the performance of the BANN (e.g., via an LLM or any other suitable classification method using BANN generated features) at sentence classification remains consistent while the initial three stimulation patterns (1-3) are permutated among the six trials.

### X. Closed-Loop BNN System

As described herein, some aspects of the technology described herein provide for a closed-loop BNN system. In the closed-loop BNN system, an output of the BNN system is fed back into the BNN system. For example, in some embodiments, and output of the BNN system may be used to determine whether and/or how to train the BNN system.

The closed-loop BANN, an extension of BNN and BANN described herein, integrates synaptic modification through long-term potentiation, long-term depression and biological learning to teach biological networks encoded stimuli. The Closed-loop BNN and BANN may employ stimulation and recording, contextual electrode stimulation, stimulus response, spike extraction, and readout of neural activity, as previously described. In one or more embodiments, the closed-loop BANN process can be summarized as follows: stimuli, such as spatial representations of MNIST or CIFAR 10 images, are introduced to a biological network via stimulation (e.g., electrical, chemical, and/or optical stimulation). The biological network's electrical responses (including spike rates, timing, patterns, and latencies, etc.) to these stimuli are analyzed using an ANN to predict the class of the stimulus. This ANN, once trained, is tested with the biological network's electrical responses to new stimuli. To improve test performance and develop a robust biological classifier, the network receives ‘online’ feedback that is meant to strengthen or weaken synapses across the BNN in order to achieve improved classification accuracy. Feedback parameters, such as electrode configuration and amplitude, are optimized for the experimental setup. This closed-loop method employs feedback to adjust synaptic weights in the biological network that modify intrinsic neuronal processing and iteratively retrains the CNN weights to achieve optimal stable performance.

FIGS. 76A-B illustrates schematic diagrams illustrating example workflows for training a biological neural network, according to some embodiments of the technology described herein. FIG. 76A illustrates that after building a classifier based on MEA responses, subsequent stimulation patterns can be used to test classifier performance, with success of this performance being used to train the BNN. FIG. 76B illustrates another example schematic diagram of a closed-loop system. In the illustrated embodiment of FIG. 76B, learning is incorporated through feedback (e.g., positive or negative), enabling the system to learn and improve over time. In the examples of FIGS. 76A-B, the input signal is an image from an MNIST dataset comprising images of numbers. The task is a classification task. Encoding of the data into the BNN is performed spatially and decoding is performed using spike rates and/or spike patterns. Learning of the BNN is achieved through closed-loop training.

According to some embodiments, a method for using a BNN system includes closed-loop training. For example, the method may include determining, based on a measured response of the BNN, whether to apply a positive feedback stimulation pattern to the BNN, and stimulating, based on the determining whether to apply the positive feedback stimulation pattern to the BNN, the BNN with the positive feedback stimulation pattern.

For a BANN system, an ANN may be used to perform a classification task by processing a response of a BNN to a stimulation pattern. If the task output, which is a classification, is incorrect, the BNN may be stimulated with negative feedback. In some embodiments, the negative feedback comprises a repeated stimulation pattern applied by the MEA across a set of electrodes drawn probabilistically from a pool of electrode sets, designed to induce network plasticity. If the negative feedback improves classification performance of the BANN, the negative feedback pattern is upregulated, making it more likely that it will be chosen again in subsequent trials.

Correct classifications by the BANN system may be stimulated with positive feedback.

Positive and negative feedback may have the same stimulus timing and configuration. In an example implementation, a cluster of six electrodes are stimulated in sequence at 10 ms intervals, and 10-12 cluster stimulations are delivered at 200-400 ms intervals.

In one illustrative example, the 100-800 electrodes that evoked the most array-wide spikes were used as feedback electrodes. Once this criterion is met, 50-100 groups of 6 electrodes are made. The stimulation order of the 6 electrodes is fixed for negative feedback for the duration of closed-loop training.

If a stimulus is correctly classified, any one of the groups of electrodes may be chosen. The chosen 6 electrodes are individually stimulated in a sequence at 10 ms intervals. After 200-400 ms the same electrodes are again stimulated in a sequence 10 ms apart, but the sequence is randomly reordered. 10-12 similar repetitions of 6 electrode stimulations are made before the next classifiable/intended stimulus is delivered. The random order of the stimulations is intended to stabilize synaptic weights and subsequently spike patterns used as input to the ANN.

If the stimulus is incorrectly classified, a group of electrodes is selected and stimulated in a set order with the set order repeated 10-12 times. This stimulation regime is intended to change synaptic weights and therefore the spike outputs feeding into the ANN. If the following classifiable stimulus is correctly classified, the previous negative stimulus is upregulated. This leads to a higher likelihood that that ‘successful’ group is used again. If the following stimulus is misclassified, the closed-loop group is downregulated meaning that it is less likely to be picked.

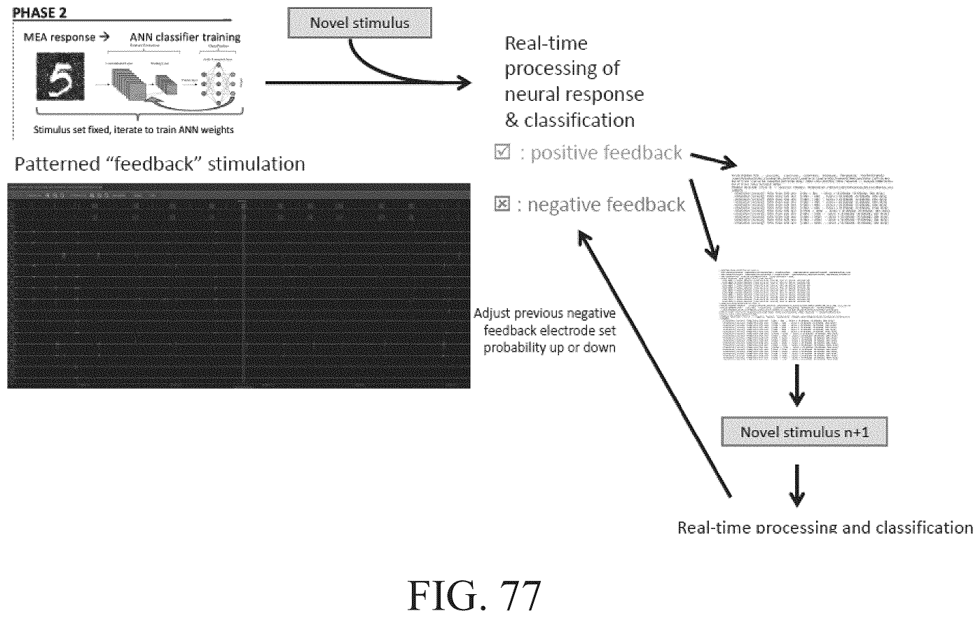

FIG. 77 illustrates example aspects of training a biological neural network, according to some embodiments of the technology described herein. FIG. 77 illustrates an example workflow for closed-loop training of a BNN. In the example workflow, the following acts are performed. A classifier is built using MEA responses to input stimulations. 50-100 random groups (“pools”) of electrodes clusters are generated. Negative feedback pools include identical electrodes and order in each cluster within a pool, and utilize repeated stimulation of a set of 6 electrodes in a fixed order to induce biological network connectivity. Positive feedback pools include identical electrodes but a random order of electrodes in each cluster and utilize repeated stimulation of a set of 6 electrodes in a random order to maintain biological network connectivity. Electrode sets are picked from pools for 50-110 sets based according to an initially uniform probability. The clusters of 6 electrodes are stimulated at 10 ms intervals. The clusters are spaced 200-400 ms apart.

Real-time classification based on a new input stimulation is performed. If the classification is correct, positive feedback stimulation is applied to maintain connectivity. If the classification is incorrect, negative feedback stimulation is applied to induce network changes. If a subsequent classification is correct, a probability of previously applied negative feedback is upweighted, making it more likely to be chosen again. If a subsequent classification is incorrect, a probability of the previously applied negative feedback is downweighted, making it less likely to be chosen again.

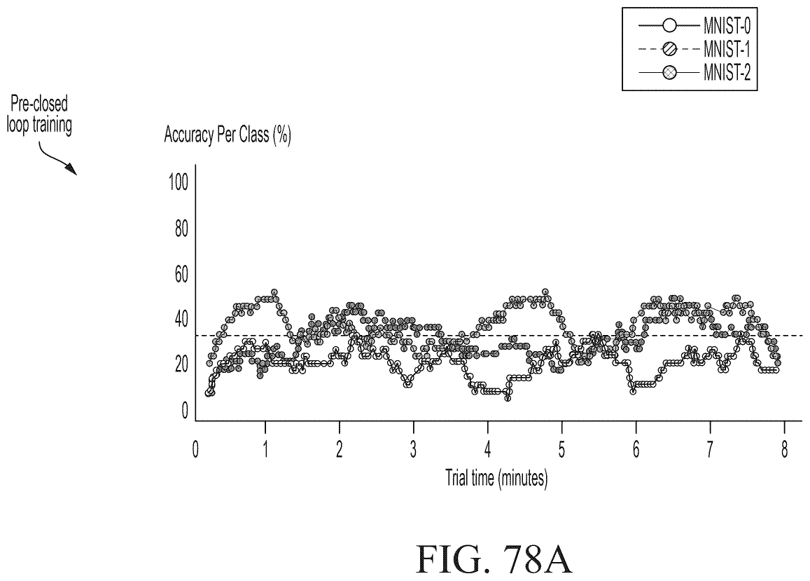

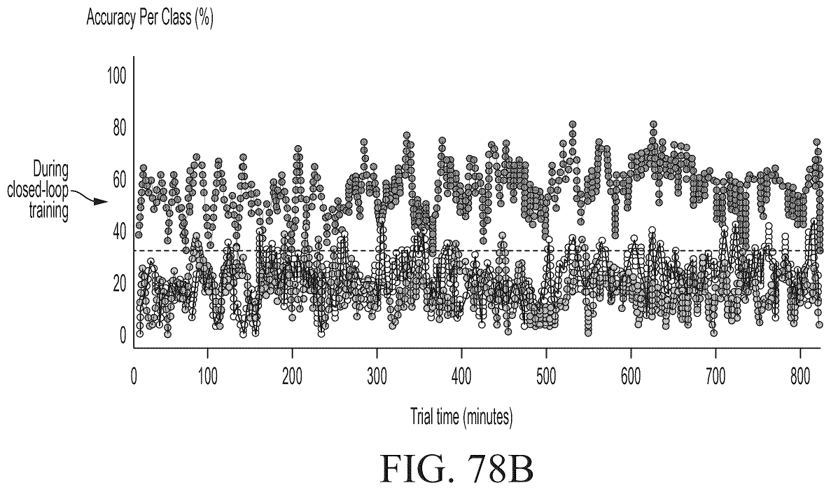

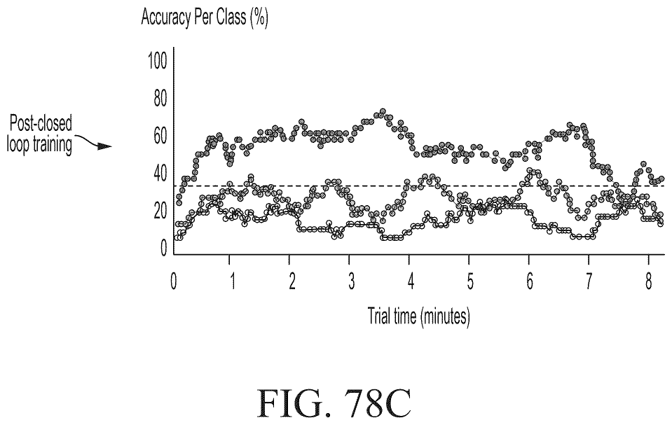

FIGS. 78A-C illustrate example graphs depicting results of a biological neural network at a classification task before, during, and after training the biological neural network, according to some embodiments of the technology described herein. The results of FIGS. 78A-C illustrate that use of the closed-loop BANN system improves performance of image classification. In particular, the results of FIGS. 78A-C show that after training neurons to recognize the number 3, classification accuracy of neuronal responses after three stimulations increased from chance (˜33% accuracy) to 70% accuracy. The results shown in FIGS. 78A-B were obtained from an experiment where the input dataset is MNIST data, the task is a classification task, the encoding of input signals to the BNN was performed spatially, the decoding is performed using spike rates and/or spike patterns, and biological learning is achieved using closed-loop training.

FIG. 78A illustrates pre-closed loop training and shows the accuracy of selecting a MNIST 0, 1, 2 by a trained ANN is 33%, which is chance (red dashed line). 300 presentation of each MNIST character to the ANN were provided.

FIG. 78B illustrates during closed-loop training to classify MNIST 2 and shows that the accuracy of selecting a 2 by a trained ANN increases to 80% during closed-loop training. The closed loop system is trained on 3300 representations of MNIST characters 0, 1, 2 (each) and is trained to classify 2.

FIG. 78C illustrates post-closed loop training and shows that the cells are trained to select MNIST 2 60-80% of the time.

### XI. Applications of BNN Systems

The BNN system described herein may be used with or without an ANN to perform biological computing. For example, the biological computing may include analysis of a BNN response with or without an ANN, as described herein. Example applications of the BNN systems described herein are further provided. As described herein, the methods for neuronal cell culture preparation, electrode recording stimulation, and stimulus encoding allows one to leverage the data processing that occurs within the biological neural network, the decoding of which allows for a novel application towards data analysis and computation. As such, the neurons themselves serve as the primary computational medium. Data is converted into electrical (or optical) stimuli for presentation to the neurons through the MEA, such as spatially or temporally. The output from the BNN is recorded as total number of spikes and/or spike patterns from all electrodes. This information provides insight into the computation performed by the cells and is decoded for use.

In one or more embodiments, a BNN is used to forecast stock market values based on historical data. The experiment employed an MEA with parameters consistent with those previously described. In the experiment, 100 days of S&P500 stock price fluctuations were encoded into the BNN by first identifying the two electrodes with the highest response to neuronal stimulation. This was achieved by administering a stimulus pulse across all electrodes and selecting the two with the greatest response for stimulus presentation. This stimulus parameters included bipolar stimulation across these endpoints, biphasic tetanic stimulation at a frequency of 50 Hz for 10 seconds every minute, with a baseline current of 250 μA and 500 μV. To encode the S&P500 values, daily percentage changes in stock prices were converted into corresponding changes in voltage, applying this formula to adjust the stimulus voltage. For instance, a 10% increase in the S&P500 index resulted in a stimulus of 550 μV. This stimulation, which varied in voltage to reflect daily stock market changes, was repeated every minute for 100 minutes to simulate 100 days of data. Spikes from all electrodes after each stimulus were recorded to predict daily S&P500 value changes. For example, if 100 spikes were recorded after the first stimulus and 110 spikes after the second, the BNN predicted a 10% increase in S&P500 market capitalization. These predictions were evaluated against historical data for prediction accuracy.

Using similar properties as described herein, processing through in four dimensions (spatially and through time) in neural tissue offers the ability to encode and classify video (multiple images passing at a frame rate of 30-60 fps). The non-linear, recurrent, and fading memory characteristics-which maintains information through time, also offers a far superior encoding of relationships of images passing through time than current digital computing offers.

An example of the process currently used in one embodiment to encode and decode video is with the initial aim of classifying video representations. This can be scaled to much more complicated videos with more complicated backgrounds and images. Within each video, individual frames are used as tokens, which are then transformed into a spatial and temporal pattern for stimulation in a biological network. These tokens are then stimulated in a sequence (that of the movie), with one token representing each video frame. A series of token stimulations encodes one video in the neural tissue. For initial experiments, a very short movie is encoded constructed from 100 images, presented to the neural network every 30 ms. Stimulation of a single video is processed by the tissue using its unique analogue, recurrent and fading-memory properties. Following stimulation of a video, digital ANNs are employed to classify video identity (dancing vs. running figure) using as input the spiking output (rates and patterns) from the tissue, which reflect the analogue computation performed by the tissue. To further optimize this analogue computation, the synaptic weights of the tissue are trained using a closed-loop system, with the goal of enhancing class separation of the spiking outputs, which reflect the videos, before they are input to the ANN for further class-separation.

### XII. Exemplary Computing Device

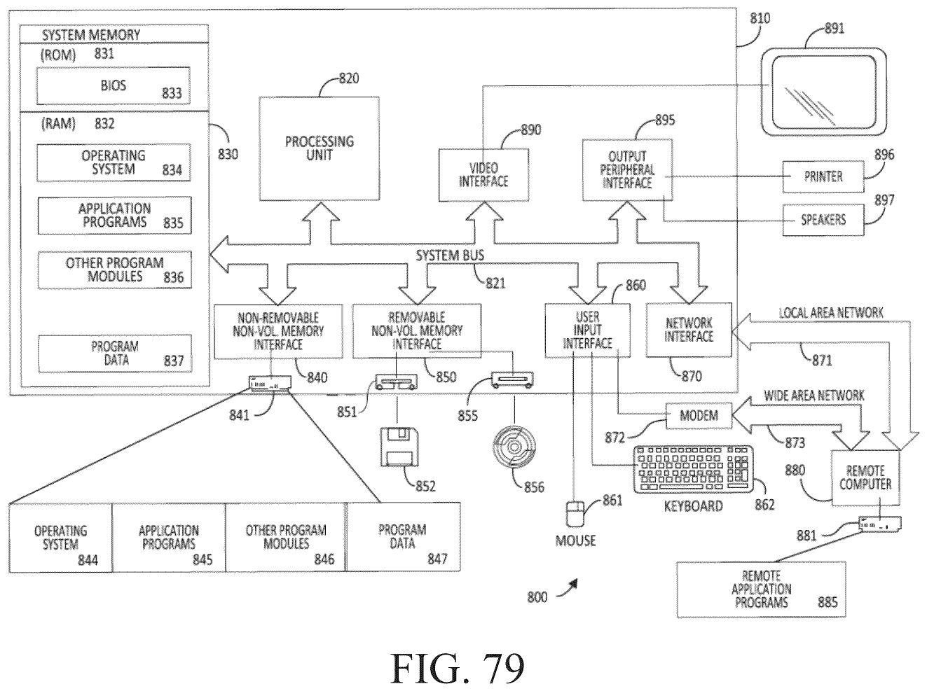

FIG. 79 shows a block diagram of an exemplary computing device, in accordance with some embodiments of the technology described herein. The computing system environment 800 is only one example of a suitable computing environment and is not intended to suggest any limitation as to the scope of use or functionality of the technology described herein.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 79, an exemplary system for implementing the technology described herein includes a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules, biological media such as DNA, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 79 illustrates operating system 834, application programs 835, other program modules 836, and program data 837.

The computer 810 may also include other removable/non-removable, volatile or nonvolatile computer storage media. By way of example only, FIG. 79 illustrates a hard disk drive 841 that reads from or writes to non-removable, nonvolatile magnetic media, a flash drive 851 that reads from or writes to a removable, nonvolatile memory 852 such as flash memory, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media described above and illustrated in FIG. 79, provide storage of computer readable instructions, data structures, program modules and other data for the computer 810. In FIG. 79, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. An actor may enter commands and information into the computer 810 through input devices such as a keyboard 862 and pointing device 861, commonly referred to as a mouse, trackball, or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 88 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device, or other common network node, and typically includes many or all of the elements described above relative to the computer 810, although only a memory storage device 881 has been illustrated in FIG. 79. The logical connections depicted in FIG. 79 include a local area network (LAN) 871 and a wide area network (WAN) 873, but may also include other networks. Such networking environments are commonplace in offices, enterprise-wide computer networks, intranets, and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the actor input interface 860, or other appropriate mechanism. In a networked environment, program modules depicted relative to the computer 810, or portions thereof, may be stored in the remote memory storage device. By way of example, and not limitation, FIG. 79 illustrates remote application programs 885 as residing on memory device 881. It will be appreciated that the network connections shown are exemplary and other means of establishing a communications link between the computers may be used.

### XIV. Examples

Example embodiments of the technology are provided herein.

(1) A method for using a biological and artificial neural network (BANN) system to perform a task, the BANN system comprising: (i) a multi-electrode array (MEA); (ii) a biological neural network (BNN) comprising neurons arranged on the MEA, (iii) a trained statistical model trained using inputs generated using responses of the BNN to training data inputs; and (iv) at least one processor, the method comprising: using the BANN system to perform: receiving an input signal to be processed by the BANN in furtherance of performing the task; encoding the input signal to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; generating, based on the measured at least one response, an input for the ANN; processing the input with the trained statistical model to obtain corresponding output from the trained statistical model; and using the output from the trained statistical model in furtherance of performing the task.

(2) The method of (1), wherein the trained statistical model comprises an artificial neural network (ANN).

(3) The method of (1), wherein encoding the input signal to generate the at least one stimulation pattern comprises encoding the input signal using a second trained statistical model different from the trained statistical model.

(4) The method of (3), wherein the second trained statistical model comprises a second ANN.

(5) The method of (1), wherein the task is a classification task, a prediction task, a dimensionality reduction task, a reinforcement learning task, or a regression task.

(6) The method of (1), wherein measuring, using the MEA, the at least one response of the BNN comprises: measuring, using each of the one or more electrodes of the MEA, a respective series of one or more voltages; and determining a number of spikes measured based on a number of measured voltages exceeding a voltage threshold.

(7) The method of (6), wherein measuring, using the MEA, the at least one response of the BNN comprises determining an average number of spikes per time period in a plurality of time periods following the stimulating.

(8) The method of (1), wherein measuring, using the MEA, the at least one response of the BNN comprises measuring spectral information.

(9) The method of (1), wherein measuring, using the MEA, the at least one response of the BNN comprises deriving from the at least one response of the BNN, multiple features.

(10) The method of (9), wherein the multiple features comprises one or more of spike rate, latency, average latency, a sequence of images of the at least one response of the BNN, and/or Earth mover's distance.

(11) The method of (1), further comprising: prior to stimulating the BNN, selecting a subset of a plurality of electrodes of the MEA to use when stimulating the BNN, and wherein the stimulating the BNN using the MEA comprises stimulating the BNN using only the selected subset of the plurality of electrodes.

(12) The method of (11), wherein selecting the subset of the plurality of electrodes comprises: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; and selecting, based on the measured at least one response of the BNN, the subset of the plurality of electrodes based on an amount of neuronal activity induced by the respective ones of the plurality of electrodes.

(13) The method of (12), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(14) The method of (1), further comprising: subsequent to measuring the at least one response of the BNN and using the BANN system, stimulating the BNN by using the MEA to generate electrical signals in accordance with at least one calibration pattern designed for reducing burstiness of the BNN.

(15) The method of (1), wherein the BANN system further comprises a graphical user interface (GUI) for receiving user input, the user input comprising one or more values for one or more parameters of the at least one stimulation pattern.

(16) The method of (1), wherein the input signal comprises one-dimensional data.

(17) The method of (16), wherein the one-dimensional data comprises time series data.

(18) The method of (1), wherein the input signal comprises two-dimensional data.

(19) The method of (18), wherein the two-dimensional data comprises one or more images.

(20) The method of (1), wherein the input signal comprises three-dimensional data.

(21) The method of (20), wherein the three-dimensional data comprises one or more videos.

(22) The method of (1), wherein the input signal comprises four-dimensional data.

(23) The method of (1), wherein the input signal comprises natural language text and/or alphanumeric signals.

(24) The method of (1), wherein the encoding the input signal to generate at least one stimulation pattern comprises encoding the input signal spatially and/or temporally.

(25) The method of (1), wherein: the input signal comprises one or more images; measuring the at least one response of the BNN comprises measuring, using each of the one or more electrodes of the MEA, a respective series of one or more voltages and determining a number of spikes measured based on a number of measured voltages exceeding a voltage threshold; the task is a classification task; and the classification task comprises classifying the one or more images as belonging to one of a discrete set of classes.

(26) The method of (2), wherein the ANN comprises a neural network having one or more convolutional layer or a neural network having a transformer architecture.

(27) The method of (4), wherein the second ANN comprises a convolutional neural network.

(28) The method of (1), further comprising: determining, based on the measured at least one response of the BNN, whether to apply a positive feedback stimulation pattern to the BNN;

and stimulating, based on the determining whether to apply the positive feedback stimulation pattern to the BNN, the BNN with the positive feedback stimulation pattern.

(29) The method of (1), further comprising optimizing the biological neural network to perform the task prior to performing the stimulating.

(30) A biological and artificial neural network (BANN) system comprising: a multi-electrode array (MEA); a biological neural network (BNN) comprising neurons arranged on the MEA; a trained statistical model trained using inputs generated using responses of the BNN to training data inputs; and at least one processor configured to perform a task at least in part by: receiving an input signal to be processed by the BANN in furtherance of performing the task; encoding the input signal to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; generating, based on the measured at least one response, an input for the trained statistical model; processing the input with the ANN to obtain corresponding output from the trained statistical model; and using the output from the trained statistical model in furtherance of performing the task.

At least one non-transitory computer-readable storage medium having instructions encoded thereon that, when executed by at least one processor, cause the at least one processor to perform the method of any one of (1)-(29).

(32) A method for using a biological and artificial neural network (BANN) system to perform a task, the BANN system comprising: (i) a multi-electrode array (MEA); (ii) a biological neural network (BNN) comprising neurons arranged on the MEA, (iii) a trained statistical model; and (iv) at least one processor, the method comprising: using the BANN system to perform: receiving an input signal to be processed by the BANN in furtherance of performing the task; encoding the input signal using the trained statistical model to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; and using the measured at least one response from the BNN in furtherance of performing the task.

(33) The method of (32), wherein the trained statistical model comprises an artificial neural network (ANN).

(34) The method of (33), wherein the ANN comprises a convolutional neural network.

(35) The method of (32), wherein encoding the input signal using the trained statistical model to generate the at least one stimulation pattern comprises transforming the input signal into a set of input signals, each of the input signals in the set of input signals is derived from the input signal and wherein the at least one stimulation pattern comprises a respective stimulation pattern for each of the input signals in the set of input signals.

(36) The method of (35), wherein the input signal comprises an image and the set of input signals comprises a set of images.

(37) The method of (36), wherein: the input signal comprises a two-dimensional image; the trained statistical model comprises a convolutional neural network comprising a plurality of convolutional kernels; and the set of images comprises images generated by respective ones of the plurality of convolutional kernels of the convolutional neural network.

(38) The method of (35), wherein each respective input signal of the input signals in the set of input signals is derived using a respective convolutional kernel of the ANN.

(39) The method of (32), wherein the trained statistical model comprises an artificial neural network (ANN) which comprises a convolutional neural network (CNN) and encoding the input signal using the trained statistical model comprises: processing the input signal using at least one convolutional layer to obtain first images; binarizing the first images to obtain binarized images; inflating the binarized images to obtain inflated images; padding the inflated images to obtain a set of padded images; and organizing the set of padded images into a set of images to form the at least one stimulation pattern.

(40) The method of (32), wherein the task is a classification task, a prediction task, a dimensionality reduction task, a reinforcement learning task, or a regression task.

(41) The method of (32), wherein measuring, using the MEA, the at least one response of the BNN comprises: measuring, using each of the one or more electrodes of the MEA, a respective series of one or more voltages; and determining a number of spikes measured based on a number of measured voltages exceeding a voltage threshold.

(42) The method of (41), wherein measuring, using the MEA, the at least one response of the BNN comprises determining an average number of spikes per time period in a plurality of time periods following the stimulating.

(43) The method of (32), wherein measuring, using the MEA, the at least one response of the BNN comprises measuring spectral information.

(44) The method of (32), wherein measuring, using the MEA, the at least one response of the BNN comprises deriving from the at least one response of the BNN, multiple features of the at least one response.

(45) The method of (44), wherein the multiple features comprises one or more of spike rate, latency, average latency, a sequence of images of the at least one response of the BNN, and/or Earth mover's distance.

(46) The method of (32), further comprising prior to stimulating the BNN, selecting a subset of a plurality of electrodes of the MEA to use when stimulating the BNN and wherein the stimulating the BNN using the MEA comprises stimulating the BNN using only the selected subset of the plurality of electrodes.

(47) The method of (46), wherein selecting the subset of the plurality of electrodes comprises: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by the respective ones of the plurality of electrodes.

(48) The method of (47), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(49) The method of (32), further comprising subsequent to measuring the at least one response of the BNN and using the BANN system, stimulating the BNN by using the MEA to generate electrical signals in accordance with at least one calibration pattern designed for reducing burstiness of the BNN.

(50) The method of (32), wherein the BANN system further comprises a graphical user interface (GUI) for receiving user input, the user input comprising one or more values for one or more parameters of the at least one stimulation pattern.

(51) The method of (32), wherein the input signal comprises one-dimensional data, the one-dimensional data comprising time series data.

(52) The method of (32), wherein the input signal comprises two-dimensional data, the two-dimensional data comprising one or more images.

(53) The method of (32), wherein the input signal comprises three-dimensional data, the three-dimensional data comprising one or more videos.

(54) The method of (32), wherein using the measured at least one response from the BNN in furtherance of performing the task comprises processing the measured at least one response with an artificial neural network (ANN) in furtherance of performing the task.

(55) The method of (32), wherein the input signal comprises four-dimensional data.

(56) The method of (32), wherein the input signal comprises natural language text and/or alphanumeric signals.

(57) The method of (32), wherein the encoding the input signal to generate at least one stimulation pattern comprises encoding the input signal spatially and/or temporally.

(58) The method of (32), further comprising: determining, based on the measured at least one response of the BNN, whether to apply a positive feedback stimulation pattern to the BNN; and stimulating, based on the determining whether to apply the positive feedback stimulation pattern to the BNN, the BNN with the positive feedback stimulation pattern.

(59) The method of (32), further comprising optimizing the biological neural network to perform the task prior to performing the stimulating.

(60) A system comprising: a multi-electrode array (MEA); a biological neural network (BNN) comprising neurons arranged on the MEA; a trained statistical model; and at least one processor configured to perform a method for performing a task, the method comprising: receiving an input signal to be processed by the system in furtherance of performing the task; encoding the input signal using the trained statistical model to generate at least one stimulation pattern; stimulating the BNN by using the MEA to generate electrical signals in accordance with the at least one stimulation pattern; measuring, using the MEA, at least one response of the BNN that is responsive to the stimulating with the at least one stimulation pattern; and using the measured at least one response from the BNN in furtherance of performing the task.

(61) At least one non-transitory computer-readable storage medium having instructions encoded thereon that, when executed by at least one processor, cause the at least one processor to perform the method of any one of (32)-(59).

(61) A method for using a biological and artificial neural network (BANN) system to generate a neural-based embedding of an input signal, the BANN system comprising: (i) a multi-electrode array (MEA); (ii) a biological neural network (BNN) comprising neurons arranged on the MEA, (iii) an artificial neural network (ANN); and (iv) at least one processor, the method comprising: using the BANN system to perform: stimulating the BNN by using the MEA to generate electrical signals in accordance with at least one stimulation pattern generated based on the input signal; measuring, using the MEA, at least one response of the BNN responsive to the stimulating, wherein measuring the at least one response comprises deriving from the at least one response of the BNN, multiple features of the at least one response; and processing the multiple features derived from the at least one response of the BNN with the ANN to generate the neural-based embedding, wherein the ANN is trained to process the multiple features derived from the at least one response of the BNN.

(63) The method of (62), wherein the multiple features comprise one or more of spike rate, latency, average latency, a sequence of images of the at least one response of the BNN, and/or Earth mover's distance.

(64) The method of (62), wherein the ANN comprises a plurality of branches, each branch of the plurality of branches configured to receive and process a respective one of the multiple features and wherein each of the plurality of branches of the ANN further comprise one or more additional layers that process the respective one of the multiple features.

(65) The method of (64), wherein the one or more additional layers comprise a convolutional layer, a batch normalization layer, a non-linearity layer, a fully-connected layer, and/or a recurrent layer.

(66) The method of (64), wherein processing the one or more features comprises processing each respective feature in a respective one or the plurality of branches of the ANN.

(67) The method of (66), wherein the processing the multiple features further comprises concatenating outputs of the plurality of branches to generate a concatenated output.

(68) The method of (67), wherein the processing the multiple features further comprises performing further processing on the concatenated output.

(69) The method of (62), further comprising providing the neural-based embedding as input to a trained statistical model and performing a task using the trained statistical model.

(70) The method of (69), wherein the trained statistical model is a second ANN.

(71) The method of (69), wherein the task is a classification task, a prediction task, a dimensionality reduction task, a reinforcement learning task, or a regression task.

(72) The method of (70, wherein the second ANN comprises a large language model.

(73) The method of (62), further comprising prior to stimulating the BNN, selecting a subset of a plurality of electrodes of the MEA to use when stimulating the BNN and wherein the stimulating the BNN using the MEA comprises stimulating the BNN using only the selected subset of the plurality of electrodes.

(74) The method of (73), wherein selecting the subset of the plurality of electrodes comprises: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by the respective ones of the plurality of electrodes.

(75) The method of (74), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(76) The method of (62), further comprising subsequent to measuring the at least one response of the BNN, stimulating the BNN by using the MEA to generate electrical signals in accordance with at least one calibration pattern designed for reducing burstiness of the BNN.

(77) The method of (62), wherein the BANN system further comprises a graphical user interface (GUI) for receiving user input, the user input comprising one or more values for one or more parameters of the at least one stimulation pattern.

(78) The method of (62), wherein the input signal comprises one-dimensional data.

(79) The method of (78), wherein the one-dimensional data comprises time series data.

(80) The method of (62), wherein the input signal comprises two-dimensional data.

(81) The method of (80, wherein the two-dimensional data comprises one or more images.

(82) The method of (62), wherein the input signal comprises three-dimensional data.

(83) The method of (81), wherein the three-dimensional data comprises one or more videos.

(84) The method of (62), wherein the input signal comprises four-dimensional data.

(85) The method of (62), wherein the input signal comprises natural language text and/or alphanumeric signals.

(86) The method of (62), wherein the encoding the input signal to generate at least one stimulation pattern comprises encoding the input signal spatially and/or temporally.

(87) The method of (62), further comprising: determining, based on the measured at least one response of the BNN, whether to apply a positive feedback stimulation pattern to the BNN; and stimulating, based on the determining whether to apply the positive feedback stimulation pattern to the BNN, the BNN with the positive feedback stimulation pattern.

(88) The method of (62), further comprising optimizing the biological neural network to perform a task prior to performing the stimulating.

(89) A system comprising: a multi-electrode array (MEA); a biological neural network (BNN) comprising neurons arranged on the MEA; an artificial neural network; and at least one processor configured to generate a neural-based embedding of an input signal at least in part by: stimulating the BNN by using the MEA to generate electrical signals in accordance with at least one stimulation pattern generated based on the input signal to be processed by the BANN in furtherance of generating the neural-based embedding; measuring, using the MEA, at least one response of the BNN that is responsive to the stimulating, wherein measuring the at least one response comprises deriving from the at least one response of the BNN, multiple features of the at least one response; and processing the multiple features derived from the at least one response of the BNN with the ANN to generate the neural-based embedding, wherein the ANN is trained to process the multiple features derived from the at least one response of the BNN.

(90) At least one non-transitory computer-readable storage medium having instructions encoded thereon that, when executed by at least one processor, cause the at least one processor to perform the method of any one of (62)-(88).

(91) A method for calibrating a system comprising (i) a multi-electrode array (MEA); (ii) a biological neural network (BNN) comprising neurons arranged on the MEA, and (iii) at least one processor, the method comprising: using the system to perform a calibration method to select a subset of a plurality of electrodes of the MEA to use when stimulating the BNN, at least in part by: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by respective ones of the plurality of electrodes; receiving an input signal to be processed by the BNN; encoding the input signal to generate at least one stimulation pattern for stimulating the BNN; and stimulating the BNN using only the selected subset of the plurality of electrodes of the MEA to generate electrical signals in accordance with the at least one stimulation pattern.

(92) The method of (91), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(93) The method of (91), further comprising subsequent to stimulating the BNN using only the selected subset of the plurality of electrodes, stimulating the BNN by using the MEA to generate electrical signals in accordance with at least one calibration pattern designed for reducing burstiness of the BNN.

(94) The method of (91), wherein the system further comprises a graphical user interface (GUI) for receiving user input, the user input comprising one or more values for one or more parameters of the at least one stimulation pattern.

(95) The method of (91), wherein the encoding the input signal to generate the at least one stimulation pattern for stimulating the BNN comprises encoding the input signal using a trained statistical model to generate the at least one stimulation pattern.

(96) The method of (95), wherein the trained statistical model comprises an artificial neural network (ANN).

(97) The method of (96), wherein the ANN comprises a convolutional neural network.

(98) The method of (95), wherein encoding the input signal using the trained statistical model to generate the at least one stimulation pattern comprises transforming the input signal into a set of input signals, each of the input signals in the set of input signals is derived from the input signal and wherein the at least one stimulation pattern comprises a respective stimulation pattern for each of the input signals in the set of input signals.

(99) The method of (98), wherein the input signal comprises an image and the set of input signals comprises a set of images.

(100) The method of (99), wherein: the input signal comprises a two-dimensional image; the trained statistical model comprises a convolutional neural network comprising a plurality of convolutional kernels; and the set of images comprises images generated by respective ones of the plurality of convolutional kernels of the convolutional neural network.

(101) The method of (98), wherein each respective input signal of the input signals in the set of input signals is derived using a respective convolutional kernel of the ANN.

(102) The method of (95), wherein the trained statistical model comprises an artificial neural network (ANN) which comprises a convolutional neural network (CNN) and encoding the input signal using the trained statistical model comprises: processing the input signal using at least one convolutional layer to obtain first images; binarizing the first images to obtain binarized images; inflating the binarized images to obtain inflated images; padding the inflated images to obtain a set of padded images; and organizing the set of padded images into a set of images to form the at least one stimulation pattern.

(103) The method of (91), wherein the receiving the input signal to be processed by the BNN is in furtherance of performing a task.

(104) The method of (103), wherein the task is a classification task, a prediction task, a dimensionality reduction task, a reinforcement learning task, or a regression task.

(105) The method of (91), wherein the measuring, using the MEA, the at least one response of the BNN comprises: measuring, using each of the one or more electrodes of the MEA, a respective series of one or more voltages; and determining a number of spikes measured based on a number of measured voltages exceeding a voltage threshold.

(106) The method of (105), wherein measuring, using the MEA, the at least one response of the BNN comprises determining an average number of spikes per time period in a plurality of time periods following the stimulating.

(107) The method of (91), wherein measuring, using the MEA, the at least one response of the BNN comprises measuring spectral information.

(108) The method of (91), wherein measuring, using the MEA, the at least one response of the BNN comprises deriving from the at least one response of the BNN, multiple features of the at least one response.

(109) The method of (108), wherein the multiple features comprises one or more of spike rate, latency, average latency, a sequence of images of the at least one response of the BNN, and/or Earth mover's distance.

(110) The method of (91), wherein the system further comprises a graphical user interface (GUI) for receiving user input, the user input comprising one or more values for one or more parameters of the at least one stimulation pattern.

(111) The method of (91), wherein the input signal comprises one-dimensional data, the one-dimensional data comprising time series data.

(112) The method of (91), wherein the input signal comprises two-dimensional data, the two-dimensional data comprising one or more images.

(113) The method of (91), wherein the input signal comprises three-dimensional data, the three-dimensional data comprising one or more videos.

(114) The method of (95), further comprising using a measured at least one response from the BNN in response to the at least one stimulation pattern in furtherance of performing a task at least in part by processing the measured at least one response with an artificial neural network (ANN) in furtherance of performing the task.

(115) The method of (91), wherein the input signal comprises four-dimensional data.

(116) The method of (91), wherein the input signal comprises natural language text and/or alphanumeric signals.

(117) The method of (91), wherein the encoding the input signal to generate at least one stimulation pattern comprises encoding the input signal spatially and/or temporally.

(118) The method of (91), further comprising: determining, based on a measured at least one response of the BNN to the at least one stimulation pattern, whether to apply a positive feedback stimulation pattern to the BNN; and stimulating, based on the determining whether to apply the positive feedback stimulation pattern to the BNN, the BNN with the positive feedback stimulation pattern.

(119) The method of (91), further comprising optimizing the biological neural network to perform a task prior to performing the stimulating.

(120) A system comprising: a multi-electrode array (MEA); a biological neural network (BNN), wherein the BNN comprises neurons arranged on the MEA; and at least one processor configured to perform a method for calibrating the system comprising: using the system to perform a calibration method to select a subset of a plurality of electrodes of the MEA to use when stimulating the BNN, at least in part by: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by respective ones of the plurality of electrodes; receiving an input signal to be processed by the BNN; encoding the input signal to generate at least one stimulation pattern for stimulating the BNN; and stimulating the BNN using only the selected subset of the plurality of electrodes of the MEA to generate electrical signals in accordance with the at least one stimulation pattern.

(121) At least one non-transitory computer-readable storage medium having instructions encoded thereon that, when executed by at least one processor, cause the at least one processor to perform the method of any one of (91)-(119).

(122) A method for generating a dictionary of neural-based embeddings for a dictionary of tokens, the method performed by a biological and artificial neural network (BANN) system comprising (i) a multi-electrode array (MEA); (ii) a biological neural network (BNN) comprising neurons arranged on the MEA; (iii) an artificial neural network (ANN) trained to process multiple features derived from at least one response of the BNN to a stimulation pattern; and (iv) at least one processor, to create a dictionary of neural-based embeddings, the method comprising: using the BANN system to perform: (a) receiving a token of a dictionary of tokens; (b) mapping the token to a corresponding stimulation pattern; (c) stimulating the BNN by using the MEA to generate electrical signals in accordance with the corresponding stimulation pattern for the token; (d) measuring, using the MEA, at least one response of the BNN that is responsive to the stimulating with the corresponding stimulation pattern for the token; (c) generating, based on the measured at least one response, an input; (f) processing the input with the ANN to obtain a neural-based embedding for the token; and (g) storing the neural-based embedding for the token in a memory.

(123) The method of (122), further comprising repeating steps (a)-(g) for each remaining token of the dictionary of tokens.

(124) The method of (122), wherein processing the input with the ANN comprises processing multiple features derived from the at least one response of the BNN with the ANN.

(125) The method of (122), wherein the system further comprises a second artificial neural network (ANN), and wherein the method further comprises generating a plurality of stimulation patterns using the second ANN.

(126) The method of (122), further comprising: identifying a plurality of unique stimulation patterns, the plurality of unique stimulation patterns being distinguishable from each other; and determining a correspondence between each token of the dictionary of tokens and a respective one of the plurality of unique stimulation patterns to determine the corresponding stimulation pattern for each token.

(127) The method of (126), wherein determining the correspondence between each token of the dictionary of tokens and the respective one of the plurality of unique stimulation patterns comprises using word2vec to determine the correspondence between each token of the dictionary of tokens and the respective one of the plurality of unique stimulation patterns.

(128) The method of (122), wherein the system further comprises a second artificial neural network (ANN) incorporating the dictionary of neural-based embeddings, and wherein the method further comprises performing one or more tasks using the second ANN.

(129) The method of (122), further comprising prior to stimulating the BNN, selecting a subset of electrodes of the MEA to use when stimulating the BNN and wherein the stimulating the BNN using the MEA comprises stimulating the BNN using only the selected subset of the plurality of electrodes.

(130) The method of (129), wherein selecting the subset of the plurality of electrodes comprises: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by the respective ones of the plurality of electrodes.

(131) The method of (130), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(132) The method of (122), further comprising subsequent to measuring the at least one response of the BNN, stimulating the BNN by using the MEA to generate electrical signals in accordance with at least one calibration pattern designed for reducing burstiness of the BNN.

(133) The method of (122), wherein the system further comprises a graphical user interface (GUI) for receiving user input, the user input comprising one or more values for one or more parameters of the at least one stimulation pattern.

(134) The method of (122), further comprising, prior to stimulating the BNN, preconditioning the BNN using at least some of the tokens of the dictionary of tokens.

(135) The method of (122), further comprising optimizing the biological neural network to perform a task prior to performing the stimulating.

(136) A system comprising: a multi-electrode array (MEA); a biological neural network (BNN), wherein the BNN comprises neurons arranged on the MEA; an artificial neural network (ANN) trained to process multiple features derived from at least one response of the BNN to a stimulation pattern; and at least one processor configured to generate a dictionary of neural-based embeddings for a dictionary of tokens, at least in part by: (a) receiving a token of a dictionary of tokens; (b) mapping the token to a corresponding stimulation pattern; (c) stimulating the BNN by using the MEA to generate electrical signals in accordance with the corresponding stimulation pattern for the token; (d) measuring, using the MEA, at least one response of the BNN that is responsive to the stimulating with the corresponding stimulation pattern for the token; (c) generating, based on the measured at least one response, an input; (f) processing the input with the ANN to obtain a neural-based embedding for the token; and (g) storing the neural-based embedding for the token in a memory.

(137) The system of (136), wherein the at least one processor is further configured to repeat steps (a)-(g) for each remaining token of the dictionary of tokens.

(138) The system of (136), wherein processing the input with the ANN comprises processing multiple features derived from the at least one response of the BNN with the ANN.

(139) The system of (136), wherein the system further comprises a second artificial neural network (ANN), and wherein the at least one processor is further configured to generate a plurality of stimulation patterns using the second ANN.

(140) The system of (136), wherein the at least one controller is further configured to: identify a plurality of unique stimulation patterns, the plurality of unique stimulation patterns being distinguishable from each other; and determine a correspondence between each token of the dictionary of tokens and a respective one of the plurality of unique stimulation patterns to determine the corresponding stimulation pattern for each token.

(141) The system of (140), wherein determining the correspondence between each token of the dictionary of tokens and the respective one of the plurality of unique stimulation patterns comprises using word2vec to determine the correspondence between each token of the dictionary of tokens and the respective one of the plurality of unique stimulation patterns.

(142) The system of (136), wherein the system further comprises a second artificial neural network (ANN) incorporating the dictionary of neural-based embeddings, and wherein the method further comprises performing one or more tasks using the second ANN.

(143) The system of (136), wherein the at least one processor is further configured to, prior to stimulating the BNN, select a subset of electrodes of the MEA to use when stimulating the BNN and wherein the stimulating the BNN using the MEA comprises stimulating the BNN using only the selected subset of the plurality of electrodes.

(144) The system of (143), wherein selecting the subset of the plurality of electrodes comprises: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; and selecting, based on the measured at least one response of the BNN, the subset of the plurality of electrodes based on an amount of neuronal activity induced by the respective ones of the plurality of electrodes.

(145) The system of (144), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(146) The system of (136), wherein the at least one processor is further configured to, subsequent to measuring the at least one response of the BNN, stimulate the BNN by using the MEA to generate electrical signals in accordance with at least one calibration pattern designed for reducing burstiness of the BNN.

(147) The system of (136), further comprising a graphical user interface (GUI) for receiving user input, the user input comprising one or more values for one or more parameters of the at least one stimulation pattern.

(148) The system of (136), wherein the at least one processor is configured to, prior to stimulating the BNN, precondition the BNN using at least some of the tokens of the dictionary of tokens.

(149) The system of (136), wherein the at least one processor is further configured to optimize the biological neural network to perform a task prior to performing the stimulating.

(150) At least one non-transitory computer-readable storage medium having instructions encoded thereon that, when executed by at least one processor, cause the at least one processor to perform the method of any one of (122)-(135).

(151) A method for using a dictionary of neural-based embeddings to perform a task using a system comprising: (i) a large language model (LLM); and (ii) at least one processor, the method comprising: using the system to perform: receiving text comprising one or more tokens to be processed by the LLM in furtherance of performing a task; determining, for each token of the one or more tokens, a corresponding neural-based embedding using the dictionary of neural-based embeddings, the dictionary of neural based embeddings being generated using a biological neural network (BNN) comprising neurons arranged on a multi-electrode array; processing the one or more tokens using the LLM by inputting to the LLM the determined corresponding neural-based embeddings for each of the one or more tokens to obtain an output; using the output in furtherance of performing the task.

(152) The method of (151), further comprising training the LLM using the dictionary of neural-based embeddings.

(153) The method of (151), further comprising generating the dictionary of neural-based embeddings for the one or more tokens using a biological and artificial neural network (BANN) system comprising (i) a multi-electrode array (MEA); (ii) a biological neural network (BNN) comprising neurons arranged on the MEA; (iii) an artificial neural network (ANN) trained to process multiple features derived from at least one response of the BNN to a stimulation pattern; and (iv) the least one processor at least in part by: (a) receiving a token of a dictionary of tokens; (b) mapping the token to a corresponding stimulation pattern; (c) stimulating the BNN by using the MEA to generate electrical signals in accordance with the corresponding stimulation pattern for the token; (d) measuring, using the MEA, at least one response of the BNN that is responsive to the stimulating with the corresponding stimulation pattern for the token; (c) generating, based on the measured at least one response, an input; (f) processing the input with the ANN to obtain a neural-based embedding for the token; and (g) storing the neural-based embedding for the token in a memory.

(154) The method of (153), further comprising repeating steps (a)-(g) for each remaining token of the dictionary of tokens.

(155) The method of (153), wherein processing the input with the ANN comprises processing multiple features derived from the at least one response of the BNN with the ANN.

(156) The method of (153), wherein the system further comprises a second artificial neural network (ANN), and wherein the method further comprises generating a plurality of stimulation patterns using the second ANN.

(157) The method of (153), further comprising: identifying a plurality of unique stimulation patterns, the plurality of unique stimulation patterns being distinguishable from each other; and determining a correspondence between each token of the dictionary of tokens and a respective one of the plurality of unique stimulation patterns to determine the corresponding stimulation pattern for each token.

(158) The method of (157), wherein determining the correspondence between each token of the dictionary of tokens and the respective one of the plurality of unique stimulation patterns comprises using word2vec to determine the correspondence between each token of the dictionary of tokens and the respective one of the plurality of unique stimulation patterns.

(159) The method of (153), wherein the system further comprises a second artificial neural network (ANN) incorporating the dictionary of neural-based embeddings, and wherein the method further comprises performing one or more tasks using the second ANN.

(160) The method of (153), further comprising prior to stimulating the BNN, selecting a subset of electrodes of the MEA to use when stimulating the BNN and wherein the stimulating the BNN using the MEA comprises stimulating the BNN using only the selected subset of the plurality of electrodes.

(161) The method of (160), wherein selecting the subset of the plurality of electrodes comprises: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; selecting, based on the measured at least one response of the BNN, the subset of the plurality of electrodes based on an amount of neuronal activity induced by the respective ones of the plurality of electrodes.

(162) The method of (161), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(163) The method of (153), further comprising subsequent to measuring the at least one response of the BNN, stimulating the BNN by using the MEA to generate electrical signals in accordance with at least one calibration pattern designed for reducing burstiness of the BNN.

(164) The method of (153), wherein the system further comprises a graphical user interface (GUI) for receiving user input, the user input comprising one or more values for one or more parameters of the at least one stimulation pattern.

(165) The method of (153), further comprising, prior to stimulating the BNN, preconditioning the BNN using at least some of the tokens of the dictionary of tokens.

(166) The method of (153), further comprising optimizing the biological neural network to perform a task prior to performing the stimulating.

(167) A system comprising: a large language model (LLM); and at least one processor configured to use a dictionary of neural-based embeddings to perform a task at least in part by:

receiving text comprising one or more tokens to be processed by the LLM in furtherance of performing a task; determining, for each token of the one or more tokens, a corresponding neural-based embedding using the dictionary of neural-based embeddings, the dictionary of neural based embeddings being generated using a biological neural network (BNN) comprising neurons arranged on a multi-electrode array; processing the one or more tokens using the LLM by inputting to the LLM the determined corresponding neural-based embeddings for each of the one or more tokens to obtain an output; using the output in furtherance of performing the task.

(168) The system of (167), wherein the at least one processor is further configured to train the LLM using the dictionary of neural-based embeddings.

(169) The system of (167), wherein the at least one processor is further configured to generate the dictionary of neural-based embeddings for the one or more tokens using a biological and artificial neural network (BANN) system comprising (i) a multi-electrode array (MEA); (ii) a biological neural network (BNN) comprising neurons arranged on the MEA; (iii) an artificial neural network (ANN) trained to process multiple features derived from at least one response of the BNN to a stimulation pattern; and (iv) the least one processor at least in part by: (a) receiving a token of a dictionary of tokens; (b) mapping the token to a corresponding stimulation pattern; (c) stimulating the BNN by using the MEA to generate electrical signals in accordance with the corresponding stimulation pattern for the token; (d) measuring, using the MEA, at least one response of the BNN that is responsive to the stimulating with the corresponding stimulation pattern for the token; (e) generating, based on the measured at least one response, an input; (f) processing the input with the ANN to obtain a neural-based embedding for the token; and (g) storing the neural-based embedding for the token in a memory.

(170) The system of (169), wherein the at least one processor is further configured to repeat steps (a)-(g) for each remaining token of the dictionary of tokens.

(171) The system of (169), wherein processing the input with the ANN comprises processing multiple features derived from the at least one response of the BNN with the ANN.

(172) The system of (169), wherein the system further comprises a second artificial neural network (ANN), and wherein the at least one processor is further configured to generate a plurality of stimulation patterns using the second ANN.

(173) The system of (168), wherein the at least one controller is further configured to: identify a plurality of unique stimulation patterns, the plurality of unique stimulation patterns being distinguishable from each other; and determine a correspondence between each token of the dictionary of tokens and a respective one of the plurality of unique stimulation patterns to determine the corresponding stimulation pattern for each token.

(174) The system of (173), wherein determining the correspondence between each token of the dictionary of tokens and the respective one of the plurality of unique stimulation patterns comprises using word2vec to determine the correspondence between each token of the dictionary of tokens and the respective one of the plurality of unique stimulation patterns.

(175) The system of (169), wherein the system further comprises a second artificial neural network (ANN) incorporating the dictionary of neural-based embeddings, and wherein the method further comprises performing one or more tasks using the second ANN.

(176) The system of (169), wherein the at least one processor is further configured to, prior to stimulating the BNN, select a subset of electrodes of the MEA to use when stimulating the BNN and wherein the stimulating the BNN using the MEA comprises stimulating the BNN using only the selected subset of the plurality of electrodes.

(177) The system of (176), wherein selecting the subset of the plurality of electrodes comprises: stimulating the BNN by using the plurality of electrodes of the MEA to generate electrical signals in accordance with at least one calibration stimulation pattern; measuring, using the MEA, at least one response of the BNN to being stimulated with the at least one calibration stimulation pattern; and selecting, based on the measured at least one response of the BNN, the subset of the plurality of electrodes based on an amount of neuronal activity induced by the respective ones of the plurality of electrodes.

(178) The system of (177), wherein the selecting the subset of the plurality of electrodes comprises: determining, based on the measured at least one response of the BNN, a ranking of respective ones of the plurality of electrodes based on the amount of neuronal activity induced by the respective ones of the plurality of electrodes; and selecting the subset of the plurality of electrodes based on the ranking.

(179) The system of (169), wherein the at least one processor is further configured to, subsequent to measuring the at least one response of the BNN, stimulate the BNN by using the MEA to generate electrical signals in accordance with at least one calibration pattern designed for reducing burstiness of the BNN.

(180) The system of (169), further comprising a graphical user interface (GUI) for receiving user input, the user input comprising one or more values for one or more parameters of the at least one stimulation pattern.

(181) The system of (169), wherein the at least one processor is configured to, prior to stimulating the BNN, precondition the BNN using at least some of the tokens of the dictionary of tokens.

(182) The system of (171), wherein the at least one process is further configured to optimize the biological neural network to perform a task prior to performing the stimulating.

(183) At least one non-transitory computer-readable storage medium having instructions encoded thereon that, when executed by at least one processor, cause the at least one processor to perform the method of any one of (151)-(166).

(184) A method for training a large language model (LLM) using a dictionary of neural-based embeddings, the method comprising: using at least one computer hardware processor to perform: obtaining a dictionary of neural-based embeddings, the dictionary of neural based embeddings being generated using a biological neural network (BNN) comprising neurons arranged on a multi-electrode array, the dictionary of neural based embeddings including a neural embedding for each of one or more words in a lexicon; initializing parameters of an input embedding layer of the LLM using neural embeddings in the dictionary of neural-based embeddings; and after the initializing, training an LLM using training data comprising text having words in the lexicon to obtain a trained LLM, the training comprising updating the parameters of the input embedding layer of the LLM.

(185) The method of claim 184), further comprising using the trained LLM to process text.

(186) The method of (184), further comprising using the trained LLM to fill in a missing word in the text or to predict a next word following the text.

(187) The method of (184), further comprising processing text using the trained LLM, the processing comprising embedding the text using the updated parameters of the input embedding layer of the LLM to obtain text embeddings.

(188) The method of (187), wherein the LLM comprises a plurality of transformers each having a respective plurality of attention heads, the method further comprising processing the obtained text embeddings using the plurality of transformers part of the LLM to obtain LLM output.

(189) A system, comprising: at least one computer hardware processor; at least one non-transitory computer-readable storage medium storing processor-executable instructions that, when executed by the at least one computer hardware processor, causes the at least one computer hardware processor to perform the method of any one of (184)-(188).

(190) At least one non-transitory computer-readable storage medium storing processor-executable instructions that, when executed by at least one computer hardware processor, causes the at least one computer hardware processor to perform the method of any one of (184)-(188).

(191) A method for using a dictionary of neural-based embeddings to process text using a large language model (LLM), the LLM having an embedding layer and a plurality of transformers, each of the transformers having one or more attention heads, the method comprising: using at least one computer hardware processor to perform: receiving text comprising one or more tokens to be processed by the LLM; determining a corresponding token embedding for each of the one or more tokens by using parameters of the embedding layer to obtain token embeddings, the parameters of the embedding layer determined using the dictionary of neural-based embeddings, the dictionary of neural-based embeddings having been generated using a biological neural network (BNN) comprising neurons arranged on a multi-electrode array; and processing the obtained token embeddings using the plurality of transformers part of the LLM to obtain LLM output.

(192) The method of (191), further comprising: determining the parameters of the embedding layer using the dictionary of neural-based embeddings.

(193) The method of (192), further comprising setting the parameters of the embedding layer to the neural-based embeddings.

(194) The method of (193), further comprising: training the LLM at least in part by updating the parameters of the embedding layer using further training data.

(195) The method of (193), further comprising: training the LLM at least in part by fixing the parameters of the embedding layer during training and updating other parameters of the LLM using further training data.

(196) A system, comprising: at least one computer hardware processor; at least one non-transitory computer-readable storage medium storing processor-executable instructions that, when executed by the at least one computer hardware processor, causes the at least one computer hardware processor to perform the method of any one of (191)-(195).

(197) At least one non-transitory computer-readable storage medium storing processor-executable instructions that, when executed by at least one computer hardware processor, causes the at least one computer hardware processor to perform the method of any one of (191)-(195).

### XIV. Alternatives and Scope

Having thus described several aspects of at least one embodiment of the technology described herein, it is to be appreciated that various alterations, modifications, and improvements will readily occur to those skilled in the art. Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semicustom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, a tablet computer, a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 19, 33, 40, 43, 49, 51, 56, 61, and 68. The acts performed as part of any of the methods may be ordered in any suitable way. Accordingly, embodiments may be constructed in which acts are performed in an order different than illustrated, which may include performing some acts simultaneously, even though shown as sequential acts in some embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within +20% of a target value in some embodiments, within +10% of a target value in some embodiments, within +5% of a target value in some embodiments, within +2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method for using a biological and artificial neural network (BANN) system to generate a neural-based embedding of an input signal, the BANN system comprising: (i) a multi-electrode array (MEA); (ii) a biological neural network (BNN) comprising neurons arranged on the MEA, (iii) an artificial neural network (ANN); and (iv) at least one processor, the method comprising:
using the BANN system to perform:
stimulating the BNN by using the MEA to generate electrical signals in accordance with at least one stimulation pattern generated based on the input signal;
measuring, using the MEA, at least one response of the BNN responsive to the stimulating, wherein measuring the at least one response comprises deriving from the at least one response of the BNN, multiple features of the at least one response; and
processing the multiple features derived from the at least one response of the BNN with the ANN to generate the neural-based embedding, wherein the ANN is trained to process the multiple features derived from the at least one response of the BNN.

2. The method of claim 1, wherein the multiple features comprise one or more of spike rate, latency, average latency, a sequence of images of the at least one response of the BNN, and/or earth mover's distance.

3. The method of claim 1, wherein the ANN comprises a plurality of branches, each branch of the plurality of branches configured to receive and process a respective one of the multiple features and wherein each of the plurality of branches of the ANN further comprise one or more additional layers that process the respective one of the multiple features.

4. The method of claim 3, wherein the one or more additional layers comprise a convolutional layer, a batch normalization layer, a non-linearity layer, a fully-connected layer, and/or a recurrent layer.

5. The method of claim 3, wherein processing the one or more features comprises processing each respective feature in a respective one or the plurality of branches of the ANN.

6. The method of claim 5, wherein the processing the multiple features further comprises concatenating outputs of the plurality of branches to generate a concatenated output.

7. The method of 6, wherein the processing the multiple features further comprises performing further processing on the concatenated output.

8. The method of claim 1, further comprising providing the neural-based embedding as input to a trained statistical model and performing a task using the trained statistical model.

9. The method of claim 8, wherein the trained statistical model is a second ANN.

10. The method of claim 8, wherein the task is a classification task, a prediction task, a dimensionality reduction task, a reinforcement learning task, or a regression task.

11. The method of claim 9, wherein the second ANN comprises a large language model.

12. The method of claim 1, further comprising prior to stimulating the BNN, selecting a subset of a plurality of electrodes of the MEA to use when stimulating the BNN and wherein the stimulating the BNN using the MEA comprises stimulating the BNN using only the selected subset of the plurality of electrodes.

13. The method of claim 11, wherein selecting the subset of the plurality of electrodes comprises:
stimulating the BNN by using the plurality of electrodes of the MEA to generate electrical signals in accordance with at least one calibration stimulation pattern;
measuring, using the MEA, at least one response of the BNN to being stimulated with the at least one calibration stimulation pattern;
selecting, based on the measured at least one response of the BNN, the subset of the plurality of electrodes based on an amount of neuronal activity induced by the respective ones of the plurality of electrodes.

14. The method of claim 12, wherein the selecting the subset of the plurality of electrodes comprises:
determining, based on the measured at least one response of the BNN, a ranking of respective ones of the plurality of electrodes based on the amount of neuronal activity induced by the respective ones of the plurality of electrodes; and
selecting the subset of the plurality of electrodes based on the ranking.

15. The method of claim 1, further comprising subsequent to measuring the at least one response of the BNN, stimulating the BNN by using the MEA to generate electrical signals in accordance with at least one calibration pattern designed for reducing burstiness of the BNN.

16. The method of claim 1, wherein the BANN system further comprises a graphical user interface (GUI) for receiving user input, the user input comprising one or more values for one or more parameters of the at least one stimulation pattern.

17. The method of claim 1, further comprising:
determining, based on the measured at least one response of the BNN, whether to apply a positive feedback stimulation pattern to the BNN; and
stimulating, based on the determining whether to apply the positive feedback stimulation pattern to the BNN, the BNN with the positive feedback stimulation pattern.

18. The method of claim 1, further comprising optimizing the biological neural network to perform a task prior to performing the stimulating.

19. A system comprising:
a multi-electrode array (MEA);
a biological neural network (BNN) comprising neurons arranged on the MEA;
an artificial neural network; and
at least one processor configured to generate a neural-based embedding of an input signal at least in part by:
stimulating the BNN by using the MEA to generate electrical signals in accordance with at least one stimulation pattern generated based on the input signal to be processed by the BANN in furtherance of generating the neural-based embedding;
measuring, using the MEA, at least one response of the BNN that is responsive to the stimulating, wherein measuring the at least one response comprises deriving from the at least one response of the BNN, multiple features of the at least one response; and
processing the multiple features derived from the at least one response of the BNN with the ANN to generate the neural-based embedding, wherein the ANN is trained to process the multiple features derived from the at least one response of the BNN.

20. At least one non-transitory computer-readable storage medium having instructions encoded thereon that, when executed by at least one processor, cause the at least one processor to perform a method for using a biological and artificial neural network (BANN) system to generate a neural-based embedding of an input signal, the BANN system comprising: (i) a multi-electrode array (MEA); (ii) a biological neural network (BNN) comprising neurons arranged on the MEA, (iii) an artificial neural network (ANN), the method comprising:
using the BANN system to perform:
stimulating the BNN by using the MEA to generate electrical signals in accordance with at least one stimulation pattern generated based on the input signal;
measuring, using the MEA, at least one response of the BNN responsive to the stimulating, wherein measuring the at least one response comprises deriving from the at least one response of the BNN, multiple features of the at least one response; and
processing the multiple features derived from the at least one response of the BNN with the ANN to generate the neural-based embedding, wherein the ANN is trained to process the multiple features derived from the at least one response of the BNN.
